(19) United States
(12) Patent Application Publication
(10) Pub. No.: US 2004/0248006 A1
(43) Pub. Date: Dec. 9, 2004

(54) Active material for cell and its manufacturing method

(76) Inventors: Kazuo Tsutsumi, Hyogo (JP); Kazuya Nishimura, Hyogo (JP); Susumu Mitsuda, Hyogo (JP)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/489,788

(22) PCT Filed: Sep. 13, 2002
(86) PCT No.: PCT/JP02/09408

(30) Foreign Application Priority Data
Sep. 17, 2001 (JP) 2001-280847
Sep. 17, 2001 (JP) 2001-280848
Sep. 17, 2001 (JP) 2001-280849
Sep. 19, 2001 (JP) 2001-284490

(51) Int. Cl. H01M 4/52; H01M 4/62; H01M 4/60; H01M 4/58; H01M 4/56; H01M 4/32; H01M 4/36

(52) U.S. Cl. 429/223; 429/232; 429/222; 429/218.2; 429/231.95; 429/231.8; 429/213; 429/225; 429/228; 252/182.1; 429/217

(57) ABSTRACT

Electrically conductive filler such as carbon fibers, carbon particles, Ni fibers, Ni particles, Ni foil, Ni-plated fibers, or Ni-plated particles is added to an active material powder such as nickel hydroxide, which is formed into active material products. The active material is cured by using alkali-resistant resin. Thus, particulate active material for use in a three-dimensional battery is produced.

### TECHNICAL FIELD

The present invention relates to active material products for battery for use in a chargeable and dischargeable three-dimensional battery obtained by forming the active material products in the shape of particle, plate, bar, or the like, and filling the active material products in the battery, and a production method thereof. Furthermore, the present invention relates to active material forming products for battery that allows particulate active material products to be easily handled and battery performance to be improved by increasing a contact area between active material particles, and a production method thereof, active material products for battery capable of improving battery performance by improving its hydrophilicity for good compatibility with an electrolytic solution, and a method of improving hydrophilicity of the active material products, and active material products for battery that can exhibit high battery performance just after assembling the battery by increasing activity of the active material products in advance, and a method of activating the active material products.

### BACKGROUND ART

The present invention relates to a three-dimensional battery. In view of the prior arts, objectives to be achieved by the present invention are broadly classified into four objectives as described below.

The first objective is to provide highly electrically conductive active material products for battery that can be suitably used as active material products for the three-dimensional battery, and a production method thereof. The second objective is to provide active material forming products for battery capable of increasing bulk density of a layer filled with the active material products, and a production method thereof. The third objective is to provide active material products for battery capable of improving battery performance by improving hydrophilicity of the active material products, and a method of producing hydrophilic active material products. The fourth objective is to provide active material products for battery that can exhibit high battery performance just after assembling the battery, and a method of activating the active material products. Hereinbelow, the first to fourth objectives will be described according to comparison with the prior arts.

1. Prior Art and First Objective

Japanese Patent No. 3051401 discloses a so-called three-dimensional battery comprising powdery or particulate active material. Also, pamphlet of International Publication No. WO 00/59062 discloses a layered three-dimensional battery.

As a chargeable and dischargeable three-dimensional battery, a nickel-hydrogen secondary battery comprising nickel hydroxide as a cathode active material and hydrogen-occluding alloy as an anode active material is known. In the chargeable and dischargeable three-dimensional battery, metal such as hydrogen-occluding alloy used as the anode active material becomes usable just after being filled, because such metal is electrically conductive. On the other hand, nickel hydroxide used as the cathode active material is non-electrically conductive, and therefore does not conduct a current. That is, nickel hydroxide itself does not become a battery.

Accordingly, various devices have been made to give conductivity to the cathode active material such as nickel hydroxide. In general, electrically conductive material is added to nickel hydroxide. Specifically, the electrically conductive material is added to the active material, and the resulting active material is filled in metallic felt. The active material is pressed into the felt so as to be thin. A distance between the active material and current collector is made small, and a contact area between them is increased. Specifically, this is performed as follows.

Electrically conductive material such as electrically conductive cobalt hydroxide or carbon particles is added to nickel hydroxide, and binder such as polyvinyl alcohol (PVA) is further added. The resulting mixture is converted into a paste by using water and alkaline solution, and filled and impregnated into metallic Ni porous felt for the purpose of increasing conductivity. A two-dimensional planar structure is employed to ensure contact between the active material and the current collector. Since the filled active material peels off or falls off from the Ni porous forming products in the alkaline solution and is insufficiently in contact with the porous forming products, the active material and the conductor have a layered structure, or are wound to be dense, thus maintaining conductivity and shape.

Since the thin cathode active material that gains conductivity as described above and the current collector are layered, it is necessary to increase its area to increase its capacity. But, since the active material having a larger area is difficult to layer, scale up is difficult to achieve in a single battery. So, in order to obtain a large-sized battery, the number of batteries is typically increased, which leads to a high cost. Also, the active material created as described above tends to peel off or to be deformed, and therefore cannot be used as the active material for three-dimensional battery which is obtained by filling particulate active material in an electrode vessel and easily enables scale-up.

As described above, in the nickel-hydrogen battery, the non-electrically conductive cathode active material gains conductivity by adding electrically conductive filler such as carbon fine powder and PVA as the binder and by filling and impregnating it in the porous Nickel felt. However, when the active material with the electrically conductive filler added is shaped and solidified by a general binder such as PVA, PVA is dissolved and decomposed, and thereby deformed, and the active material forming products collapse and hence cannot maintain conductivity, if the active material is immersed in the alkaline solution containing electrolyte dissolved therein. Such active material products are problematic for use as the active material products for battery.

When only the active material is shaped by water-insoluble resin without use of porous Ni felt, instead of filling nickel hydroxide with water-soluble PVA added as the binder in the porous Ni felt, the active material is non-electrically conductive and is incapable of charge and discharge.

Conventionally, by impregnating an active material mixture in a slurry state comprising nickel hydroxide, electrically conductive medium, and binder such as PVA in the porous Ni felt, an electrically conductive active material sheet can be created. However, if the active material mixture is densely filled in the porous Ni felt, a sufficiently thick sheet is not obtained. For example, the active material and the electrically conductive material are filled and pressed into the porous Ni felt of 1.3 mm to be formed into a sheet of approximately of 0.5 mm. The sheet is cut into small pieces to obtain electrically conductive active material which is in the shape of particle, and small angular matte.

However, in a case where these small pieces are filled in electrode vessel as the active material, cut end portions have sharp cross-sections peculiar to porous Ni felt metal, so that when the battery is constituted, a separator between electrodes would be damaged to thereby cause cathode vessel and anode vessel to be connected to each other, thereby resulting in electric short. Since PVA used as the binder is water-soluble and hence soluble in the alkaline electrolytic solution, the active material peels off from the Ni felt. In a method using this in a particulate filled layer, battery performance would be degraded soon.

On the other hand, in the nickel-hydrogen three-dimensional battery, since hydrogen-occluding alloy as the anode active material is metal and electrically conductive, this becomes usable just after being filled. Nonetheless, the hydrogen-occluding alloy is converted into powder composed of fine particles, after repeated charge and discharge. Since conductivity of a particulate layer of hydrogen-storing metal powder is low, Ni metal power or the like as conduction promoter is mixed with the particulate layer and put into a space between the separator and the electrode and used so as to inhibit hydrogen-occluding alloy from being converted into powder. In metal composed of fine particles, the powdery layer has a high resistance, and loss of a power increases herein. While the cathode and the anode are defined by a porous separator which an electrolytic solution permeates, the cathode and the anode become electrically conductive if fine particle powder on anode side travel to the cathode through holes of the separator. In order to avoid this, a separator that is expensive and has fine holes, is used, or the battery active material is restricted under pressure between the electrode and the separator in order to inhibit the active materials from traveling between the anode and the cathode. Therefore, particles of the hydrogen-occluding alloy powdered due to charge and discharge must maintain conductivity, and fine particles must be inhibited from falling off the particles and traveling through large holes of the separator, such as a general non-woven fabric.

The present invention has been developed under the circumstances, and a first objective to be achieved by the present invention is to provide active material products for battery for allowing conductivity to be given to a material such as nickel hydroxide used as a cathode active material, forming products of the active material being ion-permeable and capable of maintaining a shape and conductivity without collapse in an alkaline electrolytic solution in a chargeable and dischargeable three-dimensional battery obtained by forming the active material products in the shape of particle, plate, or bar and filling the same material, and a production method thereof.

A first objective to be achieved by the present invention is to provide active material products for battery, in which a material such as hydrogen-occluding alloy used as an anode active material is created into particles by using resin, thereby inhibiting fine-powdering and collapse of active material particles, maintaining high conductivity, and inhibiting fine particles from falling off the particles, the active material products enabling the use of a separator for battery having holes of 10 μm or larger such as an inexpensive non-woven fabric, and a production method thereof.

In addition, the first objective to be achieved by the present invention is to provide a method of producing active material products for battery, in which a mixture of the resin, the active material powder, and the electrically conductive filler is formed in the shape of particle, plate and bar, by press forming, extrusion molding, or tablet making, thereby obtaining electrically conductive cathode active material products and electrically conductive anode active material products, and the active material powder is formed into particles by using thermoplastic resin dissolved in an organic solvent, thereby obtaining the electrically conductive cathode active material products and the electrically conductive anode active material products simply and efficiently by agitation and particle formation.

Further, the first objective to be achieved by the present invention is to provide active material products for three-dimensional battery capable of achieving scale up in a single battery by forming products of the cathode active material and of the anode active material having the above-mentioned capability.

2. Prior Art and Second Objective

The applicant filed applications of three-dimensional batteries each comprising a fixed layer obtained by filling particulate active material (see Japanese Laid-Open Patent Application Publications Nos. 2002-141104 and 2002-141101). The battery is created in such a manner that particulate active materials are filled in cells, and filled layer is pressed to be dense to enable contact between active material particles, thereby increasing bulk density of the filled layer.

When a fixed-layer three-dimensional battery is created by filling particulate active materials, the particulate active materials are sometimes difficult to handle and make operation difficult. In addition, since the filled layer of the particulate active materials does not become sufficiently dense, bulk density of the filled layer is low and contact between particles is insufficient. In order to achieve high-density battery and improve battery performance, it is necessary to increase contact area between active material particles to thereby increase bulk density.

The present invention has been developed under the circumstances, and a second objective to be achieved by the present invention is to provide active material forming products for battery of an electrically conductive active material for use in a fixed-layer three-dimensional battery, in which the active material forming products (primary particles) are pressure-formed or secondarily formed by using resin, thereby increasing contact area between active material particles so as to gain improved battery performance, increasing bulk density of the filled layer so as to gain high-density battery, and improving handling by secondary formation of the primary particles, and a production method thereof.

3. Prior Art and Third Objective

As described above, the applicant filed applications of the three-dimensional batteries each comprising the fixed layer obtained by filling particulate active materials (see Japanese Laid-Open Patent Application Publication Nos. 2002-141104 and 2002-141101). In these three-dimensional batteries, battery reaction is difficult to progress and battery performance is negatively affected, unless the battery active material products are sufficiently compatible with an electrolytic solution.

When the active material products used in the three-dimensional battery are composed of metal or metal oxide, the active material products for battery have hydrophilicity sufficient to be used for the battery and hence are smoothly compatible with the electrolytic solution. But, active material products formed by mixing electrically conductive filler and resin are incompatible with the electrolytic solution, which may lead to degraded battery performance.

The present invention has been developed under the circumstances, and a third objective to be achieved by the present invention is to provide active material products for battery for use in the three-dimensional battery, with improved hydrophilicity, which is capable of improving hydrophilicity of the active material products to allow the material products to be well compatible with the electrolytic solution to thereby cause battery reaction to progress, thereby improving battery performance, by adding and applying inorganic oxide or inorganic hydroxide to the active material products.

4. Prior Art and Fourth Objective

As described above, the applicant filed applications of the three-dimensional batteries each comprising the fixed layer obtained by filling particulate active materials (see Japanese Laid-Open Patent Application Publication Nos. 2002-141104 and 2002-141101). In these three-dimensional batteries, since activity of reaction is low just after production of the battery, the activity of the active material products is increased by repeating charge and discharge once or plural times in an initial stage.

A secondary battery exhibits low performance just after production of the battery and is incapable of exhibiting desired battery performance unless charge and discharge are repeated once or plural times. By way of example, in the case of the hydrogen/nickel battery, activity of battery reaction between nickel hydroxide as a cathode and hydrogen-occluding alloy as an anode is low, while in the case of nickel-cadmium battery, activity of battery reaction between nickel hydroxide as a cathode and cadmium as an anode is low.

The present invention has been developed under the circumstances, and the fourth objective to be achieved by the present invention is to provide activated electrically conductive active material products for use in the three-dimensional battery, which are capable of exhibiting desired battery performance just after assembling of the battery, by increasing the activity of the active material products in advance, in such a manner that the active material products are placed under pressure-reduced condition and then under hydrogen-pressurized condition without increasing activity by repeated charge and discharge just after production of the battery, and a method of activating the active material products for battery.

### DISCLOSURE OF THE INVENTION

1. Invention for Achieving First Objective

In order to achieve the first objective, according to the present invention, there is provided active material products for battery for use in a three-dimensional battery comprising two vessels connected to each other with a member interposed therebetween, and electrically conductive current collectors provided within the two vessels in contact with active material particles or active material forming products contained in electrolytic solutions filled in the two vessels, the member being configured to permit passage of an ion and not to permit passage of an electron, and the active material particles or the active material forming products filled in the electrolytic solution in one of the two vessels being adapted to discharge electrons and the active material particles or the active material forming products filled in the electrolytic solution in the other vessel being adapted to absorb the electrons, the active material products being produced by adding electrically conductive filler to an active material powder and by forming and curing the active material powder in a shape of particle, plate or bar by using resin.

In the above constitution, the active material powder may be nickel hydroxide powder. The nickel hydroxide powder may comprises nickel hydroxide and cobalt compound such as cobalt hydroxide or carbon particles.

Other than nickel hydroxide, the active material powder may be obtained from a known active material, which is any one selected from hydrogen-occluding alloy, cadmium hydroxide, lead, lead dioxide, and lithium. Or, the active material powder may be a solid material, which is any one selected from wood, graphite, carbon, iron ore, coal, charcoal, sand, gravel, silica, slag, and chaff.

In the above constitution, the electrically conductive filler may be any one selected from carbon fibers, nickel-plated carbon fibers, nickel-plated organic fibers, carbon particles, nickel-plated carbon particles, fibrous nickel, nickel particles and nickel foil, or any combinations thereof.

When the nickel hydroxide powder is used as the cathode active material, it would be preferable that the resin is thermoplastic resin having a softening temperature of 120° C. or lower, resin having a curing temperature ranging from room temperature to 120° C., resin soluble in a solvent having a vaporizing temperature of 120° C. or lower, resin soluble in a water-soluble solvent, or a resin soluble in an alcohol-soluble solvent. In order to make the active material products electrically conductive, nickel hydroxide and the electrically conductive filler are solidified by using a small amount of resin. Since nickel hydroxide as the active material products loses its activity at a temperature of 130° C. or higher, various processes must be carried out at a temperature lower than 130° C. Also, since the active material products are immersed in alkaline electrolytic solution, alkali-resistant active material products must be used.

The thermoplastic resin having a softening temperature of 120° C. or lower, and the resin soluble in the solvent having a vaporizing temperature of 120° C. or lower may be at least any one selected from polyethylene, polypropylene, and ethylene vinyl acetate copolymer. The thermoplastic resin being melted by heating can be mixed with and dispersed in the active material powder or the electrically conductive filler.

The resin having a curing temperature ranging room temperature to 120° C. may be any one selected from reaction curing resin such as epoxy resin, polyurethane, or unsaturated polyester, and thermosetting resin such as phenol resin, or combinations thereof. The reaction-curing resin in a liquid state is mixed with the active material products and the electrically conductive filler, and thereafter, the resin is cured to cause a mixture to be solidified. The resin soluble in a solvent is dissolved in the solvent, and the solvent is vaporized and extracted to be removed. The resin soluble in the solvent soluble in water and extractable may be polyether sulfone (PES) resin, polystyrene, polysulfone, polyacrylonitrile, polyvinylidene fluoride, polyamide, or polyimide, and the resin soluble in the solvent soluble in alcohol and extractable may be acetylcellulose or oxide phenylene ether (PPO).

A coating layer comprising at least any one of a nickel-plated layer, carbon fibers, nickel-plated carbon fibers, nickel-plated carbon particles, nickel-plated organic fibers, fibrous nickel, nickel particles and nickel foil may be formed on a surface of the active material forming products for battery.

According to the present invention, there is provided a method of producing active material products for battery for use in a three-dimensional battery comprising two vessels connected to each other with a member interposed therebetween, and electrically conductive current collectors provided within the two vessels in contact with the active material products contained in electrolytic solutions filled in the two vessels, the member being configured to permit passage of an ion and not to permit passage of an electron, and the active material particles or the active material forming products filled in the electrolytic solution in one of the two vessels being adapted to discharge electrons and the active material particles or the active material forming products filled in the electrolytic solution in the other vessel being adapted to absorb the electrons, the method comprising adding electrically conductive filler and resin to an active material powder; and forming and curing the active material powder in a shape of particle, plate or bar to obtain particulate, plate-shaped or bar-shaped active material products.

In the above method, the active material powder may be obtained from nickel hydroxide powder. The nickel hydroxide powder may be obtained from a precipitate of nickel hydroxide and cobalt hydroxide obtained by neutralizing a mixed solution containing nickel salt and cobalt salt by alkali. Also, the nickel hydroxide powder may be obtained from a mixture comprising a precipitate of nickel hydroxide and carbon particles which is obtained by neutralizing a nickel salt solution with carbon particles suspended therein by alkali. Further, the nickel hydroxide powder may be obtained from a mixture of nickel hydroxide and cobalt hydroxide and carbon particles which are precipitated by neutralizing a mixed solution containing nickel salt and a minute amount of cobalt salt with carbon particles suspended therein by alkali.

In the above method, the active material powder may be a known active material for battery, which is any one selected from hydrogen-occluding alloy, cadmium hydroxide, lead, lead dioxide, and lithium. Or, the active material powder may be a solid material, which is any one selected from wood, graphite, carbon, iron ore, coal, charcoal, sand, gravel, silica, slag, and chaff.

The above method may further comprise, after adding a water-soluble compound (e.g., sodium carbonate) besides the electrically conductive filler and the resin to the active material powder, forming and curing the active material products, dissolving the water-soluble compound in water, and extracting and removing the water-soluble compound, thereby forming pores in the active material forming products.

The above method may further comprise adding particles of a compound, (e.g., KOH, NaOH, LiOH) which is converted into an electrolyte in the battery, besides the electrically conductive filler and the resin to the active material powder and the resin; forming and curing the active material products; and forming pores in the active material forming products by the dissolution of the electrolyte contained in the electrolytic solution or water when the active material products are used for the battery.

In the above method, the electrically conductive filler may be any one selected from carbon fibers, nickel-plated carbon fibers, carbon particles, nickel-plated carbon particles, nickel-plated organic fibers, fibrous nickel, nickel particles and nickel foil, or any combinations thereof.

In the above method, the resin may be thermoplastic resin having a softening temperature of 120° C. or lower, or resin having a curing temperature ranging from room temperature to 120° C. The thermoplastic resin may be selected from polyethylene, polypropylene, and ethylene vinyl acetate copolymer. In this case, the thermoplastic resin being melted by heating may be mixed with and dispersed in the active material powder. After mixing the active material powder and the electrically conductive filler with the thermoplastic resin dissolved in a solvent such as heated toluene or heated xylene, and dispersing a mixture of the active material powder, the electrically conductive filler, and the thermoplastic resin, the solvent is vaporized, and the active material products are formed to obtain particulate, plate-shaped or bar-shaped active material products.

The resin having a curing temperature ranging room temperature to 120° C. may be any one selected from reaction curing resin such as epoxy resin, polyurethane, resin, or unsaturated polyester, and thermosetting resin such as phenol resin, or combinations thereof.

In the above method, the resin may be selected from resin dissolved in a solvent having a vaporizing temperature of 120° C. or lower, resin dissolved in the water-soluble solvent, or resin dissolved in the alcohol-soluble solvent. The resin dissolved in the solvent having a vaporizing temperature of 120° C. or lower may be any one selected from polyethylene, polypropylene and ethylene vinyl acetate copolymer dissolved in heated toluene or heated xylene. When the resin dissolved in the solvent having a vaporizing temperature of 120° C. or lower is used, the solvent is removed from the cured products of the formed active material products by heating the solvent under a reduced pressure or a normal pressure.

The resin dissolved in the water-soluble solvent may be at least any one selected from PES resin dissolved in dimethyl sulfoxide (DMSO), polystyrene dissolved in acetone, polysulfone dissolved in dimethyl formamide (DMF) or DMSO, polyacrylonitrile dissolved in DMF, DMSO or ethylene carbonate, polyvinylidene fluoride dissolved in DMF, DMSO or N-methyl-2-pyrrolidone (NMP), polyamide dissolved in DMF or NMP, and polyimide dissolved in DMF or NMF. The resin dissolved in the alcohol-soluble solvent may be selected from acetylcellulose dissolved in methylene chloride or oxide phenylene ether (PPO)dissolved in methylene chloride. When the resin dissolved in the water-soluble or the alcohol-soluble solvent, the solvent is extracted and removed from the active material particles by using water or alcohol.

In the above method, the resin dissolved in the solvent may be added to the active material powder and the electrically conductive filler, and a mixture of the active material powder, the electrically conductive filler, and the resin may be granulated under agitation to be formed into the active material particles. Since the particles are formed by agitation, the size of the particles can be adjusted to be proper.

The active material particles may be formed and cured by tablet making or tablet forming. The particulate, plate-shaped, or bar-shaped active material products with high density is obtained by pressurized forming. The bar-shaped active material products are formed by extrusion molding. When using the tablet making, the tablet forming, the pressurized-forming, or the extrusion molding, the particulate active material products may be formed by crushing the formed active material products.

In the above method, it would be preferable that the active material particles which are angular in shape may be rounded to have smooth surfaces. Also, it would be preferable that nickel-plating is applied to surfaces of the active material particles. In order to increase output density of the battery, electric conductivity between the active material particles and electric conductivity between the active material particles and the current collectors is favorably increased. By applying Ni-plating to surfaces of the particles of the electrically conductive active material, electric conductivity between the electrically conductive material and the current collectors is improved. When the battery is constituted by the Ni-plated electrically conductive material applied to the surfaces, internal resistance of the battery can be reduced, and a voltage drop within the battery can be reduced.

It would be preferable that any one selected from carbon fibers, nickel-plated carbon fibers, carbon particles, nickel-plated carbon particles, nickel-plated organic fibers, fibrous nickel, nickel particles and nickel foil, is coated on the surfaces of the active material products. The coating of the surfaces with metal such as Ni can create the electrically conductive active material products having surfaces with improved conductivity.

The surfaces of the cured products are coated in such a manner that, after expanding and softening surfaces of the particles by using the solvent, any one selected from the carbon fibers, the nickel-plated carbon fibers, the carbon particles, the nickel-plated carbon particles, the nickel-plated organic fibers, the fibrous nickel, the nickel particles and the nickel foil, is added to the surfaces of the particles. Also, the surfaces of the active material particles are coated in such a manner that, after adding the resin dissolved in the solvent to the active material powder and the electrically conductive filler, and granulating under agitation and mixing a mixture of the active material powder, the electrically conductive filler and the resin to form particles, any one selected from the carbon fibers, the nickel-plated carbon fibers, the carbon particles, the nickel-plated carbon particles, the nickel-plated organic fibers, the fibrous nickel, the nickel particles and the nickel foil is added to the surfaces of the particles, and agitated.

2. Invention for Achieving the Second Objective

In order to achieve the second objective, according to the present invention, there is provided active material forming products for battery for use in a three-dimensional battery comprising two vessels connected to each other with a member interposed therebetween, and electrically conductive current collectors provided within the two vessels in contact with active material products contained in electrolytic solutions filled in the two vessels, the member being configured to permit passage of an ion and not to permit passage of an electron, and the active material forming products filled in the electrolytic solution in one of the two vessels being adapted to discharge electrons and the active material forming products filled in the electrolytic solution in the other vessel being adapted to absorb the electrons, the active material forming products being secondary forming products obtained by secondarily forming primary forming products produced by adding electrically conductive filler to an active material powder and curing a mixture of the active material powder and the electrically conductive filler by using resin.

In the above constitution, as the active material, all kinds of active materials may be used, regardless of the type of the secondary battery, or the cathode or the anode. For example, in the case of the nickel-hydrogen secondary battery, nickel hydroxide is used as the cathode active material and hydrogen-occluding alloy is used as the anode active material. In addition to these, known battery active materials such as cadmium hydroxide, lead, lead dioxide, lithium, etc, and further, general solid materials such as wood, graphite, carbon, iron ore, coal, charcoal, sand, gravel, silica, slag, chaff, etc, may be used.

In the above constitution, the electrically conductive filler may be any one selected from carbon fibers, nickel-plated carbon fibers, carbon particles, nickel-plated carbon particles, nickel-plated organic fibers, fibrous nickel, nickel particles and nickel foil, or combinations thereof.

The resin may be thermoplastic resin having a softening temperature of 120° C. or lower, resin having a curing temperature ranging from room temperature to 120° C., resin soluble in a solvent having a vaporizing temperature of 120° C. or lower, resin soluble in a water-soluble solvent, or a resin soluble in an alcohol-soluble solvent. When nickel hydroxide is used as the active material, various processes must be carried out at a temperature of 130° C. or lower, because nickel hydroxide loses its activity at a temperature of 130° C. or higher. Also, alkali-resistant active material must be used because the active material is immersed in the alkaline electrolytic solution.

The thermoplastic resin used for the primary forming products may be any one selected from polyethylene, polypropylene, and ethylene vinyl acetate copolymer, and the thermoplastic resin used for the secondary forming products may be any one selected from polyvinyl alcohol (PVA), polyethylene, polypropylene, and ethylene vinyl acetate copolymer. The resin having a curing temperature ranging from room temperature to 120° C. may be selected from reaction-curing resin such as epoxy resin, polyurethane resin, and unsaturated polyester resin, or thermosetting resin such as phenol resin. The resin soluble in the solvent having a vaporizing temperature of 120° C. or lower may be any one selected from polyethylene, polypropylene and ethylene vinyl acetate copolymer. When the resin soluble in the solvent is used, the resin dissolved in the solvent is added, and the solvent is vaporized and extracted. The resin soluble in the solvent soluble in water and extractable may be polyether sulfone (PES) resin, polystyrene, polysulfone, polyacrylonitrile, polyvinylidene fluoride, polyamide, or polyimide. The resin soluble in the alcohol-soluble solvent may be acetylcellulose or oxide phenylene ether (PPO).

In the above constitution, the primary forming products may have a shape selected from particle, plate, scale, cylindrical rod, polygonal cylindrical rod, sphere, dice, cube, and amorphous particle.

A coating layer comprising any one selected from a nickel-plated layer, carbon fibers, nickel-plated carbon fibers, carbon powder, nickel-plated carbon powder, fibrous nickel, nickel particles and nickel foil, may be formed on surfaces of the primary forming products.

In the above constitution, the secondary forming products may have a shape selected from cube, cylinder, block, and polygonal cylinder.

In the above constitution, the primary forming products forming secondary forming products may be spaced apart from one another. The structure in which the primary forming products are spaced from one another can improves ion-permeability. Also, the primary forming products forming secondary forming products may be closely filled so as to be in contact with one another, thereby increasing bulk density of the filled layer.

It would be preferable that the secondary forming products may be provided with concave and convex portions such as grooves or corrugation on surfaces thereof. Thereby, a space between the active material forming products and the electrolytic solution can be ensured.

According to the present invention, there is provided a method of producing active material forming products for battery for use in a three-dimensional battery comprising two vessels connected to each other with a member interposed therebetween, and electrically conductive current collectors provided within the two vessels in contact with the active material forming products contained in electrolytic solutions filled in the two vessels, the member being configured to permit passage of an ion and not to permit passage of an electron, and the active material forming products filled in the electrolytic solution in one of the two vessels being adapted to discharge electrons and or the active material forming products filled in the electrolytic solution in the other vessel being adapted to absorb the electrons, the method comprising: adding electrically conductive filler and resin to an active material powder; forming and curing a mixture of the electrically conductive filler, the resin and the active material powder to obtain primary forming products; and secondarily forming the primary forming products by pressurization and/or addition of resin, thereby obtaining electrically conductive active material forming products.

In the above method, the primary forming products may have a shape selected from particle, plate, scale, cylindrical rod, polygonal cylindrical rod, sphere, dice, cube, and amorphous particle.

The primary forming products may be secondarily formed after coating any one selected from carbon fibers, nickel-plated carbon fibers, carbon powder, nickel-plated carbon powder, nickel-plated organic fibers, fibrous nickel, nickel particles, and nickel foil on surfaces of the primary forming products. Or, the primary forming products may be secondarily formed after applying nickel-plating to surfaces thereof. The coating or plating metal Ni enables the active material products to have improved conductivity.

In the above method, the secondary forming products have a shape of any one selected from cube, cylinder, block, and polygonal cylinder.

In the above method, it would be preferable that the secondary forming products are formed such that the primary forming products are spaced from one another.

In the above method, it would be preferable that the primary forming products are filled in a mold provided with concave and convex portions such as grooves or corrugation to be formed to allow the secondary forming products to have concave and convex surfaces such as groove-shaped or corrugated surfaces.

In the above method, it would be preferable that the secondary forming products are formed after adding a water-soluble compound (e.g., sodium carbonate) to the primary forming products, and then, after dissolving the water-soluble compound in water, the water-soluble compound is extracted and removed, thereby forming pores in the active material forming products.

The method may further comprise secondarily forming the primary forming products by adding particles of a compound (e.g., KOH, NaOH, LiOH) to be converted into an electrolyte in the battery to the primary forming products; and forming pores in the active material forming products by the dissolution the electrolyte dissolved in an electrolytic solution or water, when the active material products are used for the battery.

In the above method, the electrically conductive filler used in secondary formation may be any one selected from carbon fibers, nickel-plated carbon fibers, carbon fine particles, nickel-plated carbon fine particles, nickel-plated organic fibers, fibrous nickel, nickel fine particles and nickel foil, or combinations thereof.

In the secondary formation, the resin contained in the particles of the primary forming products may be re-melted without adding resin.

The resin added in secondary formation may be thermoplastic resin having a softening temperature of 120° C. or lower, or resin having a curing temperature ranging from room temperature to 120° C. Thermoplastic resin used in secondary formation may be any one selected from PVA, polyethylene, polypropylene, and ethylene vinyl acetate copolymer. In this case, the thermoplastic resin being melted by heating may be mixed with the primary forming products. The secondary formation is carried out in such a manner that the primary forming products are mixed with the thermoplastic resin dissolved in the solvent such as heated toluene or heated xylene, and dispersed, and then the solvent is vaporized.

The resin having a curing temperature ranging from room temperature to 120° C. may be selected from reaction-curing resin such as epoxy resin, polyurethane resin, and unsaturated polyester resin, thermosetting resin such as phenol resin, or combinations thereof.

The resin added in secondary formation may be selected from resin dissolved in the solvent having a vaporizing temperature of 120° C. or lower, or resin dissolved in the water-soluble solvent. The resin dissolved in the solvent having a vaporizing temperature of 120° C. or lower may be any one selected from polyethylene, polypropylene and ethylene vinyl acetate copolymer dissolved in heated toluene or heated xylene. In this case, as described above, by vaporizing the solvent from the active material forming products, the resin is solidified. The solvent may be removed by heating under a reduced pressure or a normal pressure.

The resin dissolved in the water-soluble solvent may be any one selected from PES resin dissolved in dimethyl sulfoxide (DMSO), polystyrene dissolved in acetone, polysulfone dissolved in dimethyl formamide (DMF) or DMSO, polyacrylonitrile dissolved in DMF, DMSO or ethylene carbonate, polyvinylidene fluoride dissolved in DMF, DMSO, or N-methyl-2-pyrrolidone (NMP), polyamide dissolved in DMF or NMP, and polyimide dissolved in DMF or NMP. The resin dissolved in the alcohol-soluble solvent may be selected from acetylcellulose dissolved in methylene chloride or oxide phenylene ether (PPO) dissolved in methylene chloride. In this case, the solvent is extracted and removed from the active material forming products by using water or alcohol.

In the above method, the secondary forming products may be formed while maintaining a shape of the primary forming products.

In the above method, the secondary forming products may be formed by filling the primary forming products in a mold and applying a pressure to the primary forming products to allow bulk density of the secondary forming products to increase.

In the above method, after mixing and dispersing the resin dissolved in the solvent and the electrically conductive filler, a mixture of the resin and the electrically conductive filler may be converted into powder by vaporizing the solvent, and the primary forming products may be added to the powder to obtain the secondary forming products.

3. Invention for Achieving the Third Objective

In order to achieve the third objective, according to the present invention, there is provided active material products for battery with improved hydrophilicity, for use in a three-dimensional battery comprising two vessels connected to each other with a member interposed therebetween, and electrically conductive current collectors provided within the two vessels in contact with the active material products contained in electrolytic solutions filled in the two vessels, the member being configured to permit passage of an ion and not to permit passage of an electron, and the active material particles or the active material forming products filled in the electrolytic solution in one of the two vessels being adapted to discharge electrons and the active material particles or the active material forming products filled in the electrolytic solution in the other vessel being adapted to absorb the electrons, the active material products being produced by adding or applying at least one of inorganic oxide and inorganic hydroxide to active material forming products cured by resin after adding electrically conductive filler to an active material powder.

In the above constitution, as the active material, all kinds of active materials may be used, regardless of the type of the secondary battery, or the cathode or the anode. For example, in the case of the nickel-hydrogen secondary battery, nickel hydroxide may be used as the cathode active material and hydrogen-occluding alloy may be used as the anode active material. In addition to these, known battery active materials such as cadmium hydroxide, lead, lead dioxide, lithium, etc, and further, general solid materials such as wood, graphite, carbon, iron ore, coal, charcoal, sand, gravel, silica, slag, chaff, etc, may be used.

In the above constitution, the electrically conductive filler may be any one selected from carbon fibers, nickel-plated carbon fibers, nickel-plated organic fibers, carbon particles, nickel-plated carbon particles, fibrous nickel, nickel particles and nickel foil, or combinations thereof.

The resin may be thermoplastic resin having a softening temperature of 120° C. or lower, resin having a curing temperature ranging from room temperature to 120° C., resin soluble in a solvent having a vaporizing temperature of 120° C. or lower, resin soluble in a water-soluble solvent, or resin soluble in an alcohol-soluble solvent. Since nickel hydroxide as the active material loses its activity at a temperature of 130° C. or higher, various processes must be carried out at a temperature lower than 130° C. Also, since the active material products are immersed in alkaline electrolytic solution, alkali-resistant active material products must be used.

The thermoplastic resin having a softening temperature of 120° C. or lower may be any one selected from polyethylene, polypropylene, and ethylene vinyl acetate copolymer. The resin having a curing temperature ranging from room temperature to 120° C. may be selected from reaction-curing resin such as epoxy resin, polyurethane resin, and unsaturated polyester, or thermosetting resin such as phenol resin. The resin soluble in the solvent having a vaporizing temperature of 120° C. or lower may be any one selected from polyethylene, polypropylene and ethylene vinyl acetate copolymer. When the resin soluble in the solvent is used, the resin dissolved in the solvent is added, and the solvent is vaporized and extracted. The resin soluble in the solvent soluble in water and extractable may be polyether sulfone (PES) resin, polystyrene, polysulfone, polyacrylonitrile, polyvinylidene fluoride, polyamide, or polyimide. The resin soluble in the solvent soluble in alcohol and extractable may be acetylcellulose or oxide phenylene ether (PPO).

In the above constitution, the active material forming products may be pressurized-forming products or resin forming products having a shape selected from particle, plate, scale, cylindrical rod, polygonal cylindrical rod, sphere, dice, cube, and amorphous particle, or secondary forming products of the pressurized-forming products or the resin forming products.

A coating layer comprising at least any one selected from a nickel-plated layer, carbon fibers, nickel-plated carbon fibers, nickel-plated organic fibers, carbon particles, nickel-plated carbon particles, fibrous nickel, nickel particles and nickel foil may be formed on surfaces of active material forming products.

In the above constitution, the inorganic oxide may be metal oxide selected from titanium dioxide, silicon dioxide, calcium oxide, and calcium carbonate, or a material containing any one selected from the metal oxide as major component. The inorganic hydroxide may be metal hydroxide such as calcium hydroxide or a material containing calcium hydroxide as major component.

In the above constitution, the inorganic oxide or the inorganic hydroxide may be added or applied to surfaces of the active material forming products, or may be added to interior of the active material forming products.

According to the present invention, there is provided a method of producing hydrophilic active material products for battery, for use in a three-dimensional battery comprising two vessels connected to each other with a member interposed therebetween, and electrically conductive current collectors provided within the two vessels in contact with active material particles or active material forming products contained in electrolytic solutions filled in the two vessels, the member being configured to permit passage of an ion and not to permit passage of an electron, and the active material particles or the active material forming products filled in the electrolytic solution in one of the two vessels being adapted to discharge electrons and the active material particles or the active material forming products filled in the electrolytic solution in the other vessel being adapted to absorb the electrons, the method comprising: adding electrically conductive filler and resin to an active material powder; forming and curing the active material powder to obtain active material forming products; and applying or adding at least one of inorganic oxide and inorganic hydroxide to surfaces of the active material forming products.

In this case, it would be preferable that after suspending the inorganic oxide or and the inorganic hydroxide in a solvent, and immersing the active material forming products in the solvent with the inorganic oxide or the inorganic hydroxide dispersed therein to allow the inorganic oxide or the inorganic hydroxide to be applied to the surfaces of the active material forming products, the active material forming products are dried. The active material forming products may be dried by one of heating, vacuum drying, and pressure-reduced drying.

In the above method, the active material forming products may be kept in contact with the inorganic oxide or the inorganic hydroxide to allow the inorganic oxide or the inorganic hydroxide to be applied or added to surfaces of the active material forming products.

According to the present invention, there is provided a method of producing hydrophilic active material products for battery, adding at least one of electrically conductive filler, resin, and at least one of inorganic oxide and inorganic hydroxide to an active material powder; forming and curing the active material powder to obtain active material forming products; and adding at least one of the inorganic oxide and the inorganic hydroxide to interior of the active material forming products.

In the above method, the active material forming products may be pressurized-forming products or resin forming products having a shape selected from particle, plate, scale, cylindrical rod, polygonal cylindrical rod, sphere, dice, cube, and amorphous particle, or secondary forming products of the pressurized-forming products or the resin forming products.

One of carbon fibers, nickel-plated carbon fibers, nickel-plated organic fibers, carbon particles, nickel-plated carbon particles, fibrous nickel, nickel particles and nickel foil may be coated on surfaces of the active material forming products. Or, nickel plating may be applied to the surfaces of the active forming products. The coating or plating of metal Ni or the like allows the active material products to have improved conductivity.

In the above method, the inorganic oxide may be metal oxide selected from titanium dioxide, silicon dioxide, calcium oxide, and calcium carbonate, or a material containing any one selected from the metal oxide as major component. The inorganic hydroxide may be metal hydroxide such as calcium hydroxide or a material containing calcium hydroxide as major component. In the above application, the solvent in which one of the inorganic oxide and the inorganic hydroxide is dispersed may be water or an organic solvent selected from toluene, xylene, and isopropyl alcohol.

4. Invention for Achieving the Fourth Objective

In order to achieve the fourth objective, according to the present invention, there is provided activated active material products for battery, for use in a three-dimensional battery comprising two vessels connected to each other with a member interposed therebetween, and electrically conductive current collectors provided within the two vessels in contact with the active material products contained in electrolytic solutions filled in the two vessels, the member being configured to permit passage of an ion and not to permit passage of an electron, and the active material particles or the active material forming products filled in the electrolytic solution in one of the two vessels being adapted to discharge electrons and the active material particles or the active material forming products filled in the electrolytic solution in the other vessel being adapted to absorb the electrons, wherein the activated active material products are produced by adding electrically conductive filler to an active material powder and curing a mixture of the active material powder and the electrically conductive filler by using resin to obtain active material forming products, and the active material forming products are placed under pressure-reduced condition and then under a hydrogen-pressurized condition to form pores therein, thereby increasing activity of the active material products.

In the above constitution, as the active material, all kinds of active materials may be used, regardless of the type of the secondary battery, or the cathode or the anode. For example, in the case of the nickel-hydrogen secondary battery, nickel hydroxide is used as the cathode active material and hydrogen-occluding alloy is used as the anode active material. In addition to these, known battery active materials such as cadmium hydroxide, lead, lead dioxide, lithium, etc, and further, general solid materials such as wood, graphite, carbon, iron ore, iron carbide, iron sulfide, iron hydroxide, and iron oxide, coal, charcoal, sand, gravel, silica, slag, chaff, etc, may be used.

In the above constitution, the electrically conductive filler may be any one selected from carbon fibers, nickel-plated carbon fibers, nickel-plated organic fibers, nickel-plated inorganic fibers of silica or alumina, nickel-plated inorganic foil such as mica, carbon particles, nickel-plated carbon particles, fibrous nickel, nickel particles, and nickel foil, or combinations thereof.

The resin may be thermoplastic resin having a softening temperature of 120° C. or lower, resin having a curing temperature ranging from room temperature to 120° C., resin soluble in a solvent having a vaporizing temperature of 120° C. or lower, resin soluble in a water-soluble solvent, or resin soluble in an alcohol-soluble solvent. Since nickel hydroxide as the active material loses its activity at a temperature of 130° C. or higher, various processes must be carried out at a temperature lower than 130° C. Also, since the active material products are immersed in alkaline electrolytic solution, alkali-resistant active material products must be used.

The thermoplastic resin having a softening temperature of 120° C. or lower may be any one selected from polyethylene, polypropylene, and ethylene vinyl acetate copolymer. The resin having a curing temperature ranging from room temperature to 120° C. may be selected from reaction-curing resin such as epoxy resin, polyurethane resin, and unsaturated polyester, or thermosetting resin such as phenol resin. The resin soluble in the solvent having a vaporizing temperature of 120° C. or lower may be any one selected from polyethylene, polypropylene and ethylene vinyl acetate copolymer. When the resin soluble in the solvent is used, the resin dissolved in the solvent is added, and the solvent is vaporized and extracted. The resin soluble in the solvent soluble in water and extractable may be polyether sulfone (PES) resin, polystyrene, polysulfone, polyacrylonitrile, polyvinylidene fluoride, polyamide, or polyimide. The resin soluble in solvent soluble in alcohol and extractable may be acetylcellulose or oxide phenylene ether (PPO).

In the above constitution, the active material forming products may be pressurized-forming products or resin forming products having a shape selected from particle, plate, scale, cylindrical rod, polygonal cylindrical rod, sphere, dice, cube, and amorphous particle, or secondary forming products of the pressurized-forming products or the resin forming products.

A coating layer comprising at least any one selected from a nickel-plated layer, carbon fibers, nickel-plated carbon fibers, nickel-plated organic fibers, nickel-plated inorganic fibers of silica or alumina, nickel-plated inorganic foil of mica, carbon particles, nickel-plated carbon particles, fibrous nickel, nickel particles and nickel foil may be formed on surfaces of active material forming products.

In the above constitution, the gas to be applied under pressurized condition, which is other than hydrogen, may be any one selected from air, nitrogen, oxygen, ozone, carbon monoxide, carbon dioxide, helium, neon, argon, nitrogen monoxide, nitrogen dioxide and hydrogen sulfide.

According to the present invention, there is provided a method of activating active material products for battery, for use in a three-dimensional battery comprising two vessels connected to each other with a member interposed therebetween, and electrically conductive current collectors provided within the two vessels in contact with the active material products contained in electrolytic solutions filled in the two vessels, the member being configured to permit passage of an ion and not to permit passage of an electron, and the active material particles or the active material forming products filled in the electrolytic solution in one of the two vessels being adapted to discharge electrons and the active material particles or the active material forming products filled in the electrolytic solution in the other vessel being adapted to absorb the electrons, the method comprising: adding electrically conductive filler and resin to an active material powder and forming and curing a mixture of the active material powder, the electrically conductive filler, and resin to obtain active material forming products; placing the active material forming products under pressure-reduced condition; and placing the active material forming products under pressurized condition by injecting a gas to form pores in the active material forming products by the injected gas, thereby increasing activity of the active material products.

In this case, a closed vessel containing the active material forming products may be pressure-reduced to less than an atmospheric pressure by using a vacuum pump. Also, the closed vessel containing the active material forming products may be pressurized to more than an atmospheric pressure by using a pressure pump. The gas to be applied to the active material forming products for pressurization, which is other than hydrogen, may be any one selected from air, nitrogen, oxygen, ozone, carbon monoxide, carbon dioxide, helium, neon, argon, nitrogen monoxide, nitrogen dioxide and hydrogen sulfide.

In the above method, the active material forming products may be pressurized-forming products or resin forming products having a shape selected from particle, plate, scale, cylindrical rod, polygonal cylindrical rod, sphere, dice, cube, and amorphous particle, or secondary forming products of the pressurized-forming products or the resin forming products.

One of carbon fibers, nickel-plated carbon fibers, nickel-plated organic fibers, nickel-plated inorganic fibers of silica or alumina, nickel-plated inorganic foil of mica, carbon particles, nickel-plated carbon particles, fibrous nickel, nickel particles and nickel foil may be coated on the surfaces of the active material forming products. Nickel-plating may be applied to the surfaces of the active material forming products. By coating or plating metal Ni or the like, it is possible to create the active material products with improved conductivity.

Since the present invention is constituted as described above, the following remarkable effects are provided.

(1) In Accordance with the Invention for Achieving the First Objective, the Following Effects are Obtained.

1) The active material products do not collapse in the alkaline electrolytic solution. The active material forming products or particles can have conductivity and ion permeability. When the active material products are used in the three-dimensional battery, the active material products can keep conductivity.

2) By solidifying the active material particles by using resin, the fine powder does not fall off. Therefore, as a separator for battery, for example, inexpensive non-woven fabric provided with large holes, may be used.

3) By using the thermoplastic resin dissolved in the organic solvent, the particulate active material can be easily produced by agitation.

4) It is possible to obtain active material products for battery capable of easily scale up in a single battery.

5) The particulate active material products can be easily filled a space between an electrode and a separator. And, without a need to disassemble the battery, only the active material products can be discharged and easily recovered for recycling.

(2) In Accordance with the Invention for Achieving the Second Objective, the Following Effects are Obtained.

1) In the electrically conductive active material products for use in the fixed-layer three-dimensional battery, the active material forming particles (primary forming products) are secondarily formed. Thereby, the bulk density of the filled layer is increased and a contact area between the active material particles is increased. As a result, the capacity of the battery in an equal volume is increased, and thereby battery performance is improved.

2) Since the active material forming particles (primary forming products) are secondarily formed, the particulate active material products can be handled more easily.

3) Since the secondary forming products of the active material products are provided with concave and convex portions such as grooves and corrugation, a space in which an electrolytic solution exists is ensured on the separator side, and a space through which a gas passes is ensured on the current collector side.

(3) In Accordance with the Invention for Achieving the Third Objective, the Following Effects are Obtained.

1) By applying or adding the inorganic oxide or the inorganic hydroxide to the active material products for battery, hydrophilicity of the active material products can be improved and thereby become well compatible with the electrolytic solution. As a result, battery reaction is promoted, and battery performance is thereby improved.

2) Since the active material products for battery is caused to only make contact with the solvent with the inorganic oxide or the inorganic hydroxide dispersed therein, operation is easy.

3) Since the active material products for battery is caused to only make contact with the inorganic oxide or the inorganic hydroxide, operation is easy.

(4) In Accordance with the Invention for Achieving the Fourth Objective, the Following Effects are Obtained.

1) The particulate or plate-shaped active material forming products for battery, secondary forming products of these, plated active material forming products, or surface-treated active material forming products can be placed under a reduced-pressure or pressurized condition, thereby increasing activity of the active material products.

2) Before the battery is assembled or after the battery is assembled under the condition in which the electrolytic solution is not injected yet, the active material products are placed under pressure-reduced or pressurized condition. As a result, since the activity of the active material products is increased, the battery can exhibit desired battery performance just after assembling the battery.

3) The active material products can be placed under pressure-reduced or pressurized condition, regardless of the kind of the material, and the cathode or the anode. Thus, the activity of all the active material products can be increased.

4) In contrast to the conventional method that increases activity of the active material products by repeated charge and discharge, the activity of the battery can be increased in a very short time, and the battery can exhibit high performance just after assembling the battery. Moreover, time for producing the battery can be significantly reduced.

### BRIEF DESCRIPTION OF THE DRAWINGS

FIG. 1 is a cross-sectional view showing a schematic structure of an example of a battery comprising a cathode particulate active material products and an anode particulate active material products;

FIG. 2(a) is a perspective view showing an example of a tester of a layered three-dimensional battery and

FIG. 2(b) is a central longitudinal sectional view schematically showing the three-dimensional battery; and

FIG. 3 is a perspective view partially showing main components before assembling the tester (in a disassembled state) of the layered three-dimensional battery in FIG. 2.

### BEST MODE FOR CARRYING OUT THE INVENTION

Hereinafter, embodiments of the present invention will be described. The present invention is not limited to the embodiments described below but may be suitably altered and carried out.

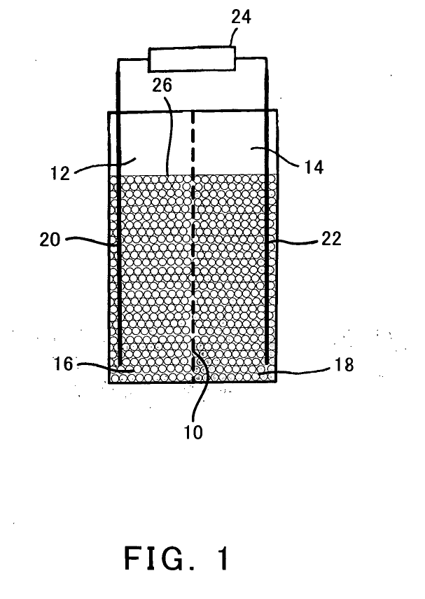

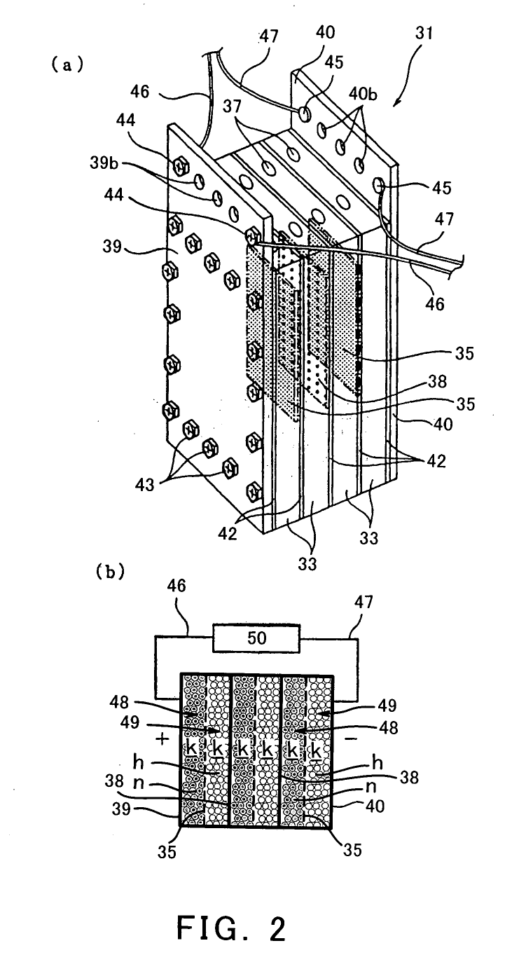

First of all, a schematic structure of a three-dimensional battery will be described. FIG. 1 is a cross-sectional view showing a schematic structure of an example of a battery comprising a cathode particulate active material products and an anode particulate active material products. As shown in FIG. 1, an anode cell 12 and a cathode cell 14 are provided with an ion-permeable filter (separator) 10 interposed between them. The anode cell 12 is filled with an electrolytic solution and an anode particulate active material products 16. The cathode cell 14 is filled with an electrolytic solution and a cathode particulate active material products 18. The particulate active material products exist within the electrolytic solutions as fixed layers. In FIG. 1 and FIG. 2 to be described later, the size of the particulate active material products are equal for the convenience, but actually, differ from each other, as a matter of course.

The separator 10 is an electrically-insulative. The separator 10 serves as an ion-passing membrane and does not serves as a particle-passing membrane. As the separator 10, an unglazed battery, an ion exchange resin membrane, a polymer fibers, or the like is used.

An anode current collector 20 comprising a conductor and a cathode current collector 22 comprising a conductor are respectively provided in the anode cell 12 and the cathode cell 14, respectively. The current collectors 20 and 22 are connected to a load means (for discharge) or to a powder generation means 24 (for charge). Reference numeral 26 denotes an electrolytic solution interface.

Subsequently, mechanism of charge and discharge of the battery of this embodiment will be described.

(Charge)

A voltage is applied to the battery and an electron is supplied from the anode current collector 20. The electron reacts with the anode particulate material immediately on the anode current collector 20 or while traveling through the anode particulate material. An ion produced by the reaction passes through the separator 10 and enters the cathode cell 14, where it reacts with the cathode particulate active material products and discharges the electron. The electron moves to the cathode current collector 22 immediately or through the particulate active material products and is supplied to the power generation means 24.

(Discharge)

A load is applied to the battery and an electron is supplied from the anode current collector 20. The electron reacts with the positively ionized material immediately on the anode current collector 20 or while traveling through the anode particulate material within the anode cell 12. An ion produced by the reaction passes through the separator 10 and enters the cathode cell 14, where it reacts with the cathode particulate active material products and the electron. The electron moves to the cathode current collector 22 immediately or through the particulate active material products and is supplied to the load means 24.

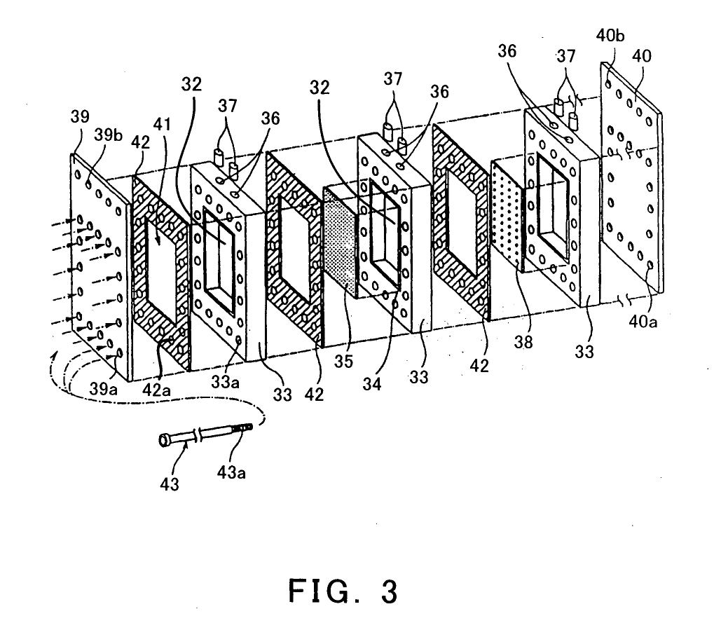

FIGS. 2(a) and 2(b) are a perspective view and a schematic cross-sectional view showing an example of a tester of a layered three-dimensional battery, and FIG. 3 is a perspective view partially showing main components before assembling of the tester (in a disassembled state) of the layered three-dimensional battery.

As shown in FIG. 2, a layered three-dimensional battery 31 is a nickel-hydrogen battery. As shown in FIG. 3, the battery 31 is structured to have a pair of two cell (vessel) members 33 each having a square central opening 32 penetrating therethrough in a thickness direction thereof. In this example, two pairs (four in total) cell members 33 are provided. A shallow (in this example, 0.5 mm deep) concave portion 34 is formed annularly at a periphery of an opening 32 of each of the cell members 33. A substantially-square and alkali-resistant ion-permeable separator 35 is fitted in the concave portion 34 between the cell members 33. The separator 35 is a membrane which permits only ions to pass therethrough but does not permit the active material products and electron to pass therethrough. Two injection ports 36 through which an electrolytic solution is injected are formed in an upper surface of each of the cell members 33 such that they vertically penetrate toward the opening 32 and are spaced apart from each other in the width direction thereof. Rubber plugs 37 are removably attached to the respective injection ports 36.

A substantially-square, alkali-resistant, electrically conductive, and plate-shaped current collector 38 is fitted into the concave portion 34 between the cell members 33 in each pair. Alkali-resistant and electrically conductive current collectors 39 and 40 are provided on both ends of the two pairs of the cell members 33 and have a width as large as that of the cell members 33 and a height larger than that of the cell members 33. Rubber packings 42 are respectively interposed between the cell members 33, between the cell member 33 and the current collector 39, and the cell member 33 and collector 40. The rubber packings 42 have openings 41 shaped identically to the openings 32 in central portions thereof and have outer shapes identical to those of the cell members 33. A plurality of insertion holes 33a, 42a, 39a, 40a are formed around the openings 32 and 41 in the cell members 33, the packings 42, and the current collectors 39 and 40 such that these holes penetrate in the thickness directions thereof and are spaced along their peripheries. Non-electrically conductive bolts 43 are inserted through the plurality of insertion holes 33a, 42a, 39a, 40a and nuts (not shown) are securely screwed to tip screw portions 43a of the bolts 43. Small holes 39b and small holes 40b are respectively formed at upper end portions of the left-end (cathode) and right-end (anode) current collectors 39 and 40 such that these holes are spaced in the width directions thereof. In this example, cathode terminals 44 and anode terminals 45 are respectively fitted to the small holes 39b of the left-end current collector 39 and the small holes 40b of the right-end current collector 40 and one end portions of wirings 46 and 47 are connected to these terminals.

A potassium hydroxide solution k as the electrolytic solution is injected into each of the cell members 33 through the injection ports 36. Nickel hydroxide n as the cathode particulate active material products, hydrogen-occluding alloy h as the anode particulate active material products, nickel hydroxide n as the cathode particulate active material products, hydrogen-occluding alloy h as the anode particulate active material products are put into the potassium hydrogen aqueous solution k sequentially from the left-end cell member 33 of FIG. 2(b). As a result, from the left end to the right end in FIG. 2(b), a cathode cell 48, an anode cell 49, the cathode cell 48, and the anode cell 49 are sequentially formed. Reference numeral 50 denotes a load means (for discharge) or a power generation means (for charge).

### (1) EMBODIMENT OF THE INVENTION FOR ACHIEVING FIRST OBJECTIVE

Particulate active material products used in the above-mentioned three-dimensional battery is produced in such a manner that electrically conductive filler and resin as a binder are added to active material powder which becomes active material products and the resulting active material products is shaped and cured. For example, in the case of the nickel-hydrogen secondary battery, nickel hydroxide used as the cathode is non-electrically conductive, and therefore, the electrically conductive filler is mixed with nickel hydroxide powder to allow the active material products to gain conductivity. As the electrically conductive filler, carbon particles, carbon fibers, Ni metal particles, Ni metal fibers, Ni metal foil, Ni-plated particles, Ni-plated fibers may be used. The use of the particulate material as the electrically conductive filler allows ions to permeate through gap between the nickel hydroxide and the electrically conductive filler. More preferably, electrically conductive fiber filler is used, because active material forming products has some clearance due to spring back under a pressure-released state during pressure formation, through which ions travel, thus facilitating ion exchange. Also, a high internal resistance of the battery causes a loss of the voltage, and a large loss of the voltage is problematic. For example, by setting conductivity of the electrically conductive material to have a volume resistance of 5 Ω/cm³ or less, resistance can be set to 0.05 Ω or less in an electrode of 10 cm square and an active material electrode of 1 cm thickness.

The nickel hydroxide powder may be a precipitate of nickel hydroxide and cobalt hydroxide. Industrial nickel hydroxide is composed of spherical particles of approximately 10 μm for increasing filling density. A mixture of nickel hydroxide contains Co compound of approximately 1% and some other components. It is said that Co(OH)₂ is converted into CoOOH by charge, which exhibits conductivity. Ni (OH)₂ is obtained by neutralizing Ni acid solution with alkali and precipitating the resulting hydroxide. In this case, a mixed solution of Ni and Co is neutralized with alkali and Ni(OH)₂ and Co(OH)₂ are both precipitated.

Carbon fine particles are suspended in the Ni acid solution and neutralized, thereby producing particles with Ni(OH)₂ attached around carbon fine particles or a precipitate of a mixture of carbon fine particles and Ni(OH)_{2.} Since the carbon fine particles have high conductivity, highly electrically conductive nickel hydroxide powder can be produced.

It is advantageous that the active material forming products are formed under pressure for reducing electric resistance. However, drawbacks of such formation are such that diffusion of electrolytic ions is impeded and concentration polarization occurs, thereby lowering discharge voltage. As a solution to this, particles of water-soluble compound (e.g., sodium carbonate) are added to and mixed with active material mixture before shaping, and the resulting mixture is formed under pressure by press forming, tablet forming, extrusion molding, or the like so that the entire mixture becomes dense. Alternatively, the mixed powder is agitated to form active material forming products, which is then immersed in water. By extracting water-soluble compound, electrolytic ions easily permeate within the forming products through cavity corresponding to the compound, thereby inhibiting voltage reduction due to concentration polarization.

When alkali such as KOH, NaOH, LiOH or the like used as electrolyte is added to the active material mixture before shaping, the alkali is dissolved in an electrolytic solution or water and converted into electrolyte. Therefore, it is not necessary to perform extraction of the compound, which takes place when adding the water-soluble compound. By immersing the active material forming products in the electrolytic solution or water and dissolving alkali, the active material products with internal holes and small concentration polarization is obtained. Since the alkali such as KOH or NaOH is deliquescent, it is difficult to crush such material into particles under normal atmosphere. Assuming that crush and mixing are conducted under low humidity condition, KOH, NaOH, or the like may be used, but this is burdensome and expensive. On the other hand, such problem does not exist in water-soluble salts such as sodium carbonate, and the above method is simple and inexpensive. But performance of the electrolytic solution would be degraded unless such water-soluble salt is extracted and removed.

By using alkali-resistant resin stable in alkali as a binder and solidifying the active material products and the electrically conductive filler in contact, the forming products do not expand and collapse in alkali. Thereby, the shape of the forming products can be maintained, and therefore the active material products can stably maintain conductivity within alkaline electrolytic solution. Also, by solidifying nickel hydroxide and electrically conductive filler with a small amount of resin, nickel hydroxide particles become highly electrically conductive, while by solidifying particles with a small amount of resin, the electrolytic solution easily enters the forming products and electrolyte is smoothly supplied to the active material products during reaction of the active material products. In addition, since the shape of the active material products is maintained under this condition, conductivity of these and ion exchangeability between them can be maintained, and reactivity of the active material products can be stably maintained.

When particulate electrically conductive material such as carbon fine powder is used in large amount as the electrically conductive material, conductivity is improved indeed. But, large amount of resin is required to solidify the particulate electrically conductive material. This impedes permeation of ions within the solidified material and causes concentration polarization, thereby reducing an electromotive force. In order to increase conductivity within the forming products with less electrically conductive material, electrically conductive fiber material such as carbon fibers is advantageously used. This is because network is created by electric wires comprising electrically conductive fiber material within the particles, and nickel hydroxide is coupled to the network by means of the particulate electrically conductive material, thereby obtaining desired conductivity with less electrically conductive particles. By using the fiber material as the electrically conductive filler, high conductivity is gained with less electrically conductive material, and the entire forming products can be cured with a small amount of resin.

As the resin used as the binder, thermoplastic resin such as polyethylene, polypropylene, or ethylene vinyl acetate copolymer may be used. In this case, thermoplastic resin may be melted by heating and mixed with the active material powder or the like. But, when the resin is dissolved in a solvent and added to the active material powder, the resin tends to be uniformly dispersed in the active material powder, so that the active material mixture may be formed with a small amount of resin. For example, polyethylene, polypropylene, or ethylene vinyl acetate copolymer is soluble in a solvent such as heated benzene, toluene, or xylene. Also, styrene resin is soluble in acetone solvent. After the resin dissolved in any of these solvents is mixed with the active material and the electrically conductive filler, the solvent is removed by vaporization, thereby creating the active material products solidified by the resin.

As the reaction curing resin, epoxy resin, urethane resin, unsaturated polyester resin may be used as the binder. As thermosetting resin, phenol resin, or the like, may be used as the binder.

When using resin dissolved in a solvent soluble in water or alcohol, the solvent is extracted and removed by using the water or alcohol, thereby creating the active material products solidified by the resin. For example, polyether sulfone (PES) resin is soluble in dimethyl sulfoxide (DMSO). DMOS has a high boiling point. By removing DMSO by vaporization and solidifying resin dissolved in the solvent, β-nickel hydroxide loses its activity. When DMOS is used, the solvent is removed and cured by using an extraction material (in this case, water) in which the resin is not soluble but the solvent is soluble. So, the resin dissolved in the solverit may be mixed with nickel hydroxide and the electrically conductive filler, and the resulting forming products may be solidified in the extraction material (water). The resin obtained by curing PES dissolved in DMSO by DMSO removing method using water can be made porous, which favorably increases contact area between the electrolyte and the battery active material products.

When polystyrene dissolved in acetone is used as the resin, polyethylene is mixed with the active material products, and acetone is extracted by using water, thereby obtaining an active material products similar to the active material products solidified by PES. In the same manner, the method of extracting a solvent by using water is applicable to polysulfone dissolved in DMF or, DMSO, polyacrylonitrile dissolved in DMF, DMOS or ethylene carbonate, polyvinylidene fluoride dissolved in DMF, DMOS or NMP, polyamide dissolved in DMF or NMP, polyimide dissolved in DMF or NMP, or the like. As the resin soluble in an alcohol-soluble solvent, acetylcellulose dissolved in methylene chloride, oxide phenylene ether (PPO) dissolved in methylene chloride, or the like may be used.

When the resin dissolved in the solvent is mixed with the active material powder and the electrically conductive filler to allow active material forming products to be formed, a mixture of these may be agitated to form particles. The agitation can adjust the size of particles to be proper.

In forming the products, tablet making, tablet forming, pressurized forming, extrusion molding, or the like may be used. In order to increase contact area between the active material products and the electrically conductive filler, it is advantageous that the mixture is formed by pressurized forming. When using the tablet making, the tablet forming, the pressurized forming or the like, active material particles can be directly obtained. The particulate forming products obtained by the tablet making or the tablet forming, plate-shaped or particulate forming products obtained by pressurized forming, bar-shaped forming products obtained by extrusion molding, may be crushed into active material particles of proper size. The active material particles can be easily filled in cells constituted by electrodes and separators of the three-dimensional battery. If the active material products are degraded, the degraded active material products are discharged and recovered. The active material products are filled again, thus facilitating recycle without disassembling the battery. The discharged degraded active material products are separated from other battery components, and therefore can be easily recovered.

Typically, the crushed particles or the tablet particles are angular. If the angular particles are filled in the cells, filling density is low, or conductivity of particles is low. In order to solve this, the angular particles are favorably rounded to provide smooth surfaces. To this end, the active material particles or a mixture of the active material particles and other grinding medium is agitated to allow the angular particles to be rounded.

The filled layer of particles with filling density increased by the above method, has conductivity much lower than that of each particle. For this reason, a large current does not flow in such a filled layer. When an electrically conductive layer is formed on outer surfaces of particles by Ni plating, electrons from the active material products within the particles pass through the particles and then through the electrically conductive layer outside the particles and move to the electrodes (current collectors). During charge, in the reverse procedure, the cathode active material products receives electrons from the electrode quickly, thus allowing a large current to flow. When plating around the particles is thick, the particles are entirely covered with metal, so that the electrolytic solution does not go into the particles. For this reason, concentration polarization occurs due to concentration grade. As a result, battery performance is degraded.

To form the electrically conductive layer on the outer surfaces of the particles, coating by using Ni metal powder, Ni metal fibers, Ni metal foil, Ni plated fibers (carbon fibers, or organic fibers), Ni-plated particles, etc, may be conducted. Unlike previously-described plating, in this coating method, the particles are not entirely covered, and there are clearances between metal particles and between metal fibers, through which the electrolytic solution enters the particles. So, much coating does not degrade performance of the battery. In the coating method, the metal powder, metal fibers, or metal-plated fibers, is added to the particles before being cured, followed by rolling and agitation, thereby allowing any of the metal powder, metal fibers, or the metal-plated fibers to adhere to soft outer surfaces of the particles. In the case of particles solidified by the resin, for example, particles solidified by thermally-softened resin or resin soluble in a solvent, the particles is heated up to a high temperature so as to be softened, or the solvent is added to the particles to allow the particles to be expanded and softened to be thereby uncured. Then, metal is added to the uncured particles.

The particulate active material forming products are easily filled between the electrode and the separator in production of the three-dimensional battery. Conventionally, the nickel-hydrogen secondary battery needs to be disassembled into components for the purpose of recycling, because of its integral forming product. The particulate active material forming products filled in the electrode vessels can be immediately used as the battery. If the active material products are degraded, the active material forming products can be discharged without disassembling the battery. As a result, recycling is easily carried out by discharging, recovering, and re-filling the active material products.

The above description has been given of nickel hydroxide as the cathode active material products of the nickel-hydrogen secondary battery, but the present invention is not intended to be limited to this. In addition to hydrogen-occluding alloy as the anode active material of the nickel-hydrogen secondary battery, the present invention is applicable to known battery active material such as cadmium hydroxide, lead, lead dioxide, lithium, and further solid materials such as wood, graphite, carbon, iron ore, coal, charcoal, sand, gravel, silica, slag, or chaff.

Hereinbelow, examples of the present invention will be described.

### EXAMPLE 1

150 g of particulate graphite (acetylene black, ketchen black) was put into a Henschel mixer having an internal volume of 10 liters and agitated at 1000 rpm for about 3 minutes to be sufficiently dispersed. Then, 1000 g of nickel hydroxide powder for battery and 100 g of nickel-plated carbon fiber 10 mm chip were added to and mixed with the particulate graphite at 1000 rpm for about 3 minutes. Then, 150 g of polyethylene as thermoplastic resin was added to and mixed with the particulate graphite for 10 minutes at a temperature of not lower than a softening temperature of resin and lower than 130° C. The resulting mixture was taken out and put into a metal mold of 2 mm depth to be molded in the shape of board. The board-shaped mixture was cooled and then taken out from the metal mold. The molded board-shaped mixture was crushed by a hammer crusher. The crushed particles were sieved with a 2.88 mm-mesh sieve and a 1 mm-mesh sieve, thereby obtaining particles of a particular diameter of 1 to 2.88 mm.

### EXAMPLE 2

150 g of particulate graphite (acetylene black, ketchen black) was put into the Henschel mixer having an internal volume of 10 liters and agitated at 1000 rpm for about 3 minutes to be sufficiently dispersed. Then, 2500 g of hydrogen-occluding alloy powder for battery was added to and mixed with the particulate graphite at 1000 rpm for about 3 minutes. Then, 150 g of ethylene vinyl acetate copolymer as thermoplastic resin was added to and mixed with the particulate graphite for 10 minutes at a temperature of not lower than a softening temperature of resin and lower than 130° C. The resulting mixture was taken out and put into the metal mold of 2 mm depth to be molded in the shape of board. The board-shaped mixture was cooled and then taken out from the metal mold. The molded board-shaped mixture was crushed into particles by a hammer crusher. The crushed particles were sieved with a 2.88 mm-mesh sieve and a 1 mm-mesh sieve, thereby obtaining particles of a particle diameter of 1 to 2.88 mm.

### EXAMPLE 3

150 g of particulate graphite (acetylene black, ketchen black) was put into the Henschel mixer having an internal volume of 10 liters and agitated at 1000 rpm for about 3 minutes to be sufficiently dispersed. Then, 1000 g of nickel hydroxide powder for battery and 100 g of carbon fibers (trade name: DONER S-247) were added to and mixed with the particulate graphite at 1000 rpm for about 3 minutes. 150 g of ethylene vinyl acetate copolymer was added to and dissolved in 1000g of xylene heated to 60° C. Resin dissolved in the heated xylene was added to a mixture of the nickel hydroxide powder and the electrically conductive filler which were heated to 60° C. and agitated by the Henschel mixer while being kept at 60° C. Then, the Henschel mixer was cooled while agitating the mixture, and the mixture was cooled and crushed into powder. The powder was put into a high-speed mixer and entirely agitated by an agitator while adjusting the size of granulated particles by a chopper. The powder was agitated under the condition in which the high-speed mixer had a volume of 2 liters, the number of rotations of the agitator was 600 rpm, and the number of rotations of the chopper was 1500 rpm, and temperature of the powder was increased from room temperature to 50° C. After formation of the granulated particles, agitation was stopped while cooling the granulated particles. The particles containing xylene, was put into a pressure-reducing drier and heated to 50° C., to remove xylene. The particles were cooled and then sieved with a 2.88 mm-mesh sieve and a 1 mm-mesh sieve, thereby obtaining particles of a particle diameter of 1 to 2.88 mm.

### EXAMPLE 4

150 g of particulate graphite (acetylene black, ketchen black) was put into the Henschel mixer having an internal volume of 10 liters and agitated at 1000 rpm for about 3 minutes to be sufficiently dispersed. Then, 1000 g of nickel hydroxide powder for battery and 100 g of carbon fibers (trade name: DONER S-247) were added to and mixed with the particulate graphite at 1000 rpm for about 3 minutes. 150 g of ethylene vinyl acetate copolymer was added to and dissolved in 1000 g of xylene heated to 60° C. Resin dissolved in the heated xylene was added to a mixture of the nickel hydroxide powder and the electrically conductive filler which were heated to 60° C. and agitated by the Henschel mixer while being kept at 60° C. Then, the Henschel mixer was cooled while agitating the mixture, and the mixture was cooled and crushed into powder. The powder was put into the high-speed mixer and entirely agitated by the agitator while adjusting the size of the granulated particles by the chopper. The powder was agitated under the condition in which the high-speed mixer had a volume of 2 liters, the number of rotations of the agitator was 600 rpm, and the number of rotations of the chopper was 1500 rpm, and temperature of the powder was increased from room temperature to 50° C. After formation of the granulated particles, 50 g of Ni-plated carbon fibers crushed to have an average length of approximately 200 μm was added to the particles with agitation continued, and the resulting mixture was further agitated for 5 minutes. Thereafter, agitation was stopped while cooling the particles. The particles containing xylene, was put into a pressure-reducing drier and heated to 50° C., to remove xylene. The particles were cooled and then sieved with a 2.88 mm-mesh sieve and a 1 mm-mesh sieve, thereby obtaining particles of a particle diameter of 1 to 2.88 mm.

### EXAMPLE 5

150 g of particulate graphite (acetylene black, ketchen black) was put into the Henschel mixer having an internal volume of 10 liters and agitated at 1000 rpm for about three minutes to be sufficiently dispersed. Then, 1000 g of nickel hydroxide powder for battery and 100 g of carbon fibers (trade name: DONER S-247) were added to and mixed with the particulate graphite at 1000 rpm for about 3 minutes. 150 g of PES resin was added to and dissolved in 2000 g of DMSO. The mixture of the nickel hydroxide powder and the electrically conductive filler was put into the high-speed mixer and agitated by an agitator, and PES resin dissolved in DMSO was added while adjusting the size of the granulated particles by the chopper. The mixture was agitated under the condition in which the high-speed mixer had a volume of 2 liters, the number of rotations of the agitator was 600 rpm, and the number of rotations of the chopper was 1500 rpm. After formation of the granulated particles, 50 g of Ni-plated carbon fiber crushed to have an average length of approximately 200 μm was added to the particles with agitation continued, and further, the resulting mixture was agitated for 5 minutes. Then, agitation was stopped while cooling the particles. The particles containing DMSO, was put into water of 10 liters, to remove DMSO. The particles were taken out and dried. Then, the particles were sieved with a 2.88 mm-mesh sieve and a 1 mm-mesh sieve, thereby obtaining particles of a particle diameter of 1 to 2.88 mm.

### EXAMPLE 6

150 g of particulate graphite (acetylene black, ketchen black) was put into the Henschel mixer having an internal volume of 10 liters and agitated at 1000 rpm for about 3 minutes to be sufficiently dispersed. Then, 2500 g of hydrogen-occluding alloy powder for battery and 100 g of carbon fibers (trade name: DONER S-247) were added to and mixed with the particulate graphite at 1000 rpm for about 3 minutes. 150 g of ethylene vinyl acetate copolymer was added to and dissolved in 1000 g of xylene heated to 60° C. Resin dissolved in the heated xylene was added to a mixture of the hydrogen-occluding alloy and the electrically conductive filler which were heated to 60° C. and agitated by the Henschel mixer while being kept at 60° C. Then, the Henschel mixer was cooled while agitating the mixture, and the mixture was cooled and crushed into powder. The powder was put into the high-speed mixer and agitated by an agitator while adjusting the size of the granulated particles by the chopper. The powder was agitated under the condition in which the high-speed mixer had a volume of 2 liters, the number of rotations of the agitator was 600 rpm, and the number rotations of the chopper was 1560 rpm, and temperature of the powder was increased from room temperature to 50° C. After formation of the granulated particles, agitation was stopped while cooling the granulated particles. The particles containing xylene, was put into a pressure-reducing drier and heated to 50° C., to remove xylene. The particles were cooled and then sieved with a 2.88 mm-mesh sieve and a 1 mm-mesh sieve, thereby obtaining particles of a particle diameter of 1 to 2.88 mm.

### EXAMPLE 7

150 g of particulate graphite (acetylene black, ketchen black) was put into the Henschel mixer having an internal volume of 10 liters and agitated at 1000 rpm for about 3 minutes to be sufficiently dispersed. Then, 2500 g of hydrogen-occluding alloy powder for battery and 100 g of carbon fibers (trade name: DONER S-247) were added to and mixed with the particulate graphite at 1000 rpm for about 3 minutes. 150 g of PES resin was added to and dissolved in 2000 g of DMSO. The mixture of the hydrogen-occluding alloy powder and the electrically conductive filler was put into the high-speed mixer and entirely agitated by the agitator, and PES resin dissolved in DMSO was added while adjusting the size of the granulated particles by the chopper. The mixture was agitated under the condition in which the high-speed mixer had a volume of 2 liters, the number of rotations of the agitator was 600 rpm, and the number of rotations of the chopper was 1500 rpm. After formation of the granulated particles, the high-speed mixer was stopped. The particles containing DMSO, was put into water of 10 liters, to remove DMSO. The particles were taken out and dried. Then, the particles were sieved with a 2.88 mm-mesh sieve and a 1 mm-mesh sieve, thereby obtaining particles of a particle diameter of 1 to 2.88 mm.

### EXAMPLE 8

150 g of particulate graphite (acetylene black, ketchen black) was put into the Henschel mixer having an internal volume of 10 liters and agitated at 1000 rpm for about 3 minutes to be sufficiently dispersed. Then, 1000 g of nickel hydroxide powder for battery and 100 g of carbon fibers (trade name: DONER S-247) were added to and mixed with the particulate graphite at 1000 rpm for about 3 minutes. Then, 100 g of sodium carbonate particles of a particle diameter of approximately 500 μm was added to the mixed powder and sufficiently mixed. 150 g of ethylene vinyl acetate copolymer was added to and dissolved in 1000 g of xylene heated to 60° C. Resin dissolved in the heated xylene was added to a mixture of the nickel hydroxide powder, the electrically conductive filler and the sodium carbonate which were heated to 60° C. and agitated by the Henschel mixer while being kept at 60° C. Then, the Henschel mixer was cooled while agitating the mixture, and the mixture was cooled and crushed into powder. The powder was put into a high-speed mixer and entirely agitated by the agitator while adjusting the size of the granulated particles by the chopper. The powder was agitated under the condition in which the high-speed mixer had a volume of 2 liters, the number of rotations of the agitator was 600 rpm, and the number of rotations of the chopper was 1500 rpm, and temperature of the powder was increased from room temperature to 50° C. After formation of the granulated particles, agitation was stopped while cooling the granulated particles. The particles containing xylene, was put into the pressure-reducing drier and heated to 50° C., to remove xylene. The particles were cooled and then sieved with a 2.88 mm-mesh sieve and a 1 mm-mesh sieve, thereby obtaining particles of a particle diameter of 1 to 2.88 mm. The particles were put into water of 10 liters and sodium carbonate taken in the particles were extracted and removed from the particles. Thereafter, the particles were cleaned by water to allow adhering sodium carbonate to be completely removed, and dried, thus creating a product.

### EXAMPLE 9

150 g of particulate graphite (acetylene black, ketchen black) was put into the Henschel mixer having an internal volume of 10 liters and agitated at 1000 rpm for about 3 minutes to be sufficiently dispersed. Then, 1000 g of nickel hydroxide powder for battery and 100 g of carbon fibers (trade name: DONER S-247) were added to and mixed with the particulate graphite at 1000 rpm for about 3 minutes. Then, 100 g of potassium hydroxide (KOH) particles of a particle diameter of approximately 500 μm was added to the mixed powder and sufficiently mixed. 150 g of ethylene vinyl acetate copolymer was added to and dissolved in 1000 g of xylene heated to 60° C. Resin dissolved in the heated xylene was added to a mixture of the nickel hydroxide powder, the electrically conductive filler and KOH which were heated to 60° C. and agitated by the Henschel mixer while being kept at 60° C. Then, the Henschel mixer was cooled while agitating the mixture, and the mixture was cooled and crushed into powder. The powder was put into a high-speed mixer and entirely agitated by the agitator while adjusting the size of the granulated particles by the chopper. The powder was agitated under the condition in which the high-speed mixer had a volume of 2 liters, the number of rotations of the agitator was 600 rpm, and the number of rotations of the chopper was 1500 rpm, and temperature of the powder was increased from room temperature to 50° C. After formation of the granulated particles, agitation was stopped while cooling the granulated particles. The particles containing xylene, was put into the pressure-reducing drier and heated to 50° C., to remove xylene. The particles were cooled and then sieved with a 2.88 mm-mesh sieve and a 1 mm-mesh sieve, thereby obtaining particles of a particle diameter of 1 to 2.88 mm. KOH taken in the particles is dissolved in an electrolytic solution or water to be converted into a part of an electrolyte when the particles are filled in the battery. Operation for handling potassium hydroxide was carried out under dry atmosphere since potassium hydroxide suctioned water contained in air and became deliquescent.

### EXAMPLE 10

150 g of particulate graphite (acetylene black, ketchen black) was put into the Henschel mixer having an internal volume of 10 liters and agitated at 1000 rpm for about 3 minutes to be sufficiently dispersed. Then, 1000 g of nickel hydroxide powder for battery and 100 g of carbon fibers (trade name: DONER S-247) were added to and mixed with the particulate graphite at 1000 rpm for about 3 minutes. Then, 150 g of phenol resin was added to and mixed with the particulate graphite for 10 minutes. The resulting mixture in a particle condition or wet powder condition was taken out and put into a container. The mixture was formed under pressure while phenol resin was heated up to a solidifying temperature (115° C.). The particles formed under pressure was cooled and then taken out from the container, thus creating a product.

### EXAMPLE 11

150g of particulate graphite (acetylene black, ketchen black) was put into the Henschel mixer having an internal volume of 10 liters and agitated at 1000 rpm for about 3 minutes to be sufficiently dispersed. Then, 1000 g of nickel hydroxide powder for battery and 100 g of carbon fibers (trade name: DONERS-247) were added to and mixed with the particulate graphite at 1000 rpm for about 3 minutes. Then, 150 g of polypropylene as thermoplastic resin was added to and mixed with the particulate graphite for 10 minutes at a temperature of not lower than a softening temperature of resin and lower than 130° C. The resulting mixture was taken out and put into a container to be formed under pressure by heating. The mixture was cooled and then taken out from the container, thus creating a product.

### EXAMPLE 12

150 g of particulate graphite (acetylene black, ketchen black) was put into the Henschel mixer having an internal volume of 10 liters and agitated at 1000 rpm for about 3 minutes to be sufficiently dispersed. Then, 1000 g of nickel hydroxide powder for battery and 100 g of carbon fibers (trade name: DONER S-247) were added to and mixed with the particulate graphite at 1000 rpm for about 3 minutes. 150 g of ethylene vinyl acetate copolymer was added to and dissolved in 1000 g of xylene heated to 60° C. Resin dissolved in the heated xylene was added to a mixture of the nickel hydroxide powder and the electrically conductive filler which were heated to 60° C. and agitated by the Henschel mixer while being kept at 60° C. The mixture was taken out and heated to 50° C. under a reduced pressure to allow xylene to be vaporized. Then, the mixture was cooled to be solidified. The solidified mixture was crushed into particles. In order to increase filling density, the crushed particles were agitated and ground, thereby providing smooth particles. Such particles can increase filling density when used as a product.

### EXAMPLE 13

150 g of particulate graphite (acetylene black, ketchen black) was put into the Henschel mixer having an internal volume of 10 liters and agitated at 1000 rpm for about 3 minutes to be sufficiently dispersed. Then, 1000 g of nickel hydroxide powder for battery and 100 g of carbon fibers (trade name: DONER S-247) were added to and mixed with the particulate graphite at 1000 rpm for about 3 minutes. 150 g of PES resin was added to and dissolved in 2000 g of DMSO. PES resin dissolved in DMSO was added to the mixture of the nickel hydroxide powder and the electrically conductive filler and agitated to be formed into slurry. The slurry was dropped into the container containing water to be formed into particles of several millimeters. Then, DMSO was extracted and removed in water and the resulting solidified particles were dried into a product.

### EXAMPLE 14

150 g of particulate graphite (acetylene black, ketchen black) was put into the Henschel mixer having an internal volume of 10 liters and agitated at 1000 rpm for about 3 minutes to be sufficiently dispersed. Then, 1000 g of nickel hydroxide powder for battery and 100 g of carbon fibers (trade name: DONER S-247) were added to and mixed with the particulate graphite at 1000 rpm for about 3 minutes. 150 of ethylene vinyl acetate copolymer was added to and dissolved in 1000 g of xylene heated to 60° C. The resin dissolved in the heated xylene was added to the mixture of the nickel hydroxide powder and the electrically conductive filler which were heated to 60° C. and agitated while being kept at 60° C. KOH crushed in dry atmosphere was classified by a sieve having a sieve size of 500 μm, and KOH particles of a particle diameter of 500 μm or less were added to and sufficiently mixed with the mixture. The mixture was taken out and heated to 50° C. under a reduced pressure to allow xylene to be vaporized. Then, the mixture was cooled to be solidified. The solidified mixture was crushed into particles. In order to increase filling density, the crushed particles were agitated and ground, thereby providing smooth particles. Such particles can increase filling density when used as a product. KOH taken in the particles is dissolved in electrolytic solution or water to be converted into part of electrolyte when the particles are filled in the battery.

### EXAMPLE 15

Crushed carbon black was added to nickel nitrate solution and sufficiently dispersed. Caustic soda dissolved in water was added to the solution being well-agitated, thereby producing nickel hydroxide and carbon fine particles in a mixed state. The solution was kept stationary and a product was precipitated. Then, by tilting the container, supernatant was removed, and water was added and mixed. This operation was repeated until pH of the supernatant became approximately 7 and the precipitate was cleaned. The precipitate was filtered, dried, and crushed as desired, thereby producing nickel hydroxide powder comprising carbon fine particles. This is applicable to the above example as the nickel hydroxide powder for battery.

### EXAMPLE 16

The particulate active material products were produced by the methods of the examples 3 and 12 and nickel-plating was applied to surfaces of the particles. The step is as follows. 200 g of the particles was immersed in 100 cc of alkaline cleaning agent (sigma clean) 10% aqueous solution and sufficiently cleaned. Then, the particles were immersed in 100 cc of alkaline chromate solution for 2 seconds to allow surfaces of the particles to be etched, and then cleaned by using water. Following this, catalytic process, activation process, and chemical plating process, were carried out. The catalytic process was carried out in such a manner that the particles were immersed for 3 minutes in a solution which is obtained by well mixing 20 cc of MAT1-A (produced by Uemura Kogakusya), 10 cc of MAT1-B (produced by Uemura Kogakusya), and 70 cc of water and adjusted to have pH 11 by NaOH, thereby causing Pd catalyst to be carried on the particles. The activation process was carried out in such a manner that the particles with catalyst carried thereon were immersed for 5 minutes in a solution obtained by mixing 1.8 cc of MRD2-A (produced by Uemura Kogakusya) and 15 cc of MRD2-B (produced by Uemura Kogakusya) with 80 cc of water and adjusted to have pH 12. 7 by NaOH, thereby reducing Pd catalyst. The chemical plating was carried out in such a manner that particles that were subjected to the activation process were immersed for 7 minutes in a solution which is obtained by mixing 400 cc of water with 100 cc of nibodule u-77 (produced by Uemura Kogakusya) and adjusted to have pH 9 by ammonia water, thereby applying nickel-plating to the surfaces of the particles. In each of the above processes, the particles were sufficiently cleaned by using water.

### EXAMPLE 17

The particulate active material products were produced by the method of the examples 3 and 12. Toluene was added to and impregnated in the particles to allow surfaces thereof to be expanded and softened. Nickel metal powder of particle weight of 10% was added to the expanded and softened particles and the particles were coated with Ni metal powder by a rolling method.

### EXAMPLE 18

The particulate active material products were produced by the method of the examples 3 and 12. Toluene was added to and impregnated in the particles to allow surfaces thereof to be expanded and softened. Crushed carbon fibers (diameter of 7 μm, average fiber length of approximately 100 μm, and average plating thickness of 0.2 μm) nickel-plated at particle weight of 5% were added to the expanded and softened particles. The particles were coated with Ni-plated carbon fiber powder by the rolling method.

### EXAMPLE 19

150 g of particulate graphite (acetylene black) was put into the Henschel mixer having an internal volume of 10 liters and agitated at 1000 rpm for about 3 minutes to be sufficiently dispersed. Then, 1000 g of sand (toyoura standard sand) and 100 g of carbon fibers (trade name: DONER S-247) were added to and mixed with the particulate graphite at 1000 rpm for about 3 minutes. 150 g of ethylene vinyl acetate copolymer was added to and dissolved in 1000 g of xylene heated to 60° C. Resin dissolved in heated xylene was added to the mixture of the sand and electrically conductive filler which were heated to 60° C. and agitated by the Henschel mixer while being kept at 60° C. Then, the Henschel mixer was cooled while agitating the particles, and the mixture was cooled and crushed into powder. The powder was put into a high-speed mixer and agitated by an agitator while adjusting the size of the granulated particles by the chopper. The powder was agitated under the condition in which the high-speed mixer had a volume of 2 liters, the number of rotations of the agitator was 600 rpm, and the number of rotations of the chopper was 1500 rpm, and temperature of the powder was increased from room temperature to 50° C. After formation of the granulated particles, agitation was stopped while cooling the granulated particles. The particles containing xylene, was put into a pressure-reducing drier and heated to 50° C., to remove xylene. The particles were taken out and dried. Then, the particles were sieved with a 2.88 mm-mesh sieve and a 1 mm-mesh sieve, thereby obtaining particles of a particle diameter of 1 to 2.88 mm.

### EXAMPLE 20

150 g of particulate graphite (acetylene black) was put into the Henschel mixer having an internal volume of 10 liters and agitated at 1000 rpm for about 3 minutes to be sufficiently dispersed. Then, 1000 g of coal particles (fine powder coal of Daidousumi) and 100 g of carbon fibers (trade name: DONER S-247) were added to and mixed with the particulate graphite at 1000 rpm for about 3 minutes. 150 g of ethylene vinyl acetate copolymer was added to and dissolved in 1000 g of xylene heated to 60° C. Resin dissolved in the heated xylene was added to a mixture of the coal and the electrically conductive filler which were heated to 60° C. and agitated by the Henschel mixer while being kept at 60° C. Then, the Henschel mixer was cooled while agitating the mixture, and the mixture was cooled and crushed into powder. The powder was put into the high-speed mixer and agitated by the agitator while adjusting the size of the granulated particles by the chopper. The powder was agitated under the condition in which the high-speed mixer had a volume of 2 liters, the number of rotations of the agitator was 600 rpm, and the number of rotations of the chopper was 1500 rpm, and temperature of the powder was increased from room temperature to 50° C. After formation of the granulated particles, agitation was stopped while cooling the granulated particles. The particles containing xylene, was put into a pressure-reducing drier and heated to 50° C., to remove xylene. The particles were cooled and then sieved with a 2.88 mm-mesh sieve and a 1 mm-mesh sieve, thereby obtaining particles of a particle diameter of 1 to 2.88 mm.

### EXAMPLE 21

150 g of particulate graphite (acetylene black) was put into the Henschel mixer having an internal volume of 10 liters and agitated at 1000 rpm for about 3 minutes to be sufficiently dispersed. Then, 1000 g of charcoal (obtained by calcining wood at 600° C. for 2 hours) and 100 g of carbon fibers (trade name: DONER S-247) were added to and mixed with the particulate graphite at 1000 rpm for about 3 minutes. 150 g of ethylene vinyl acetate copolymer was added to and dissolved in 1000 g of xylene heated to 60° C. The resin dissolved in the heated xylene was added to the mixture of the charcoal and the electrically conductive filler which were heated to 60° C. and agitated by the Henschel mixer while being kept at 60° C. Then, the Henschel mixer was cooled while agitating the mixture, and the mixture was cooled and crushed into powder. The powder was put into the high-speed mixer and agitated by the agitator while adjusting the size of the granulated particles by the chopper. The powder was agitated under the condition in which the high-speed mixer had a volume of 2 liters, the number of rotations of the agitator was 600 rpm, and the number of rotations of the chopper was 1500 rpm, and temperature of the powder was increased from room temperature to 50° C. After formation of the granulated particles, agitation was stopped while cooling the granulated particles. The particles containing xylene, was put into a pressure-reducing drier and heated to 50° C., to remove xylene. The particles were cooled and then sieved with a 2.88 mm-mesh sieve and a 1 mm-mesh sieve, thereby obtaining the particles of a particle diameter of 1 to 2.88 mm.

### EXAMPLE 22

150 g of particulate graphite (acetylene black) was put into the Henschel mixer having an internal volume of 10 liters and agitated at 1000 rpm for about 3 minutes to be sufficiently dispersed. Then, 500 g of silica (obtained by calcining chaff at 600° C. for 2 hours) and 100 g of carbon fibers (trade name: DONER S-247) were added to and mixed with the particulate graphite at 1000 rpm for about 3 minutes. 150 g of ethylene vinyl acetate copolymer was added to and dissolved in 1000 g of xylene heated to 60° C. The resin dissolved in the heated xylene was added to the mixture of the charcoal and the electrically conductive filler which were heated to 60° C. and agitated by the Henschel mixer while being kept at 60° C. Then, the Henschel mixer was cooled while agitating the mixture, and the mixture was cooled and crushed into powder. The powder was put into the high-speed mixer and agitated by the agitator while adjusting the size of the granulated particles by the chopper. The powder was agitated under the condition in which the high-speed mixer had a volume of 2 liters, the number of rotations of the agitator was 600 rpm, and the number of rotations of the chopper was 1500 rpm, and temperature of the powder was increased from room temperature to 50° C. After formation of the granulated particles, agitation was stopped while cooling the granulated particles. The particles containing xylene, was put into the pressure-reducing drier and heated to 50° C., to remove xylene. The particles were cooled and then sieved with a 2.88 mm-mesh sieve and a 1 mm-mesh sieve, thereby obtaining particles of a particle diameter of 1 to 2.88 mm.

### EXAMPLE 23

150 g of particulate graphite (acetylene black) was put into the Henschel mixer having an internal volume of 10 liters and agitated at 1000 rpm for about 3 minutes to be sufficiently dispersed. Then, 1000 g of slag (obtained by melting ash of burned garbage at 1500° C. for 2 hours and then by cooling the ash) and 100 g of carbon fibers (trade name: DONER S-247) were added to and mixed with the particulate graphite. 150 g of ethylene vinyl acetate copolymer was added to and dissolved in 1000 g of xylene heated to 60° C. The resin dissolved in the heated xylene was added to the mixture of the slag and the electrically conductive filler which were heated at 60° C. and agitated by the Henschel mixer while being kept at 60° C. Then, the Henschel mixer was cooled while agitating the mixture, and the mixture was cooled and crushed into powder. The powder was put into the high-speed mixer and agitated by the agitator while adjusting the size of the granulated particles by the chopper. The powder was agitated under the condition in which the high-speed mixer had a volume of 2 liters, the number of rotations of the agitator was 600 rpm, and the number of rotations of the chopper was 1500 rpm, and temperature of the powder was increased from room temperature to 50° C. After formation of the granulated particles, agitation was stopped while cooling the granulated particles. The particles containing xylene, was put into a pressure-reducing drier and heated to 50° C., to remove xylene. The particles were cooled and then sieved with a 2.88 mm-mesh sieve and a 1 mm-mesh sieve, thereby obtaining particles of a particle diameter of 1 to 2.88 mm.

### EXAMPLE 24

150 g of particulate graphite (acetylene black) was put into the Henschel mixer having an internal volume of 10 liters and agitated at 1000 rpm for about 3 minutes to be sufficiently dispersed. Then, 500 g of carbon (obtained by calcining carbon fibers at 1100° C.) was added to and mixed with the particulate graphite at 1000 rpm for about 3 minutes. 150 g of ethylene vinyl acetate copolymer was added to and dissolved in 1000 g of xylene heated at 60° C. The resin dissolved in the heated xylene was added to the mixture of the carbon and the electrically conductive filler which were heated to 60° C. and agitated by the Henschel mixer while being kept to 60° C. Then, the Henschel mixer was cooled while agitating the mixture, and the mixture was cooled and crushed into powder. The powder was put into the high-speed mixer and agitated by the agitator while adjusting the size of the granulated particles by the chopper. The powder was agitated under the condition in which the high-speed mixer had a volume of 2 liters, the number of rotations of the agitator was 600 rpm, and the number of rotations of the chopper was 1500 rpm, and temperature of the powder was increased from room temperature to 50° C. After formation of the granulated particles, agitation was stopped while cooling the granulated particles. The particles containing xylene, was put into the pressure-reducing drier and heated to 50° C., to remove xylene. The particles were cooled and then sieved with a 2.88 mm-mesh sieve and a 1 mm-mesh sieve, thereby obtaining particles of a particle diameter of 1 to 2.88 mm.

### (2) EMBODIMENT OF THE INVENTION FOR ACHIEVING THE SECOND OBJECTIVE

In the case of the three-dimensional battery obtained by filling the particulate active material products to form the fixed layer, handling is difficult, bulk density of the filled layer is low, and a battery capacity is reduced. Accordingly, the electrically conductive active material forming products (primary particles) are pressure-formed or secondarily formed by using resin. The pressure formation or secondary formation results in an increase in a contact area between the active material particles for improved battery performance and an increase in bulk density of the filled layer for higher density battery, and makes handling easier.

A method of producing the forming products of the electrically conductive active material products are such that the electrically conductive filler and the resin are added to active material powder for battery, and the resulting mixture is shaped and cured to be formed into primary forming products, which are then secondarily formed by pressurizing the primary forming products and/or by adding the resin. The primary forming products are secondarily formed in such a manner that resin contained in particles of the primary forming products is re-melted without adding resin. Alternatively, the primary forming products may be secondarily formed by adding resin.

As the active material, all kinds of active materials may be used, regardless of the type of the secondary battery, or the cathode or the anode. For example, in the case of the nickel-hydrogen secondary battery, nickel hydroxide is used as the cathode active material and hydrogen-occluding alloy is used as the anode active material. In addition to these, known battery active materials such as cadmium hydroxide, lead, lead dioxide, lithium, etc, and further, general solid materials such as wood, graphite, carbon, iron ore, coal, charcoal, sand, gravel, silica, slag, chaff, etc, may be used. As the electrically conductive filler to be added in primary formation, carbon fibers, nickel-plated carbon fibers, nickel-plated organic fibers, carbon particles, nickel-plated carbon particles, fibrous nickel, nickel particles, nickel foil, etc, may be used.

As the resin used in the primary formation, thermoplastic resin such as polyethylene, polypropylene, and ethylene vinyl acetate copolymer, reaction curing resin such as epoxy resin, urethane resin, unsaturated polyester resin, thermosetting resin such as phenol resin, PES resin, polystyrene, polysulfone, polyacrylonitrile, polyvinylidene fluoride, polyamide, polyimide, acetylcellulose, oxide phenylene ether (PPO), etc, may be used. The primary formation is performed substantially as in the secondary formation. As the binder, alkali-resistant resin must be used.

The shape formed in the primary formation includes, particle, plate, scale, cylindrical rod, polygonal cylindrical rod, sphere, dice, cube, and amorphous particles. Such a shape can be created by agitation, tablet making, or tablet forming, or pressurized forming, extrusion molding, or the like. When using the tablet making, the tablet forming, the pressurized forming, or extrusion molding, the active material forming products may be crushed into primary forming products. Alternatively, the primary forming products which are angular may be rounded to provide smooth surfaces.

The primary forming products may be forming products coated with electrically conductive material such as, carbon fibers, nickel-plated carbon fibers, carbon powder, nickel-plated carbon powder, nickel-plated organic fibers, fibrous nickel, nickel powder, nickel foil, etc. The coating is performed in such a manner that, before curing the primary forming products, the metal powder, the metal fibers, the metal-plated fibers, or the like are added to the forming products, followed by rolling and agitation, thereby allowing any of these to adhere to outer surfaces of the soft forming products. When the forming products are solidified by thermoplastic resin or the resin soluble in the solvent, the temperature of the forming products is increased to allow the forming products to be softened by heating, or the solvent is added to the forming products to allow the forming products to be expanded and softened to be thereby uncured, and the metal is added to the uncured forming products.

As the primary forming products, nickel-plated forming products may be used. By forming the electrically conductive layer on the outer surfaces of the primary forming products by coating or plating of the electrically conductive material, a large current flows.

The secondary forming products may have a shape of cube, cylinder, block, polygonal cylinder, etc. In this case, the primary forming products are filled in a mold and a pressure is applied to the filled forming products, thereby resulting in increased bulk density of the secondary forming products. Preferably, the secondary formation is performed so that a space is formed between the primary forming products. Also, preferably, the secondary formation is performed while maintaining the shape of the primary forming products. In the secondary formation, the primary forming products are filled in a mold provided with concave/convex portions, such as grooves or corrugation, and formed to allow the secondary forming products to have a shape of the grooves or corrugation on surfaces thereof. When such active material forming products are filled in the battery, a space in which an electrolytic solution exists is ensured on the separator side, and a space through which a gas passes is ensured on the current collector side.

A water-soluble compound (e.g., sodium carbonate) is added before secondary formation, and is dissolved in water after the secondary formation, to be extracted and removed. Thereby, active material forming products with internal holes therein and with small concentration polarization are obtained.

Before the secondary formation, alkali such as KOH, NaOH, or LiOH used as an electrolytic compound is added. The alkali is dissolved in the electrolytic solution or the water and converted into the electrolyte, and therefore, it is not necessary to perform extraction of the water-soluble compound, which takes place when adding the water-soluble compound. By immersing the active material forming products in the electrolytic solution or water and dissolving alkali, the active material products with internal holes and small concentration polarization is obtained. Since the alkali is deliquescent, it is difficult to crush such material into particles under normal atmosphere. Assuming that crush and mixing are conducted under low humidity condition, KOH, NaOH, or the like may be used, but this is burdensome and expensive. In contrast, such problem does not exist in water-soluble salts such as sodium carbonate, and the above method is simple and inexpensive, but performance of the electrolytic solution would be degraded unless such water-soluble salt is extracted and removed.

In the secondary formation, as the electrically conductive filler, any of carbon fibers, nickel-plated carbon fibers, nickel-plated organic fibers, carbon fine powder, nickel-plated carbon fine powder, fibrous nickel, nickel fine particles and nickel foil, or a combination of any of these, may be added.

When resin is added in the secondary formation, thermoplastic resin such as polyvinyl alcohol (PVA), polyethylene, polypropylene, or ethylene vinyl acetate copolymer may be used. In this case, thermoplastic resin melted by heating may be mixed with and dispersed in the primary forming products. When the resin dissolved in the solvent is added, the resin is easily uniformly dispersed over the forming products. So, the active material mixture can be secondarily formed with a small amount of resin. For example, polyethylene, polypropylene, or ethylene vinyl acetate copolymer is soluble in the solvent such as heated benzene, toluene, or xylene. Also, styrene resin is soluble in acetone solvent. By mixing the resin dissolved in any of these solvents with the primary forming products or the electrically conductive filler as necessary, and by removing the solvent by vaporization, the active material forming products (secondary forming products) solidified by the resin can be created.

As the reaction curing resin, epoxy resin, urethane resin, unsaturated polyester resin may be used as the binder. As thermosetting resin, phenol resin may be used as the binder.

When resin dissolved in the water-soluble solvent or alcohol-soluble solvent is added in the secondary formation, the solvent is extracted and removed by using water or alcohol, thereby creating the active material forming products (secondary forming products) solidified by the resin. For example, polyether sulfone (PES) resin is soluble in dimethyl sulfoxide (DMSO), and the PES resin dissolved in DMSO may be used in the above method as the resin dissolved in the water-soluble solvent. In the same manner, polystyrene dissolved in acetone, polysulfone dissolved in dimethyl formamide (DMF) or DMSO, polyacrylonitrile dissolved in DMF, DMSO or ethylene carbonate, polyvinylidene fluoride dissolved in DMF, DMSO, or NMP, polyamide dissolved in DMF or NMP, polyimide dissolved in DMF or NMP, etc, may be used. As the resin dissolved in the alcohol-soluble solvent, acetylcellulose dissolved in methylene chloride, oxide phenylene ether (PPO) dissolved in methylene chloride, or the like may be used.

When the resin soluble in the solvent is added, by way of example, the resin dissolved in the solvent and the electrically conductive filler are mixed and dispersed. Then, the mixture is converted into powder by vaporizing the solvent, and the primary forming products are added to the powder.

Hereinafter, examples of the present invention will be described.

First, examples of a method of producing the primary forming products of the active material particles will be described.

### 1. EXAMPLE OF PRODUCTION OF ACTIVE MATERIAL PARTICLES USING NICKEL HYDROXIDE

150 g of particulate graphite (acetylene black, ketchen black) was put into the Henschel mixer having an internal volume of 10 liters and agitated at 1000 rpm for about 3 minutes to be sufficiently dispersed. Then, 1000 g of nickel hydroxide powder for battery and 100 g of carbon fibers (trade name: DONER S-247) were added to and mixed with the particulate graphite at 1000 rpm for about 3 minutes. 150 g of ethylene vinyl acetate copolymer was added to and dissolved in 1000 g of xylene heated to 60° C. Resin dissolved in the heated xylene was added to a mixture of the nickel hydroxide powder and the electrically conductive filler which were heated to 60° C. and agitated by the Henschel mixer while being kept at 60° C. Then, the Henschel mixer was cooled while agitating the mixture, and the mixture was cooled and crushed into powder. The powder was put into the high-speed mixer and entirely agitated by the agitator while adjusting the size of the granulated particles by the chopper. The powder was agitated under the condition in which the high-speed mixer had a volume of 2 liters, the number of rotations of the agitator was 600 rpm, and the number of rotations of the chopper was 1500 rpm, and temperature of the powder was increased from room temperature to 50° C. After formation of the granulated particles, agitation was stopped while cooling the granulated particles. The particles containing xylene, was put into the pressure-reducing drier and heated to 50° C., to remove xylene. The particles were cooled and then sieved with a 2.88 mm-mesh sieve and a 1 mm-mesh sieve, thereby obtaining primary particles of a particle diameter of 1 to 2.88 mm.

### 2. EXAMPLE OF PRODUCTION OF ACTIVE MATERIAL PARTICLES USING HYDROGEN-OCCLUDING ALLOY

150 g of particulate graphite (acetylene black, ketchen black) was put into the Henschel mixer having an internal volume of 10 liters and agitated at 1000 rpm for about 3 minutes to be sufficiently dispersed.. Then, 2500 g of hydrogen-occluding alloy powder for battery and 100 g of carbon fibers (trade name: DONER S-247) were added to and mixed with the particulate graphite at 1000 rpm for about 3 minutes. 150 g of ethylene vinyl acetate copolymer was added to and dissolved in 1000 g of xylene heated to 60° C. Resin dissolved in the heated xylene was added to a mixture of the hydrogen-occluding alloy and the electrically conductive filler which were heated to 60° C. and agitated by the Henschel mixer while being kept at 60° C. Then, the Henschel mixer was cooled while agitating the mixture, and the mixture was cooled and crushed into powder. The powder was put into the high-speed mixer and agitated by the agitator while adjusting the size of the granulated particles by the chopper. The powder was agitated under the condition in which the high-speed mixer had a volume of 2 liters, the number of rotations of the agitator was 600 rpm, and the number rotations of the chopper was 1500 rpm, and temperature of the powder was increased from room temperature to 50° C. After formation of the granulated particles, agitation was stopped while cooling the granulated particles. The particles containing xylene, was put into the pressure-reducing drier and heated to 50° C., to remove xylene. The particles were cooled and then sieved with a 2.88 mm-mesh sieve and a 1 mm-mesh sieve, thereby obtaining primary particles of a particle diameter of 1 to 2.88 mm.

### 3. EXAMPLE OF PRODUCTION OF ACTIVE MATERIAL PARTICLES USING SAND

150 g of particulate graphite (acetylene black) was put into the Henschel mixer having an internal volume of 10 liters and agitated at 1000 rpm for about 3 minutes to be sufficiently dispersed. Then, 1000 g of sand (toyoura standard sand) and 100 g of carbon fibers (trade name: DONER S-247) were added to and mixed with the particulate graphite at 1000 rpm for about 3 minutes. 150 g of ethylene vinyl acetate copolymer was added to and dissolved in 1000 g of xylene heated to 60° C. Resin dissolved in heated xylene was added to the mixture of the sand and electrically conductive filler heated to 60° C. and agitated by Henschel mixer while being kept at 60° C. Then, the Henschel mixer was cooled while agitating the particles, and the mixture was cooled and crushed into powder. The powder was put into the high-speed mixer and agitated by the agitator while adjusting the size of the granulated particles by the chopper. The powder was agitated under the condition in which the high-speed mixer had a volume of 2 liters, the number of rotations of the agitator was 600 rpm, and the number of rotations of the chopper was 1500 rpm, and temperature of the powder was increased from room temperature to 50° C. After formation of the granulated particles, agitation was stopped while cooling the granulated particles. The particles containing xylene, was put into a pressure-reducing drier and heated to 50° C., to remove xylene. The particles were cooled. Then, the particles were sieved with a 2.88 mm-mesh sieve and a 1 mm-mesh sieve, thereby obtaining primary particles of a particle diameter of 1 to 2.88 mm.

### 4. EXAMPLE OF PRODUCTION OF ACTIVE MATERIAL PARTICLES USING COAL

150 g of particulate graphite (acetylene black) was put into the Henschel mixer having an internal volume of 10 liters and agitated at 1000 rpm for about 3 minutes to be sufficiently dispersed. Then, 1000 g of coal particles (fine powder coal of Daidousumi) and 100 g of carbon fibers (trade name: DONER S-247) were added to and mixed with the particulate graphite at 1000 rpm for about 3 minutes. 150 g of ethylene vinyl acetate copolymer was added to and dissolved in 1000 g of xylene heated to 60° C. Resin dissolved in the heated xylene was added to a mixture of the coal and the electrically conductive filler which were heated to 60° C. and agitated by the Henschel mixer while being kept at 60° C. Then, the Henschel mixer was cooled while agitating the mixture, and the mixture was cooled and crushed into powder. The powder was put into the high-speed mixer and agitated by the agitator while adjusting the size of the granulated particles by the chopper. The powder was agitated under the condition in which the high-speed mixer had a volume of 2 liters, the number of rotations of the agitator was 600 rpm, and the number of rotations of the chopper was 1500 rpm, and temperature of the powder was increased from room temperature to 50° C. After formation of the granulated particles, agitation was stopped while cooling the granulated particles. The particles containing xylene, was put into the pressure-reducing drier and heated to 50° C., to remove xylene. The particles were cooled and then sieved with a 2.88 mm-mesh sieve and a 1 mm-mesh sieve, thereby obtaining primary particles of a particle diameter of 1 to 2.88 mm.

### 5. EXAMPLE OF PRODUCTION OF ACTIVE MATERIAL PARTICLES USING CHARCOAL

150 g of particulate graphite (acetylene black) was put into the Henschel mixer having an internal volume of 10 liters and agitated at 1000 rpm for about 3 minutes to be sufficiently dispersed. Then, 1000 g of charcoal (obtained by calcining wood at 600° C. for 2 hours) and 100 g of carbon fibers (trade name: DONER S-247) were added to and mixed with the particulate graphite at 1000 rpm for about 3 minutes. 150 g of ethylene vinyl acetate copolymer was added to and dissolved in 1000 g of xylene heated to 60° C. The resin dissolved in the heated xylene was added to the mixture of the charcoal and the electrically conductive filler which were heated to 60° C. and agitated by the Henschel mixer while being kept at 60° C. Then, the Henschel mixer was cooled while agitating the mixture, and the mixture was cooled and crushed into powder. The powder was agitated under the condition in which the high-speed mixer had a volume of 2 liters, the number of rotations of the agitator was 600 rpm, and the number of rotations of the chopper was 1500 rpm, and temperature of the powder was increased from room temperature to 50° C. After formation of the granulated particles, agitation was stopped while cooling the granulated particles. The particles containing xylene, was put into a pressure-reducing drier and heated to 50° C., to remove xylene. The particles were cooled and then sieved with a 2.88 mm-mesh sieve and a 1 mm-mesh sieve, thereby obtaining primary particles of a particle diameter of 1 to 2.88 mm.

### 6. EXAMPLE OF PRODUCTION OF ACTIVE MATERIAL PARTICLES USING SILICA

150 g of particulate graphite (acetylene black) was put into the Henschel mixer having an internal volume of 10 liters and agitated at 1000 rpm for about 3 minutes to be sufficiently dispersed. Then, 500 g of silica (obtained by calcining chaff at 600° C. for 2 hours) and 100 g of carbon fibers (trade name: DONER S-247) were added to and mixed with the particulate graphite at 1000 rpm for about 3 minutes. 150 g of ethylene vinyl acetate copolymer was added to and dissolved in 1000 g of xylene heated to 60° C. The resin dissolved in the heated xylene was added to the mixture of the silica and the electrically conductive filler which were heated to 60° C. and agitated by the Henschel mixer while being kept at 60° C. Then, the Henschel mixer was cooled while agitating the mixture, and the mixture was cooled and crushed into powder. The powder was put into the high-speed mixer and agitated by the agitator while adjusting the size of the granulated particles by the chopper. The powder was agitated under the condition in which the high-speed mixer had a volume of 2 liters, the number of rotations of the agitator was 600 rpm, and the number of rotations of the chopper was 1500 rpm, and temperature of the powder was increased from room temperature to 50° C. After formation of the granulated particles, agitation was stopped while cooling the granulated particles. The particles containing xylene, was put into the pressure-reducing drier and heated to 50° C., to remove xylene. The particles were cooled and then sieved with a 2.88 mm-mesh sieve and a 1 mm-mesh sieve, thereby obtaining primary particles of a particle diameter of 1 to 2.88 mm.

### 7. EXAMPLE OF PRODUCTION OF ACTIVE MATERIAL PARTICLES USING SLAG

150 g of particulate graphite (acetylene black) was put into the Henschel mixer having an internal volume of 10 liters and agitated at 1000 rpm for about 3 minutes to be sufficiently dispersed. Then, 1000 g of slag (obtained by melting ash of burned garbage at 1500° C. for 2 hours and then by cooling the ash) and 100 g of carbon fibers (trade name: DONER S-247) were added to and mixed with the particulate graphite. 150 g of ethylene vinyl acetate copolymer was added to and dissolved in 1000 g of xylene heated to 60° C. The resin dissolved in the heated xylene was added to the mixture of the slag and the electrically conductive filler which were heated to 60° C. and agitated by the Henschel mixer while being kept at 60° C. Then, the Henschel mixer was cooled while agitating the mixture, and the mixture was cooled and crushed into powder. The powder was put into the high-speed mixer and agitated by the agitator while adjusting the size of the granulated particles by the chopper. The powder was agitated under the condition in which the high-speed mixer had a volume of 2 liters, the number of rotations of the agitator was 600 rpm, and the number of rotations of the chopper was 1500 rpm, and temperature of the powder was increased from room temperature to 50° C. After formation of the granulated particles, agitation was stopped while cooling the granulated particles. The particles containing xylene, was put into a pressure-reducing drier and heated to 50° C., to remove xylene. The particles were cooled and then sieved with a 2.88 mm-mesh sieve and a 1 mm-mesh sieve, thereby obtaining primary particles of a particle diameter of 1 to 2.88 mm.

### 8. EXAMPLE OF PRODUCTION OF ACTIVE MATERIAL PARTICLES USING CARBON

150 g of particulate graphite (acetylene black) was put into the Henschel mixer having an internal volume of 10 liters and agitated at 1000 rpm for about 3 minutes to be sufficiently dispersed. Then, 500 g of carbon (obtained by calcining carbon fibers at 1100° C.) was added to and mixed with the particulate graphite at 1000 rpm for about 3 minutes. 150 g of ethylene vinyl acetate copolymer was added to and dissolved in 1000 g of xylene heated to 60° C. The resin dissolved in the heated xylene was added to the mixture of the carbon and the electrically conductive filler which were heated to 60° C. and agitated by the Henschel mixer while being kept at 60° C. Then, the Henschel mixer was cooled while agitating the mixture, and the mixture was cooled and crushed into powder. The powder was put into the high-speed mixer and agitated by the agitator while adjusting the size of the granulated particles by the chopper. The powder was agitated under the condition in which the high-speed mixer had a volume of 2 liters, the number of rotations of the agitator was 600 rpm, and the number of rotations of the chopper was 1500 rpm, and temperature of the powder was increased from room temperature to 50° C. After formation of the granulated particles, agitation was stopped while cooling the granulated particles. The particles containing xylene, was put into a pressure-reducing drier and heated to 50° C., to remove xylene. The particles were cooled and then sieved with a 2.88 mm-mesh sieve and a 1 mm-mesh sieve, thereby obtaining primary particles of a particle diameter of 1 to 2.88 mm.

Subsequently, the primary particles obtained as described in (1) to (8) were secondarily formed in methods as described below.

### EXAMPLE 1 OF PRODUCTION OF SECONDARY FORMING PRODUCTS

90 g of the primary particles was filled in a mold having a cross-section of 100 mm×100 mm and heated to 100° C. to allow the resin (ethylene vinyl acetate copolymer) contained in the primary particles to be softened. Then, under a pressure of 0.1 Mpa within the mold, temperature was decreased to allow the resin to be cured. The resulting material was taken out from the mold as secondary active material forming products.

### EXAMPLE 2 OF PRODUCTION OF SECONDARY FORMING PRODUCTS

90 g of the primary particles was filled in the mold having a cross-section of 100 mm×100 mm and heated to 100° C. to allow the resin (ethylene vinyl acetate copolymer) contained in the primary particles to be softened. Then, after applying a pressure of 0.1 Mpa within the mold, the pressure was released and the temperature was decreased to allow the resin to be cured. The resulting active material products were taken out from the mold as secondary active material products. Since the carbon fibers are used as the electrically conductive filler, spring back occurs under pressure-released cooling, so that bulk density becomes lower than that under the pressure-applied cooling in the example 1, but ion conductivity is improved.

### EXAMPLE 3 OF PRODUCTION OF SECONDARY FORMING PRODUCTS

200 g of the primary particles and 500 of the electrically conductive filler (carbon fiber) were agitated and mixed. 90 g of the mixture was filled in the mold having a cross-section of 100 mm×100 mm and heated to 100° C. to allow the resin (ethylene vinyl acetate copolymer) contained in the primary particles to be softened. Then, under a pressure of 0.1 Mpa within the mold, temperature was decreased to allow the resin to be cured. The resulting material was taken out from the mold as secondary active material forming products.

### EXAMPLE 4 OF PRODUCTION OF SECONDARY FORMING PRODUCTS

200 g of the primary particles and 500 of the electrically conductive filler (carbon fibers) were agitated and mixed. 90 g of the mixture was filled in the mold having a cross-section of 100 mm×100 mm and heated to 100° C. to allow the resin (ethylene vinyl acetate copolymer) contained in the primary particles to be softened. Then, after applying a pressure of 0.1 Mpa within the mold, the pressure was released and the temperature was decreased to allow the resin to be cured. The resulting material was taken out from the mold as secondary active material forming products. Since spring back occurs under pressure-released cooling, bulk density becomes lower than that under the pressure-applied cooling, but ion conductivity is improved.

### EXAMPLE 5 OF PRODUCTION OF SECONDARY FORMING PRODUCTS

100 g of ethylene vinyl acetate copolymer and 100 g of electrically conductive filler (carbon black) were heated to 130° C., mixed and kneaded, thus giving conductivity to the resin. 20 g of the electrically conductive resin and 90 of the primary particles were mixed and agitated at 80° C. The entire mixture was filled in the mold having a cross-section of 100 mm×100 mm and cooled within the mold without applying a pressure, to allow the resin to be cured. The forming products were taken out from the mold as secondary active material forming products.

### EXAMPLE 6 OF PRODUCTION OF SECONDARY FORMING PRODUCTS

100 g of ethylene vinyl acetate copolymer and 100 g of electrically conductive filler (carbon black) were heated to 130° C., mixed and kneaded, thus giving conductivity to the resin. 20 g of the electrically conductive resin and 90 of the primary particles were mixed and agitated at 80° C. The entire mixture was filled in the mold having a cross-section of 100 mm×100 mm and the temperature was decreased to allow the resin to be cured under a pressure of 0.1 Mpa within the mold. The forming products were taken out from the mold as secondary active material forming products.

### EXAMPLE 7 OF PRODUCTION OF SECONDARY FORMING PRODUCTS

100 g of ethylene vinyl acetate copolymer and 100 g of electrically conductive filler (carbon black) were heated to 130° C., mixed and kneaded, thus giving conductivity to the resin. 20 g of the electrically conductive resin and 90 of the primary particles were mixed and agitated at 80° C. The entire mixture was filled in the mold having a cross-section of 100 mm×100 mm and pressure was applied at 0.1 PA within the mold. Thereafter, the pressure was released and then the temperature was decreased, to allow the resin to be cured. The mixture was taken out from the mold as secondary active material forming products. Since spring back occurs under pressure-released cooling, bulk density becomes lower than that under the pressure-applied cooling, but ion conductivity is improved.

### EXAMPLE 8 OF PRODUCTION OF SECONDARY FORMING PRODUCTS

50 g of ethylene vinyl acetate copolymer, 100 g of a solvent (xylene) and 100 g of the electrically conductive filler (carbon black) were heated to 80° C., mixed and kneaded, thus giving conductivity to the resin. 20 g of the electrically conductive resin containing xylene and 90 g of the primary particles were mixed and agitated at 80° C. The entire mixture was filled in the mold having a cross-section of 100 mm×100 mm. The mixture was cooled within the mold without applying a pressure, thereby allowing the resin to be cured. Then, the mixture was left at a room temperature and a normal pressure to vaporize xylene. Then, the forming products were taken out from the mold as secondary active material forming products.

### EXAMPLE 9 OF PRODUCTION OF SECONDARY FORMING PRODUCTS

50 g of ethylene vinyl acetate copolymer, 100 g of a solvent (xylene), and 100 g of electrically conductive filler (carbon black) were heated to 80° C., mixed and kneaded, thus giving conductivity to the resin. 20 g of the electrically conductive resin containing xylene and 90 g of the primary particles were mixed and agitated at 80° C. The entire mixture was filled in the mold having a cross-section of 100 mm×100 mm and the temperature was decreased under a pressure of 0.1 Mpa within the mold to allow the resin to be cured. The mixture was left at room temperature and normal pressure to allow xylene to be vaporized. The forming products were taken out from the mold as secondary active material forming products.

### EXAMPLE 10 OF PRODUCTION OF SECONDARY FORMING PRODUCTS

50 g of ethylene vinyl acetate copolymer, 100 g of a solvent (xylene) and 100 g of the electrically conductive filler (carbon black) were heated to 80° C., mixed and kneaded, thus giving conductivity to the resin. 20 g of the electrically conductive resin containing xylene and 90 g of the primary particles were mixed and agitated at 80° C. The entire mixture was filled in the mold having a cross-section of 100 mm×100 mm and the temperature was decreased under a pressure of 0.1 Mpa within the mold. Then, the pressure was released and the temperature was decreased to allow the resin to be cured. The mixture was left at room temperature and normal pressure to allow xylene to be vaporized. Thereafter, the mixture was taken out from the mold as secondary active material forming products. Since spring back occurs under pressure-released cooling, bulk density becomes lower than that under the pressure-applied cooling, but ion conductivity is improved.

### EXAMPLE 11 OF PRODUCTION OF SECONDARY FORMING PRODUCTS

50 g of ethylene vinyl acetate copolymer, 100 g of a solvent (xylene) and 100 g of the electrically conductive filler (carbon black) were heated to 80° C., mixed and kneaded, thus giving conductivity to the resin. 20 g of the electrically conductive resin containing xylene and 90 g of the primary particles were mixed and agitated at 80° C. The entire mixture was filled in the mold having a cross-section of 100 mm×100 mm and provided with grooves having 5 mm width and 2 mm depth, and the temperature was decreased under a pressure of 0.1 Mpa within the mold to allow the resin to be cured. The mixture was left at room temperature and normal pressure to allow xylene to be vaporized. The forming products were taken out from the mold as secondary active material forming products.

### EXAMPLE 12 OF PRODUCTION OF SECONDARY FORMING PRODUCTS

40 g of the PES resin, 120 g of the solvent (DMSO), and 100 g of the electrically conductive filler (carbon black) were heated to 60° C., mixed, and kneaded, thus giving conductivity to the resin. 20 g of the electrically conductive resin containing the DMSO and 90 g of the primary particles were mixed and agitated at 80° C. The entire mixture was filled in the mold having a cross-section of 100 mm×100 mm and the temperature was decreased under a pressure of 0.1 Mpa within the mold, to allow the resin to be cured. The forming products were taken out from the mold and then immersed in water to allow DMSO to be extracted and removed. The resulting forming products were dried into secondary active material forming products.

### EXAMPLE 13 OF PRODUCTION OF SECONDARY FORMING PRODUCTS

50 g of ethylene vinyl acetate copolymer, 100 g of a solvent (xylene) and 100 g of the electrically conductive filler (carbon black) were heated to 80° C., mixed and kneaded, thus giving conductivity to the resin. Sodium carbonate particles having a particle diameter of approximately 500 μm were added to and well mixed with the electrically conductive resin containing xylene. 20 g of the electrically conductive resin containing xylene and 90 g of the primary particles were mixed and agitated at 80° C. The entire mixture was filled in the mold having a cross-section of 100 mm×100 mm and the temperature was decreased under a pressure of 0.1 Mpa within the mold to allow the resin to be cured. The mixture was left at room temperature and normal pressure to allow xylene to be vaporized. Then, the forming products were taken out from the mold. The forming products were immersed in water to allow the sodium carbonate taken in the forming products to be extracted and removed. The forming products were dried into secondary active material forming products.

### EXAMPLE 14 OF PRODUCTION OF SECONDARY FORMING PRODUCTS

50 g of ethylene vinyl acetate copolymer, 100 g of a solvent (xylene) and 100 g of the electrically conductive filler (carbon black) were heated to 80° C., mixed and kneaded, thus giving conductivity to the resin. KOH crushed under dry atmosphere was classified with a 50 μm-mesh sieve. KOH particles having a particle diameter of 500 μm or less were added to and well mixed with the resin. 20 g of the electrically conductive resin containing xylene and 90 g of the primary particles were mixed and agitated at 80° C. The entire mixture was filled in the mold having a cross-section of 100 mm×100 mm and the temperature was decreased under a pressure of 0.1 Mpa within the mold, to allow the resin to be cured. The mixture was left at room temperature and normal pressure to allow xylene to be vaporized. Then, the forming products were taken out from the mold as secondary forming products. KOH taken in the forming products is dissolved on water or an electrolytic solution and becomes a part of the electrolyte when filled in the battery.

### EXAMPLE 15 OF PRODUCTION OF SECONDARY FORMING PRODUCTS

100 g of phenol resin and 150 g of the electrically conductive filler (carbon black) were mixed and kneaded, thus giving conductivity. 20 g of the electrically conductive resin and 90 g of the primary particles were mixed and agitated. The entire mixture was filled in the mold having a cross-section of 100 mm×100 mm and heated to a solidifying temperature (115° C.) under a pressure of 0.1 Mpa within the mold to allow the resin to be cured. The resulting forming products were taken out as secondary active material forming products.

### (3) EMBODIMENTS OF THE INVENTION FOR ACHIEVING THE THIRD OBJECTIVE

In the three-dimensional battery filled with forming products of the particulate, plate-shaped, or bar-shaped active material products, reaction is difficult to progress and battery performance is degraded, unless the active material products are well compatible with electrolytic solution. The active material forming products used in the three-dimensional battery are obtained by shaping a mixture of metal or metal oxide and the electrically conductive filler or resin, and hence tends to be incompatible with the electrolytic solution. Accordingly, by adding and applying inorganic oxide or inorganic hydroxide to the active material products for the battery, hydrophilicity of the active material products is improved to allow the active material products to be well compatible with the electrolytic solution, thereby improving the battery performance.

As the active materials, all kinds of active materials may be used, regardless of the type of the battery, or the cathode or the anode. For example, in the case of the nickel-hydrogen secondary battery, nickel hydroxide is used as the cathode active material and hydrogen-occluding alloy is used as the anode active material. In addition to these, known battery active materials such as cadmium hydroxide, lead, lead dioxide, lithium, etc, may be used, and further, general solid materials such as wood, graphite, carbon, iron ore, coal, charcoal, sand, gravel, silica, slag, chaff, etc, may be used. As the electrically conductive filler to be added to give conductivity to the active materials for battery, carbon fibers, nickel-plated carbon fibers, nickel-plated organic fibers, carbon particles, nickel-plated carbon particles, fibrous nickel, nickel particles, nickel foil, etc, may be used

As the resin used in shaping and curing of the active material products for battery, thermoplastic resin such as polyethylene, polypropylene, and ethylene vinyl acetate copolymer, reaction curing resin such as epoxy resin, urethane resin, unsaturated polyester resin, thermosetting resin such as phenol resin, PES resin, polystyrene, polysulfone, polyacrylonitrile, polyvinylidene fluoride, polyamide, polyimide, acetylcellulose, oxide phenylene ether (PPO), etc, may be used. As the binder, alkali-resistant resin must be used.

Thermoplastic resin melted by heating may be mixed with and dispersed in the active material mixture. But, when the resin dissolved in the solvent is added to the active material mixture, the resin tends to be uniformly dispersed in the active material mixture, so that the active material mixture may be shaped with a small amount of resin. For example, polyethylene, polypropylene, or ethylene vinyl acetate copolymer is soluble in the solvent such as heated benzene, toluene, or xylene. After the resin dissolved in any of these solvents is mixed with the active material products and the electrically conductive filler, the solvent is removed by vaporization, thereby creating the active material forming products solidified by the resin. When resin dissolved in a water-soluble solvent is added, active material forming products solidified by the resin can be created by removing the solvent by vaporization. For example, polyether sulfone (PES) resin is soluble in dimethyl sulfoxide (DMSO). Also, polystyrene is soluble in acetone. Polysulfone is soluble in dimethyl formamide (DMF) or DMSO. Polyacrylonitrile is soluble in DMF, DMSO, or ethylene carbonate. Plyvinylidene fluoride is soluble in DMF, DMOS or N-methyl-2-pyrrolidone (NMP). Polyamide is soluble in DMF or NMP. Polyimide is soluble in DMF or NMP. When adding the resin dissolved in the alcohol-soluble solvent is added, active material forming products solidified by the resin can be created by removing the solvent by vaporization. For example, acetylcellulose is soluble in methylene chloride, and oxide phenylene ether (PPO) is soluble in methylene chloride.

The active material forming products are obtained by secondary formation of forming products or resin forming products in the shape of particle, plate, or bar, or primary forming products in the shape of particle, plate or bar. These particles can be produced by agitation, tablet making or tablet forming, pressurized forming, extrusion molding, or the like. In the case of the tablet making, the tablet forming, the pressurized forming, or the extrusion molding, the active material products obtained as the forming products may be crushed. Or, the angular forming products may be rounded to provide smooth surfaces.

The active material forming products may be forming products coated with electrically conductive material such as carbon fibers, nickel-plated carbon fibers, nickel-plated organic fibers, carbon powder, nickel-plated carbon powder, fibrous nickel, nickel powder, nickel foil, etc. The coating is performed in such a manner that, before curing the forming products, the metal powder, the metal fibers, the metal-plated fibers, or the like are added to the forming products, followed by rolling and agitation, thereby allowing any of these to adhere to outer surfaces of the soft forming products. In the case of the forming products solidified by the resin, the forming products using thermosetting resin, or the forming products using resin soluble in the solvent, the forming products is heated up in temperature to be softened, or the solvent is added to the forming products to allow the forming products to be expanded and softened to be thereby uncured, and the metal is added to the uncured forming products.

As the active material forming products, nickel-plated forming products may be used. By forming the electrically conductive layer on the outer surfaces of the forming products by coating or plating of the electrically conductive material, a large current flows.

Inorganic oxide to be added and applied for giving hydrophilicity to the active material forming products, include metal oxide such as titanium dioxide, silicon dioxide, calcium oxide, and calcium carbonate, or a material containing any of these metal oxide as major component, for example, photocatalyst containing titanium dioxide as major component. Inorganic hydroxide contains metal hydroxide such as calcium hydroxide or metal hydroxide such as calcium hydroxide as major component. When the inorganic oxide or the inorganic hydroxide is applied, it is preferable that the inorganic oxide or inorganic hydroxide is suspended in and dispersed in the solvent such as water, toluene, xylene, isopropyl alcohol, and the active material forming products are immersed in the solvent. Preferably, the solvent is agitated while the active material forming products are immersed. In this method, since the active material forming products only contact the solvent with the inorganic oxide or the inorganic hydroxide dispersed therein, operation is easy. To dry the active material forming products after application, the active material forming products may be dried at room temperature and normal pressure, or may be dried by heating, vacuum drying, reduced-pressure drying, or the like.

The inorganic oxide or the inorganic hydroxide may be applied or added to the surfaces or interior of the active material forming products by mixing or agitation to allow the active material products to mechanically contact the inorganic oxide or the inorganic hydroxide. In this method, since the active material forming products only contact the inorganic oxide or the inorganic hydroxide, operation is easy. Thus, the inorganic oxide or the inorganic hydroxide for giving hydrophilicity to the active material forming products may be added to the surfaces or interior of the active material forming products.

Hereinafter, examples of the present invention will be described.

### EXAMPLE 1 OF PRODUCTION OF HYDROPHILIC ACTIVE MATERIAL PRODUCTS

150 g of particulate graphite (acetylene black) was put into the Henschel mixer having an internal volume of 10 liters and agitated at 1000 rpm for about 3 minutes to be sufficiently dispersed. Then, 1000 g of nickel hydroxide powder for battery and 100 g of carbon fibers (trade name: DONER S-247) were added to and mixed with the particulate graphite at 1000 rpm for about 3 minutes. 150 g of ethylene vinyl acetate copolymer was added to and dissolved in 1000 g of xylene heated to 60° C. Resin dissolved in the heated xylene was added to a mixture of the nickel hydroxide powder and the electrically conductive filler which were heated to 60° C. and agitated by the Henschel mixer while being kept at 60° C. Then, the Henschel mixer was cooled while agitating the mixture, and the mixture was cooled and crushed into powder. The powder was put into the high-speed mixer and entirely agitated by the agitator while adjusting the size of the granulated particles by the chopper. The powder was agitated under the condition in which the high-speed mixer had a volume of 2 liters, the number of rotations of the agitator was 600 rpm, and the number of rotations of the chopper was 1500 rpm, and temperature of the powder was increased from room temperature to 50° C. After formation of the granulated particles, agitation was stopped while cooling the granulated particles. In this way, active material particles were created.

The active material particles were put into the organic solvent (isopropyl alcohol) with photocatalytic material containing titanium dioxide as major component dispersed therein, and agitated for 5 minutes. The particles with titanium dioxide applied thereon were taken out and dried at room temperature and normal pressure for 30 minutes, to remove isopropyl alcohol and xylene. Since the application of the titanium dioxide on the surface of the active material products for battery can improve hydrophilicity of the active material products, the active material products are well compatible with the electrolytic solution when filled in the three-dimensional battery. As a result, the battery reaction is promoted.

### EXAMPLE 2 OF PRODUCTION OF HYDROPHILIC ACTIVE MATERIAL PRODUCTS

The active material particles were created in the same method as in the Example 1. After formation of the particles, nickel-plated carbon fibers which were crushed into those having an average length of approximately 200 μm were added while agitating the mixture, and the mixture was further agitated for 5 minutes. Thereafter, agitation was stopped while cooling the mixture, and the particles were coated with the nickel-plated carbon fibers. This improves conductivity of the active material products.

The active material particles were put into the organic solvent (isopropyl alcohol) with photocatalytic material containing titanium dioxide as major component dispersed therein and agitated for 5 minutes. The particles with titanium dioxide applied thereon were taken out and dried at room temperature and normal pressure for 30 minutes, to remove isopropyl alcohol and xylene. Since the application of the titanium dioxide on the surface of the active material products for battery can improve hydrophilicity of the active material products, the active material products are well compatible with the electrolytic solution when filled in the three-dimensional battery. As a result, the battery reaction is promoted.

### EXAMPLE 3 OF PRODUCTION OF HYDROPHILIC ACTIVE MATERIAL PRODUCTS

150 g of particulate graphite (acetylene black) was put into the Henschel mixer having an internal volume of 10 liters and agitated at 1000 rpm for about 3 minutes to be sufficiently dispersed. Then, 1000 g of nickel hydroxide powder for battery, 100 g of carbon fibers (trade name: DONER S-247), and 50 g of the photocatalytic material containing titanium dioxide as major component were added to and mixed with the particulate graphite at 1000 rpm for about 3 minutes. 150 g of ethylene vinyl acetate copolymer was added to and dissolved in 1000 g of xylene heated to 60° C. Resin dissolved in the heated xylene was added to a mixture of the nickel hydroxide powder, the electrically conductive filler, and titanium dioxide which were heated to 60° C. and agitated by the Henschel mixer while being kept at 60° C. Then, the Henschel mixer was cooled while agitating the mixture, and the mixture was cooled and crushed into powder. The powder was put into the high-speed mixer and entirely agitated by the agitator while adjusting the size of the granulated particles by the chopper. The powder was agitated under the condition in which the high-speed mixer had a volume of 2 liters, the number of rotations of the agitator was 600 rpm, and the number of rotations of the chopper was 1500 rpm, and temperature of the powder was increased from room temperature to 50° C. After formation of the granulated particles, agitation was stopped while cooling the granulated particles. The particles containing xylene were put into the pressure-reducing drier and heated to 50° C., to remove xylene. By adding titanium dioxide on the interior and surface of the active material products for battery, hydrophilicity of the active material products is improved. So, the active material products are well compatible with the electrolytic solution when filled in the three-dimensional battery. As a result, the battery reaction is promoted.

### EXAMPLE 4 OF PRODUCTION OF HYDROPHILIC ACTIVE MATERIAL PRODUCTS

150 g of particulate graphite (acetylene black) was put into the Henschel mixer having an internal volume of 10 liters and agitated at 1000 rpm for about 3 minutes to be sufficiently dispersed. Then, 1000 g of nickel hydroxide powder for battery, 100 g of carbon fibers (trade name: DONER S-247) and 50 g of calcium hydroxide fine powder were added to and mixed with the particulate graphite at 1000 rpm for about 3 minutes. 150 g of ethylene vinyl acetate copolymer was added to and dissolved in 1000 g of xylene heated to 60° C. Resin dissolved in the heated xylene was added to a mixture of the nickel hydroxide powder, the electrically conductive filler, and the calcium hydroxide powder which were heated to 60° C. and agitated by the Henschel mixer while being kept at 60° C. Then, the Henschel mixer was cooled while agitating the mixture, and the mixture was cooled and crushed into powder. The powder was put into the high-speed mixer and entirely agitated by the agitator while adjusting the size of the granulated particles by the chopper. The powder was agitated under the condition in which the high-speed mixer had a volume of 2 liters, the number of rotations of the agitator was 600 rpm, and the number of rotations of the chopper was 1500 rpm, and temperature of the powder was increased from room temperature to 50° C. After formation of the granulated particles, agitation was stopped while cooling the granulated particles. The particles containing xylene were put into the pressure-reducing drier and heated to 50° C., to remove xylene. By adding calcium hydroxide on the interior and surface of the active material products for battery, hydrophilicity of the active material products is improved. So, the active material products are well compatible with the electrolytic solution when filled in the three-dimensional battery. As a result, the battery reaction is promoted.

### EXAMPLE 5 OF PRODUCTION OF HYDROPHILIC ACTIVE MATERIAL PRODUCTS

The active material particles were created in the same method as in the Example 1. After formation of the particles, calcium hydroxide fine powder was added while agitating the mixture, and the mixture was further agitated for 30 minutes to allow the calcium hydroxide fine powder to be added to the surfaces of the particles. The particles containing xylene were put into the pressure-reducing drier and heated to 50° C., to remove xylene. The addition of calcium hydroxide improves hydrophilicity of the active material products. So, the active material products are well compatible with the electrolytic solution when filled in the three-dimensional battery. As a result, the battery reaction is promoted.

### EXAMPLE 6 OF PRODUCTION OF HYDROPHILIC ACTIVE MATERIAL PRODUCTS

The active material particles were created in the same method as in the Example 1. The particles containing xylene were put into the pressure-reducing drier and heated to 50° C., to remove xylene. Nickel-plating was applied to surface of the particles by electroless metal plating. The plated particles and the calcium hydroxide fine powder were agitated and mixed by the agitator for 30 minutes. In this way, the calcium hydroxide fine powder was added to the surfaces of the particles. Since hydrophilicity of the active material products is improved, the active material products are well compatible with the electrolytic solution when filled in the three-dimensional battery. As a result, the battery reaction is promoted.

### EXAMPLE 7 OF PRODUCTION OF HYDROPHILIC ACTIVE MATERIAL PRODUCTS

The active material particles were created in the same method as in the Example 1. The particles were filled in a mold and heated to 100° C. Thereby, resin (ethylene acetate vinyl copolymer) contained in the particles was dissolved and the temperature was decreased under a pressure of 0.1 Mpa within the mold, to allow the resin to be cured. In this way, plate-shaped secondary forming products were created.

The secondary active material forming products were immersed in the organic solvent (isopropyl alcohol) with photocatalytic material containing titanium dioxide as major component dispersed therein. The active material forming products with titanium dioxide applied thereon were taken out and dried for 30 minutes at room temperature and vacuum drying, to remove isopropyl alcohol and the remaining xylene. Since the application of the titanium dioxide on the surface of the active material products for battery can improve hydrophilicity of the active material products, the active material products are well compatible with the electrolytic solution when filled in the three-dimensional battery. As a result, the battery reaction is promoted.

### EXAMPLE 8 OF PRODUCTION OF HYDROPHILIC ACTIVE MATERIAL PRODUCTS

150 g of particulate graphite (acetylene black) was put into the Henschel mixer having an internal volume of 10 liters and agitated at 1000 rpm for about 3 minutes to be sufficiently dispersed. Then, 1000 g of nickel hydroxide powder for battery and 100 g of carbon fibers (trade name: DONER S-247) were added to and mixed with the particulate graphite at 1000 rpm for about 3 minutes. 150 g of ethylene vinyl acetate copolymer was added to the mixture as thermoplastic resin and mixed with the mixture at a temperature of not lower than a softening temperature of the resin for 10 minutes. The mixture was taken out and put into an extruder, from which bar-shaped active material products were extruded.

The bar-shaped active material particles were immersed in the organic solvent (isopropyl alcohol) with photocatalytic material containing titanium dioxide as major component dispersed therein. The bar-shaped active material products with titanium dioxide applied thereon was taken out and dried at room temperature and by vacuum drying for 30 minutes, to remove isopropyl alcohol. Since the application of the titanium dioxide on the surface of the bar-shaped active material products can improve hydrophilicity of the active material products, the active material products are well compatible with the electrolytic solution when filled in the three-dimensional battery. As a result, the battery reaction is promoted.

### EXAMPLE 9 OF PRODUCTION OF HYDROPHILIC ACTIVE MATERIAL PRODUCTS

150 g of particulate graphite (acetylene black, ketchen black) was put into the Henschel mixer having an internal volume of 10 liters and agitated at 1000 rpm for about 3 minutes to be sufficiently dispersed. Then, 2500 g of hydrogen-occluding alloy powder for battery and 100 g of carbon fibers (trade name: DONER S-247) were added to and mixed with the particulate graphite at 1000 rpm for about 3 minutes. 150 g of ethylene vinyl acetate copolymer was added to and dissolved in 1000 g of xylene heated to 60° C. Resin dissolved in the heated xylene was added to a mixture of the hydrogen-occluding alloy and the electrically conductive filler which were heated to 60° C. and agitated by the Henschel mixer while being kept at 60° C. Then, the Henschel mixer was cooled while agitating the mixture, and the mixture was cooled and crushed into powder. The powder was put into the high-speed mixer and agitated by the agitator while adjusting the size of the granulated particles by the chopper. The powder was agitated under the condition in which the high-speed mixer had a volume of 2 liters, the number of rotations of the agitator was 600 rpm, and the number rotations of the chopper was 1500 rpm, and temperature of the powder was increased from room temperature to 50° C. After formation of the granulated particles, agitation was stopped while cooling the granulated particles. In this way, the active material particles were created.

The active material particles were put into the organic solvent (isopropyl alcohol) with photocatalytic material containing titanium dioxide as major component dispersed therein and agitated for 5 minutes. The particles with titanium dioxide applied thereon were taken out and dried at room temperature and normal pressure for 30 minutes, to remove isopropyl alcohol and xylene. As a result, the active material products for battery with titanium dioxide applied thereon was created.

### EXAMPLE 10 OF HYDROPHILIC ACTIVE MATERIAL PRODUCTS

150 g of particulate graphite (acetylene black) was put into the Henschel mixer having an internal volume of 10 liters and agitated at 1000 rpm for about 3 minutes to be sufficiently dispersed. Then, 1000 g of sand (toyoura standard sand) and 100 g of carbon fibers (trade name: DONER S-247) were added to and mixed with the particulate graphite at 1000 rpm for about 3 minutes. 150 g of ethylene vinyl acetate copolymer was added to and dissolved in 1000 g of xylene heated to 60° C. Resin dissolved in heated xylene was added to the mixture of the sand and electrically conductive filler which were heated to 60° C. and agitated by the Henschel mixer while being kept at 60° C. Then, the Henschel mixer was cooled while agitating the particles, and the mixture was cooled and crushed into powder. The powder was put into the high-speed mixer and agitated by the agitator while adjusting the size of the granulated particles by the chopper. The powder was agitated under the condition in which the high-speed mixer had a volume of 2 liters, the number of rotations of the agitator was 600 rpm, and the number of rotations of the chopper was 1500 rpm, and temperature of the powder was increased from room temperature to 50° C. After formation of the granulated particles, agitation was stopped while cooling the granulated particles. In this way, the active material particles were created.

The active material particles were put into the organic solvent (isopropyl alcohol) with photocatalytic material containing titanium dioxide as major component dispersed therein and agitated for 5 minutes. The particles with titanium dioxide applied thereon were taken out and dried at room temperature and normal pressure for 30 minutes, to remove isopropyl alcohol and xylene. As a result, the active material products for battery with titanium dioxide applied thereon was created.

### EXAMPLE 11 OF PRODUCTION OF HYDROPHILIC ACTIVE MATERIAL PRODUCTS

150 g of particulate graphite (acetylene black) was put into the Henschel mixer having an internal volume of 10 liters and agitated at 1000 rpm for about 3 minutes to be sufficiently dispersed. Then, 1000 g of coal particles (fine powder coal of Daidousumi) and 100 g of carbon fibers (trade name: DONER S-247) were added to and mixed with the particulate graphite at 1000 rpm for about 3 minutes. 150 g of ethylene vinyl acetate copolymer was added to and dissolved in 1000 g of xylene heated to 60° C. Resin dissolved in the heated xylene was added to a mixture of the coal and the electrically conductive filler which were heated to 60° C. and agitated by the Henschel mixer while being kept at 60° C. Then, the Henschel mixer was cooled while agitating the mixture, and the mixture was cooled and crushed into powder. The powder was put into the high-speed mixer and agitated by the agitator while adjusting the size of the granulated particles by the chopper. The powder was agitated under the condition in which the high-speed mixer had a volume of 2 liters, the number of rotations of the agitator was 600 rpm, and the number of rotations of the chopper was 1500 rpm, and temperature of the powder was increased from room temperature to 50° C. After formation of the granulated particles, agitation was stopped while cooling the granulated particles. In this way, the active material particles were created.

The active material particles were put into the organic solvent (isopropyl alcohol) with photocatalytic material containing titanium dioxide as major component dispersed therein and agitated for 5 minutes. The particles with titanium dioxide applied thereon were taken out and dried at room temperature and normal pressure for 30 minutes, to remove isopropyl alcohol and xylene. Thus, the active material products for battery with titanium dioxide applied thereon was created.

### EXAMPLE 12 OF HYDROPHILIC ACTIVE MATERIAL PRODUCTS

150 g of particulate graphite (acetylene black) was put into the Henschel mixer having an internal volume of 10 liters and agitated at 1000 rpm for about 3 minutes to be sufficiently dispersed. Then, 500 g of charcoal (obtained by calcining wood at 600° C. for 2 hours) and 100 g of carbon fibers (trade name: DONER S-247) were added to and mixed with the particulate graphite at 1000 rpm for about 3 minutes. 150 g of ethylene vinyl acetate copolymer was added to and dissolved in 1000 g of xylene heated to 60° C. The resin dissolved in the heated xylene was added to the mixture of the charcoal and the electrically conductive filler which were heated to 60° C. and agitated by the Henschel mixer while being kept at 60° C. Then, the Henschel mixer was cooled while agitating the mixture, and the mixture was cooled and crushed into powder. The powder was put into the high-speed mixer and agitated by the agitator while adjusting the size of the granulated particles by the chopper. The powder was agitated under the condition in which the high-speed mixer had a volume of 2 liters, the number of rotations of the agitator was 600 rpm, and the number of rotations of the chopper was 1500 rpm, and temperature of the powder was increased from room temperature to 50° C. After formation of the granulated particles, agitation was stopped while cooling the granulated particles. In this way, the active material particles were created.

The active material particles were put into the organic solvent (isopropyl alcohol) with photocatalytic material containing titanium dioxide as major component dispersed therein and agitated for 5 minutes. The particles with titanium dioxide applied thereon were taken out and dried at room temperature and normal pressure for 30 minutes, to remove isopropyl alcohol and xylene. As a result, the active material products for battery with titanium dioxide applied thereon was created.

### EXAMPLE 13 OF PRODUCTION OF HYDROPHILIC ACTIVE MATERIAL PRODUCTS

150 g of particulate graphite (acetylene black) was put into the Henschel mixer having an internal volume of 10 liters and agitated at 1000 rpm for about 3 minutes to be sufficiently dispersed. Then, 500 g of silica (obtained by calcining chaff at 600° C. for 2 hours) and 100 g of carbon fibers (trade name: DONER S-247) were added to and mixed with the particulate graphite at 1000 rpm for about 3 minutes. 150 g of ethylene vinyl acetate copolymer was added to and dissolved in 1000 g of xylene heated to 60° C. The resin dissolved in the heated xylene was added to the mixture of the silica and the electrically conductive filler which were heated to 60° C. and agitated by the Henschel mixer while being kept at 60° C. Then, the Henschel mixer was cooled while agitating the mixture, and the mixture was cooled and crushed into powder. The powder was put into the high-speed mixer and agitated by the agitator while adjusting the size of the granulated particles by the chopper. The powder was agitated under the condition in which the high-speed mixer had a volume of 2 liters, the number of rotations of the agitator was 600 rpm, and the number of rotations of the chopper was 1500 rpm, and temperature of the powder was increased from room temperature to 50° C. After formation of the granulated particles, agitation was stopped while cooling the granulated particles. In this way, the active material particles were created.

The active material particles were put into the organic solvent (isopropyl alcohol) with photocatalytic material containing titanium dioxide as major component dispersed therein and agitated for 5 minutes. The particles with titanium dioxide applied thereon were taken out and dried at room temperature and normal pressure for 30 minutes, to remove isopropyl alcohol and xylene. Thus, the active material products for battery with titanium dioxide applied thereon was created.

### EXAMPLE 14 OF PRODUCTION OF HYDROPHILIC ACTIVE MATERIAL PRODUCTS

150 g of particulate graphite (acetylene black) was put into the Henschel mixer having an internal volume of 10 liters and agitated at 1000 rpm for about 3 minutes to be sufficiently dispersed. Then, 1000 g of slag (obtained by melting ash of burned garbage at 1500° C. and then by cooling the ash) and 10 g of carbon fibers (trade name: DONER S-247) were added to and mixed with the particulate graphite at 1000 rpm for about 3 minutes. 150 g of ethylene vinyl acetate copolymer was added to and dissolved in 1000 g of xylene heated to 60° C. The resin dissolved in the heated xylene was added to the mixture of the slag and the electrically conductive filler which were heated at 60° C. and agitated by the Henschel mixer while being kept at 60° C. Then, the Henschel mixer was cooled while agitating the mixture, and the mixture was cooled and crushed into powder. The powder was put into the high-speed mixer and agitated by the agitator while adjusting the size of the granulated particles by the chopper. The powder was agitated under the condition in which the high-speed mixer had a volume of 2 liters, the number of rotations of the agitator was 600 rpm, and the number of rotations of the chopper was 1500 rpm, and temperature of the powder was increased from room temperature to 50° C. After formation of the granulated particles, agitation was stopped while cooling the granulated particles. In this way, the active material particles were created.

The active material particles were put into the organic solvent (isopropyl alcohol) with photocatalytic material containing titanium dioxide as major component dispersed therein and agitated for 5 minutes. The particles with titanium dioxide applied thereon were taken out and dried at room temperature and normal pressure for 30 minutes, to remove isopropyl alcohol and xylene. As a result, the active material products for battery with titanium dioxide applied thereon was created.

### EXAMPLE 15 OF PRODUCTION OF HYDROPHILIC ACTIVE MATERIAL PRODUCTS

150 g of particulate graphite (acetylene black) was put into the Henschel mixer having an internal volume of 10 liters and agitated at 1000 rpm for about 3 minutes to be sufficiently dispersed. Then, 500 g of carbon (obtained by calcining carbon fibers at 1100° C.) was added to and mixed with the particulate graphite at 1000 rpm for about 3 minutes. 150 g of ethylene vinyl acetate copolymer was added to and dissolved in 1000 g of xylene heated at 60° C. The resin dissolved in the heated xylene was added to the mixture of the carbon and the electrically conductive filler which were heated to 60° C. and agitated by the Henschel mixer while being kept at 60° C. Then, the Henschel mixer was cooled while agitating the mixture, and the mixture was cooled and crushed into powder. The powder was put into the high-speed mixer and agitated by the agitator while adjusting the size of the granulated particles by the chopper. The powder was agitated under the condition in which the high-speed mixer had a volume of 2 liters, the number of rotations of the agitator was 600 rpm, and the number of rotations of the chopper was 1500 rpm, and temperature of the powder was increased from room temperature to 50° C. After formation of the granulated particles, agitation was stopped while cooling the granulated particles. In this way, the active material particles were created.

The active material particles were put into the organic solvent (isopropyl alcohol) with photocatalytic material containing titanium dioxide as major component dispersed therein, and agitated for 5 minutes. The particles with titanium dioxide applied thereon were taken out and dried at room temperature and normal pressure for 30 minutes, to remove isopropyl alcohol and xylene. As a result, the active material products for battery with titanium dioxide applied thereon was created.

### (4) EMBODIMENTS OF THE INVENTION FOR ACHIEVING THE FOURTH OBJECTIVE

The three-dimensional battery filled with active material products such as particulate or plate-shaped forming products, secondary forming products of these, plated forming products, or forming products subjected to surface treatment, exhibits low performance just after production of the battery and is incapable of exhibiting desired battery performance unless charge and discharge are repeated once or plural times. Accordingly, before assembling the battery (or after assembling the battery if the electrolytic solution is not injected yet), the active material products of the battery are placed under pressure-reduced condition and is thereafter placed under pressurized condition using a gas such as hydrogen, thereby increasing the activity of the active material products. Under this condition, the battery can exhibit desired battery performance just after assembling. Since the activity of the active material products is increased in advance, it is not necessary to increase the activity by repeating charge and discharge just after production of the battery.

As the active material, all kinds of active materials may be used, regardless of the type of the battery, or the cathode or the anode. For example, in the case of the nickel-hydrogen secondary battery, nickel hydroxide is used as the cathode active material and hydrogen-occluding alloy is used as the anode active material. In addition to these, known battery active materials such as cadmium hydroxide, lead, lead dioxide, lithium, etc, may be used, and further, general solid materials such as wood, graphite, carbon, iron ore, iron carbide, iron sulfide, iron hydroxide, iron oxide, coal, charcoal, sand, gravel, silica, slag, chaff, etc, may be used. As the electrically conductive filler to be added to the active material products to give conductivity, carbon fibers, nickel-plated carbon fibers, nickel-plated organic fibers, nickel-plated inorganic fibers of silica or alumina, nickel-plated inorganic foil of mica, carbon particles, nickel-plated carbon particles, fibrous nickel, nickel particles, nickel foil, etc, may be used As the resin used in forming and curing the active material products for battery, thermoplastic resin such as polyethylene, polypropylene, and ethylene vinyl acetate copolymer, reaction curing resin such as epoxy resin, urethane resin, unsaturated polyester resin, thermosetting resin such as phenol resin, PES resin, polystyrene, polysulfone, polyacrylonitrile, polyvinylidene fluoride, polyamide, polyimide, acetylcellulose, oxide phenylene ether (PPO), etc, may be used. As the binder, alkali-resistant resin must be used.

Thermoplastic resin melted by heating may be mixed with and dispersed in the active material mixture. When the resin dissolved in the solvent is added, the resin is easily uniformly dispersed over the forming products. So, the active material product mixture can be shaped with a small amount of resin. For example, polyethylene, polypropylene, and ethylene vinyl acetate copolymer are soluble in a solvent such as heated benzene, toluene, or xylene. After the resin dissolved in any of these solvents is mixed with the active material products or the electrically conductive filler, the solvent is removed by vaporization, thereby creating the active material forming products (secondary forming products) solidified by the resin. When resin dissolved in water-soluble solvent is added, the solvent is extracted and removed using the water, thereby creating the active material forming products solidified by the resin. For example, polyether sulfone (PES) resin is soluble in dimethyl sulfoxide (DMSO). Plystylene resin is soluble in acetone. Polysulfone is soluble in dimethyl formamide (DMF) or DMSO. Polyacrylonitrile is soluble in DMF, DMSO or ethylene carbonate. Polyvinylidene fluoride is soluble in DMF, DMSO, or N-methyl-2-pyrrolidone (NMP). Polyamide is soluble in DMF or NMP. Polyimide is soluble in DMF or NMP. When the resin dissolved in alcohol-soluble solvent is added, the active material forming products solidified by the resin can be created by extracting and removing the solvent by using alcohol. For example, acetylcellulose is soluble in methylene chloride, and oxide phenylene ether (PPO) is soluble in methylene chloride.

The active material forming products may be obtained by secondary formation of forming products or resin forming products in the shape of particle, plate or bar, or primary forming products in the shape of particle, plate or bar. These forming products can be created by agitation, the tablet making or the tablet forming, or otherwise pressurized forming or extrusion molding. When using the tablet making, the tablet forming, the pressurized forming, or extrusion molding, the active material forming products may be crushed. Alternatively, the forming products which are angular may be rounded to provide smooth surfaces.

The active material forming products may be forming products coated with an electrically conductive material such as carbon fibers, nickel-plated carbon fibers, carbon powder, nickel-plated carbon powder, nickel-plated organic fibers, nickel-plated inorganic fibers of silica or alumina, nickel-plated inorganic foil of mica, fibrous nickel, nickel powder, or nickel foil. In the coating method, the metal powder, metal fibers, or metal-plated fibers, is added to the forming products before being cured, followed by rolling and agitation, thereby allowing any of the metal powder, metal fibers, or the metal-plated fibers to adhere to soft outer surfaces of the forming products. In the case of the forming products solidified by resin, forming products by using thermo-softening resin, or forming products by using resin soluble in a solvent, temperature of the forming products is increased to allow the forming products to be softened by heating, or the solvent is added to the particles to allow the particles to be expanded and softened to be thereby uncured. Then, metal is added to the uncured particles.

The active material forming products may be forming products having surfaces coated with nickel-plating. By creating the electrically conductive layer on the outer surfaces of the forming products by cooling or plating of the electrically-conductive material, a large current flows.

As an operation for pressure-reducing the active material products for battery, a closed container (e.g., pressure container) filled with the active material products is pressure-reduced to less than an atmospheric pressure by using a vacuum pump or the like. An operation for pressuring the active material products for battery is such that a gas such as hydrogen is injected into the closed vessel (pressure vessel) filled with the active material products by using a pressure pump or the like to allow the vessel to be set to more than atmospheric pressure. The gases used in pressure application, which are other than hydrogen, may be atmospheric air (air), nitrogen, oxygen, ozone, carbon monoxide, carbon dioxide, helium, neon, argon, nitrogen monoxide, nitrogen dioxide, and hydrogen sulfide. In contrast to the conventional method of increasing the activity by repeated charge and discharge, in the method of the present invention, the activity of the battery is increased in a very short time, and desired performance is obtained. As a result, production time of the battery can be reduced.

Hereinbelow, examples of the present invention will be described.

### EXAMPLE 1 OF PRODUCTION OF ACTIVATED ACTIVE MATERIAL PRODUCTS

150 g of particulate graphite (acetylene black) was put into the Henschel mixer having an internal volume of 10 liters and agitated at 1000 rpm for about 3 minutes to be sufficiently dispersed. Then, 1000 g of nickel hydroxide powder for battery and 100 g of carbon fibers (trade name: DONER S-247) were added to and mixed with the particulate graphite at 1000 rpm for about 3 minutes. 150 g of ethylene vinyl acetate copolymer was added to and dissolved in 1000 g of xylene heated to 60° C. Resin dissolved in the heated xylene was added to a mixture of the nickel hydroxide powder and the electrically conductive filler which were heated to 60° C. and agitated by the Henschel mixer while being kept at 60° C. Then, the Henschel mixer was cooled while agitating the mixture, and the mixture was cooled and crushed into powder. The powder was put into the high-speed mixer and entirely agitated by the agitator while adjusting the size of granulated particles by the chopper. The powder was agitated under the condition in which the high-speed mixer had a volume of 2 liters, the number of rotations of the agitator was 600 rpm, and the number of rotations of the chopper was 1500 rpm, and temperature of the powder was increased from room temperature to 50° C. After formation of granulated particles, agitation was stopped while cooling granulated particles. The particles containing xylene, were put into the pressure-reducing drier and heated to 50° C., to remove xylene. The particles were cooled and then sieved with a 2.88 mm-mesh sieve and a 1 mm-mesh sieve, thereby obtaining particles of a particle diameter of 1 to 2.88 mm.

200 ml of the active material particles were filled in the pressure vessel having an internal volume of 1 liter and its pressure was reduced to 100 Pa by using the vacuum pump. Hydrogen gas was injected into the vessel having a pressure of 100 Pa by using the pressure pump to increase the pressure to 5 Mpa. The vessel was kept under the pressure of 5 Mpa for 3 hours, and thereafter, the hydrogen gas was released so that the pressure returned to atmospheric pressure. Further, the pressure was reduced to 100 Pa by using the vacuum pump, and thereafter, air was injected so that the pressure returned to the atmospheric pressure. The resulting active material particles can exhibit desired battery performance just after charge of the battery.

### EXAMPLE 2 OF PRODUCTION OF ACTIVATED ACTIVE MATERIAL PRODUCTS

150 g of particulate graphite (acetylene black) was put into the Henschel mixer having an internal volume of 10 liters and agitated at 1000 rpm for about 3 minutes to be sufficiently dispersed. Then, 2500 g of hydrogen-occluding alloy powder for battery and 100 g of carbon fibers (trade name: DONER S-247) were added to and mixed with the particulate graphite at 1000 rpm for about 3 minutes. 150 g of ethylene vinyl acetate copolymer was added to and dissolved in 1000 g of xylene heated to 60° C. Resin dissolved in the heated xylene was added to a mixture of the hydrogen-occluding alloy and the electrically conductive filler which were heated to 60° C. and agitated by the Henschel mixer while being kept at 60° C. Then, the Henschel mixer was cooled while agitating the mixture, and the mixture was cooled and crushed into powder. The powder was put into the high-speed mixer and agitated by the agitator while adjusting the size of granulated particles by the chopper. The powder was agitated under the condition in which the high-speed mixer had a volume of 2 liters, the number of rotations of the agitator was 600 rpm, and the number rotations of the chopper was 1500 rpm, and temperature of the powder was increased from room temperature to 50° C. After formation of granulated particles, agitation was stopped while cooling granulated particles. The particles containing xylene, was put into the pressure-reducing drier and heated to 50° C., to remove xylene. The particles were cooled and then sieved with a 2.88 mm-mesh sieve and a 1 mm-mesh sieve, thereby obtaining particles of a particle diameter of 1 to 2.88 mm.

200 ml of the active material particles were filled in the pressure vessel having an internal volume of 1 liter and its pressure was reduced to 100 Pa by using the vacuum pump. Hydrogen gas was injected into the vessel having a pressure of 100 Pa by using the pressure pump to increase the pressure to 5 Mpa. The vessel was kept under the pressure of 5 Mpa for 3 hours, and thereafter, the hydrogen gas was released so that the pressure returned to atmospheric pressure. The pressure was reduced to 100 Pa by using the vacuum pump, and thereafter, air was injected so that the pressure returned to the atmospheric pressure. The resulting active material particles can exhibit desired battery performance just after charge in the battery.

### EXAMPLE 3 OF PRODUCTION OF ACTIVATED ACTIVE MATERIAL PRODUCTS

Active material particles containing nickel hydroxide, the electrically conductive filler, and the resin were created in the same method as in the Example 1. Likewise, active material particles containing hydrogen-occluding alloy, the electrically conductive filler, and the resin were created in the same manner as in the Example 2. Using these active material particles as cathode active material products and anode active material products, the nickel-hydrogen secondary battery was assembled. The assembled battery was installed within the pressure vessel having an internal volume of 1 liter and the pressure was reduced to 100 Pa. The hydrogen gas was injected into the vessel having a pressure of 100 Pa by using the pressure pump to increase the pressure to 5 Mpa. The vessel was kept under the pressure of 5 Mpa for 3 hours, and thereafter, the hydrogen gas was released so that the pressure returned to atmospheric pressure. The pressure was reduced to 100 Pa by using the vacuum pump, and thereafter, air was injected so that the pressure returned to the atmospheric pressure. In the assembled battery under the condition in which the electrolytic solution is not injected yet, the activity of the active material products can be increased by applying the hydrogen gas after reducing the pressure.

### EXAMPLE 4 OF PRODUCTION OF ACTIVATED ACTIVE MATERIAL PRODUCTS

Active material particles containing nickel hydroxide, the electrically conductive filler, and the resin were created in the same method as in the Example 1. 200 ml of the active material particles were filled in the pressure vessel having an internal volume of 1 liter and its pressure was reduced to 100 Pa by using the vacuum pump. Carbon dioxide gas was injected into the vessel having a pressure of 100 Pa by using the pressure pump to increase the pressure to 5 Mpa. The vessel was kept under the pressure of 5 Mpa for 3 hours, and thereafter, the carbon dioxide gas was released so that the pressure returned to atmospheric pressure. The pressure was reduced to 100 Pa by using the vacuum pump, and thereafter, air was injected so that the pressure returned to the atmospheric pressure. The resulting active material particles can exhibit desired battery performance just after charge in the battery.

### EXAMPLE 5 OF PRODUCTION OF ACTIVATED ACTIVE MATERIAL PRODUCTS

Active material particles containing nickel hydroxide, the electrically conductive filler, and the resin were created in the same method as in the Example 1. 200 ml of the active material particles were filled in the pressure vessel having an internal volume of 1 liter and its pressure was reduced to 100 Pa by using the vacuum pump. Nitrogen gas was injected into the vessel having a pressure of 100 Pa by using the pressure pump to increase the pressure to 5 Mpa. The vessel was kept under the pressure of 5 Mpa for 3 hours, and thereafter, the nitrogen gas was released so that the pressure returned to atmospheric pressure. The pressure was reduced to 100 Pa by using the vacuum pump, and thereafter, air was injected so that the pressure returned to the atmospheric pressure. The resulting active material particles can exhibit desired battery performance just after charge in the battery.

### EXAMPLE 6 OF PRODUCTION OF ACTIVATED ACTIVE MATERIAL PRODUCTS

Active material particles containing nickel hydroxide, the electrically conductive filler, and the resin were created in the same method as in the Example 1. The active material particles were filled in the mold and heated to 100° C. to allow the resin (ethylene vinyl acetate copolymer) contained in the particles to be dissolved. The temperature was reduced under the pressure of 0.1 Mpa within the mold, to allow the resin to be cured, thereby obtaining plate-shaped secondary forming products. The secondary active material forming products were filled in the pressure container having an internal volume of 1 liter, and the pressure was reduced to 100 Pa by using the vacuum pump. The hydrogen gas was injected into the vessel having a pressure of 100 Pa by using the pressure pump to increase the pressure to 5 Mpa. The vessel was kept under the pressure of 5 Mpa for 3 hours, and thereafter, the hydrogen gas was released so that the pressure returned to atmospheric pressure. The pressure was reduced to 100 Pa by using the vacuum pump, and thereafter, air was injected so that the pressure returned to the atmospheric pressure. The resulting secondary active material forming products can exhibit the battery performance just after charge in the battery.

### EXAMPLE 7 OF PRODUCTION OF ACTIVATED ACTIVE MATERIAL PRODUCTS

Active material particles containing nickel hydroxide, the electrically conductive filler, and the resin were created in the same method as in the Example 1. The active material particles were created in such a manner that crushed nickel-plated carbon fibers having an average length of 200 μm were added to the particles produced by agitation and agitated, and the resulting mixture was further agitated for 5 minutes. Thereafter, agitation was stopped while cooling the mixture, and the particles were coated with the nickel-plated carbon fibers. 200 ml of the active material particles were filled in the pressure vessel having an internal volume of 1 liter and its pressure was reduced to 100 Pa by using the vacuum pump. Nitrogen gas was injected into the vessel having a pressure of 100 Pa by using the pressure pump to increase the pressure to 5 Mpa. The vessel was kept under the pressure of 5 Mpa for 3 hours, and thereafter, the nitrogen gas was released so that the pressure returned to atmospheric pressure. The pressure was reduced to 100 Pa by using the vacuum pump, and thereafter, air was injected so that the pressure returned to the atmospheric pressure. The resulting active material particles can exhibit desired battery performance just after charge in the battery.

### EXAMPLE 8 OF PRODUCTION OF ACTIVATED ACTIVE MATERIAL PRODUCTS

150 g of particulate graphite (acetylene black) was put into the Henschel mixer having an internal volume of 10 liters and agitated at 1000 rpm for about 3 minutes to be sufficiently dispersed. Then, 1000 g of sand (toyoura standard sand) and 100 g of carbon fibers (trade name: DONER S-247) were added to and mixed with the particulate graphite at 1000 rpm for about 3 minutes. 150 g of ethylene vinyl acetate copolymer was added to and dissolved in 1000 g of xylene heated to 60° C. Resin dissolved in heated xylene was added to the mixture of the sand and electrically conductive filler which were heated to 60° C. and agitated by the Henschel mixer while being kept at 60° C. Then, the Henschel mixer was cooled while agitating the particles, and the mixture was cooled and crushed into powder. The powder was put into the high-speed mixer and agitated by the agitator while adjusting the size of granulated particles by the chopper. The powder was agitated under the condition in which the high-speed mixer had a volume of 2 liters, the number of rotations of the agitator was 600 rpm, and the number of rotations of the chopper was 1500 rpm, and temperature of the powder was increased from room temperature to 50° C. After formation of granulated particles, agitation was stopped while cooling granulated particles. The particles containing xylene, was put into the pressure-reducing drier and heated to 50° C., to remove xylene. After formation of granulated particles, the particles were sieved with a 2.88 mm-mesh sieve and a 1 mm-mesh sieve, thereby obtaining particles of a particle diameter of 1 to 2.88 mm.

200 ml of the active material particles were filled in the pressure vessel having an internal volume of 1 liter and its pressure was reduced to 100 Pa by using the vacuum pump. Helium gas was injected into the vessel having a pressure of 100 Pa by using the pressure pump to increase the pressure to 5 Mpa. The vessel was kept under the pressure of 5 Mpa for 3 hours, and thereafter, the helium gas was released so that the pressure returned to atmospheric pressure. The pressure was reduced to 100 Pa by using the vacuum pump, and thereafter, air was injected so that the pressure returned to the atmospheric pressure. The resulting active material particles can exhibit desired battery performance just after charge in the battery.

### EXAMPLE 9 OF ACTIVATED ACTIVE MATERIAL PRODUCTS

150 g of particulate graphite (acetylene black) was put into the Henschel mixer having an internal volume of 10 liters and agitated at 1000 rpm for about 3 minutes to be sufficiently dispersed. Then, 1000 g of coal particles (fine powder coal of Daidousumi) and 100 g of carbon fibers (trade name: DONER S-247) were added to and mixed with the particulate graphite at 1000 rpm for about 3 minutes. 150 g of ethylene vinyl acetate copolymer was added to and dissolved in 1000 g of xylene heated to 60° C. Resin dissolved in the heated xylene was added to a mixture of the coal and the electrically conductive filler which were heated to 60° C. and agitated by the Henschel mixer while being kept at 60° C. Then, the Henschel mixer was cooled while agitating the mixture, and the mixture was cooled and crushed into powder. The powder was put into the high-speed mixer and agitated by the agitator while adjusting the size of granulated particles by the chopper. The powder was agitated under the condition in which the high-speed mixer had a volume of 2 liters, the number of rotations of the agitator was 600 rpm, and the number of rotations of the chopper was 1500 rpm, and temperature of the powder was increased from room temperature to 50° C. After formation of granulated particles, agitation was stopped while cooling granulated particles. The particles containing xylene, was put into the pressure-reducing drier and heated to 50° C., to remove xylene. The particles were cooled and then sieved with a 2.88 mm-mesh sieve and a 1 mm-mesh sieve, thereby obtaining particles of a particle diameter of 1 to 2.88 mm.

200 ml of the active material particles were filled in the pressure vessel having an internal volume of 1 liter and its pressure was reduced to 100 Pa by using the vacuum pump. Argon gas was injected into the vessel having a pressure of 100 Pa by using the pressure pump to increase the pressure to 5 Mpa. The vessel was kept under the pressure of 5 Mpa for 3 hours, and thereafter, the argon gas was released so that the pressure returned to atmospheric pressure. The pressure was reduced to 100 Pa by using the vacuum pump, and thereafter, air was injected so that the pressure returned to the atmospheric pressure. The resulting active material particles were taken out from the pressure vessel, thus obtaining activated battery active material products.

### EXAMPLE 10 OF PRODUCTION OF ACTIVATED ACTIVE MATERIAL PRODUCTS

150 g of particulate graphite (acetylene black) was put into the Henschel mixer having an internal volume of 10 liters and agitated at 1000 rpm for about 3 minutes to be sufficiently dispersed. Then, 500 g of charcoal (obtained by calcining wood at 600° C. for 2 hours) and 100 g of carbon fibers (trade name: DONER S-247) were added to and mixed with the particulate graphite at 1000 rpm for about 3 minutes. 150 g of ethylene vinyl acetate copolymer was added to and dissolved in 1000 g of xylene heated to 60° C. The resin dissolved in the heated xylene was added to the mixture of the charcoal and the electrically conductive filler which were heated to 60° C. and agitated by the Henschel mixer while being kept at 60° C. Then, the Henschel mixer was cooled while agitating the mixture, and the mixture was cooled and crushed into powder. The powder was put into the high-speed mixer and agitated by the agitator while adjusting the size of the granulated particles by the chopper. The powder was agitated under the condition in which the high-speed mixer had a volume of 2 liters, the number of rotations of the agitator was 600 rpm, and the number of rotations of the chopper was 1500 rpm, and temperature of the powder was increased from room temperature to 50° C. After formation of the granulated particles, agitation was stopped while cooling the granulated particles. The particles containing xylene, was put into a pressure-reducing drier and heated to 50° C., to remove xylene. The particles were cooled and then sieved with a 2.88 mm-mesh sieve and a 1 mm-mesh sieve, thereby obtaining particles of a particle diameter of 1 to 2.88 mm.

200 ml of the active material particles were filled in the pressure vessel having an internal volume of 1 liter and its pressure was reduced to 100 Pa by using the vacuum pump. Oxygen was injected into the vessel having a pressure of 100 Pa by using the pressure pump to increase the pressure to 5 Mpa. The vessel was kept under the pressure of 5 Mpa for 3 hours, and thereafter, oxygen was released so that the pressure returned to atmospheric pressure. The pressure was reduced to 100 Pa by using the vacuum pump, and thereafter, air was injected so that the pressure returned to the atmospheric pressure. The resulting active material particles were taken out from the pressure vessel, thus obtaining activated battery active material products.

### EXAMPLE 11 OF PRODUCTION OF ACTIVATED ACTIVE MATERIAL PRODUCTS

150 g of particulate graphite (acetylene black) was put into the Henschel mixer having an internal volume of 10 liters and agitated at 1000 rpm for about 3 minutes to be sufficiently dispersed. Then, 500 g of silica (obtained by calcining chaff at 600° C. for 2 hours) and 100 g of carbon fibers (trade name: DONER S-247) were added to and mixed with the particulate graphite at 1000 rpm for about 3 minutes. 150 g of ethylene vinyl acetate copolymer was added to and dissolved in 1000 g of xylene heated to 60° C. The resin dissolved in the heated xylene was added to the mixture of the silica and the electrically conductive filler which were heated to 60° C. and agitated by the Henschel mixer while being kept at 60° C. Then, the Henschel mixer was cooled while agitating the mixture, and the mixture was cooled and crushed into powder. The powder was put into the high-speed mixer and agitated by the agitator while adjusting the size of the granulated particles by the chopper. The powder was agitated under the condition in which the high-speed mixer had a volume of 2 liters, the number of rotations of the agitator was 600 rpm, and the number of rotations of the chopper was 1500 rpm, and temperature of the powder was increased from room temperature to 50° C. After formation of the granulated particles, agitation was stopped while cooling the granulated particles. The particles containing xylene, was put into the pressure-reducing drier and heated to 50° C., to remove xylene. The particles were cooled and then sieved with a 2.88 mm-mesh sieve and a 1 mm-mesh sieve, thereby obtaining particles of a particle diameter of 1 to 2.88 mm.

200 ml of the active material particles were filled in the pressure vessel having an internal volume of 1 liter and its pressure was reduced to 100 Pa by using the vacuum pump. Ozone gas was injected into the vessel having a pressure of 100 Pa by using the pressure pump to increase the pressure to 5 Mpa. The vessel was kept under the pressure of 5 Mpa for 3 hours, and thereafter, the ozone gas was released so that the pressure returned to atmospheric pressure. The pressure was reduced to 100 Pa by using the vacuum pump, and thereafter, air was injected so that the pressure returned to the atmospheric pressure. The resulting active material particles were taken out from the pressure vessel, thus obtaining activated battery active material products.

### EXAMPLE 12 OF ACTIVATED ACTIVE MATERIAL PRODUCTS

150 g of particulate graphite (acetylene black) was put into the Henschel mixer having an internal volume of 10 liters and agitated at 1000 rpm for about 3 minutes to be sufficiently dispersed. Then, 1000 g of slag (obtained by melting ash of burned garbage at 1500° C. and then by cooling the ash) and 100 g of carbon fibers (trade name: DONER S-247) were added to and mixed with the particulate graphite. 150 g of ethylene vinyl acetate copolymer was added to and dissolved in 1000 g of xylene heated to 60° C. The resin dissolved in the heated xylene was added to the mixture of the slag and the electrically conductive filler which were heated at 60° C. and agitated by the Henschel mixer while being kept at 60° C. Then, the Henschel mixer was cooled while agitating the mixture, and the mixture was cooled and crushed into powder. The powder was put into the high-speed mixer and agitated by the agitator while adjusting the size of the granulated particles by the chopper. The powder was agitated under the condition in which the high-speed mixer had a volume of 2 liters, the number of rotations of the agitator was 600 rpm, and the number of rotations of the chopper was 1500 rpm, and temperature of the powder was increased from room temperature to 50° C. After formation of the granulated particles, agitation was stopped while cooling the granulated particles. The particles containing xylene, was put into a pressure-reducing drier and heated to 50° C., to remove xylene. The particles were cooled and then sieved with a 2.88 mm-mesh sieve and a 1 mm-mesh sieve, thereby obtaining particles of a particle diameter of 1 to 2.88 mm.

200 ml of the active material particles were filled in the pressure vessel having an internal volume of 1 liter and its pressure was reduced to 100 Pa by using the vacuum pump. Nitrogen monoxide gas was injected into the vessel having a pressure of 100 Pa by using the pressure pump to increase the pressure to 5 Mpa. The vessel was kept under the pressure of 5 Mpa for 3 hours, and thereafter, the nitrogen monoxide gas was released so that the pressure returned to atmospheric pressure. Further, the pressure was reduced to 100 Pa by using the vacuum pump, and thereafter, air was injected so that the pressure returned to the atmospheric pressure. The resulting active material particles were taken out from the pressure vessel, thus obtaining activated battery active material products.

### EXAMPLE 13 OF PRODUCTION OF ACTIVATED ACTIVE MATERIAL PRODUCTS

150 g of particulate graphite (acetylene black) was put into the Henschel mixer having an internal volume of 10 liters and agitated at 1000 rpm for about 3 minutes to be sufficiently dispersed. Then, 500 g of carbon (obtained by calcining carbon fibers at 1100° C.) was added to and mixed with the particulate graphite at 1000 rpm for about 3 minutes. 150 g of ethylene vinyl acetate copolymer was added to and dissolved in 1000 g of xylene heated at 60° C. The resin dissolved in the heated xylene was added to the mixture of the carbon and the electrically conductive filler which were heated to 60° C. and agitated by the Henschel mixer while being kept to 60° C. Then, the Henschel mixer was cooled while agitating the mixture, and the mixture was cooled and crushed into powder. The powder was put into the high-speed mixer and agitated by the agitator while adjusting the size of the granulated particles by the chopper. The powder was agitated under the condition in which the high-speed mixer had a volume of 2 liters, the number of rotations of the agitator was 600 rpm, and the number of rotations of the chopper was 1500 rpm, and temperature of the powder was increased from room temperature to 50° C. After formation of the granulated particles, agitation was stopped while cooling the particles. The particles containing xylene, was put into the pressure-reducing drier and heated to 50° C., to remove xylene. The particles were cooled and then sieved with a 2.88 mm-mesh sieve and a 1 mm-mesh sieve, thereby obtaining particles of a particle diameter of 1 to 2.88 mm.

200 ml of the active material particles were filled in the pressure vessel having an internal volume of 1 liter and its pressure was reduced to 100 Pa by using the vacuum pump. Nitrogen dioxide gas was injected into the vessel having a pressure of 100 Pa by using the pressure pump to increase the pressure to 5 Mpa. The vessel was kept under the pressure of 5 Mpa for 3 hours, and thereafter, the nitrogen dioxide gas was released so that the pressure returned to atmospheric pressure. The pressure was reduced to 100 Pa by using the vacuum pump, and thereafter, air was injected so that the pressure returned to the atmospheric pressure. The resulting active material particles were taken out from the pressure vessel, thus obtaining activated battery active material products.

[Industrial Applicability]

The present invention described above is suitable for use as the active material products for battery of the chargeable and dischargeable three-dimensional battery obtained by filling particulate, plate-shaped or bar-shaped active material products.

1. Active material products for a battery, for use in a three-dimensional battery comprising two vessels connected to each other with a member interposed therebetween, and electrically conductive current collectors provided within the two vessels in contact with active material particles or active material forming products contained in electrolytic solutions filled in the two vessels, the member being configured to permit passage of ions and not to permit passage of electrons, and the active material particles or the active material forming products filled in the electrolytic solution in one of the two vessels being adapted to discharge electrons and the active material particles or the active material forming products filled in the electrolytic solution in the other vessel being adapted to absorb the electrons,
the active material products being produced by adding electrically conductive filler to an active material powder and by forming and curing the active material powder in a shape of particle, plate or bar by using resin:

2. The active material products for a battery according to claim 1, wherein the active material powder is nickel hydroxide powder.

3. The active material products for a battery according to claim 2, wherein the nickel hydroxide powder comprises nickel hydroxide as a major component and at least one of cobalt hydroxide and carbon particles.

4. The active material products for a battery according to claim 1, wherein the active material powder is obtained from a material selected from the group consisting of hydrogen-occluding alloy, cadmium hydroxide, lead, lead dioxide, lithium, wood, graphite, carbon, iron ore, coal, charcoal, sand, gravel, silica, slag, and chaff.

5. The active material products for a battery according to claim 1, wherein the electrically conductive filler is selected from carbon fibers, nickel-plated carbon fibers, nickel-plated organic fibers, carbon particles, nickel-plated carbon particles, fibrous nickel, nickel particles nickel foil, or any combination thereof.

6. The active material products for battery according to claim 1, wherein the resin is a thermoplastic resin selected from a resin having a softening temperature of 120° C. or lower, a resin having a curing temperature ranging from room temperature to 120° C., a resin soluble in a solvent having a vaporizing temperature of 120° C. or lower, a resin soluble in a water-soluble solvent, or a resin soluble in an alcohol-soluble solvent.

7. The active material products for a battery according to claim 6, wherein the thermoplastic resin having a softening temperature of 120° C. or lower and the resin soluble in the solvent having a vaporizing temperature of 120° C. or lower are at least one selected from polyethylene, polypropylene, or an ethylene vinyl acetate copolymer.

8. The active material products for battery according to claim 6, wherein the resin having a curing temperature ranging room temperature to 120° C. is at least one selected from an epoxy resin, phenol resin, polyurethane, or an unsaturated polyester.

9. The active material products for battery according to claim 6, wherein the resin soluble in the water-soluble solvent is a polyether sulfone resin, polystyrene, polysulfone, polyvinylidene fluoride, polyamide, or polyimide, and the resin soluble in the alcohol-soluble solvent is acetylcellulose or oxide phenylene ether.

10. The active material products for battery according to claim 1, wherein a coating layer comprising at least one of a nickel-plated layer, carbon fibers, nickel-plated carbon fibers, carbon particles, nickel-plated carbon particles, fibrous nickel, nickel particles, or nickel foil is formed on surfaces of cured active material products for the battery.

11. A method of producing active material products for battery for use in a three-dimensional battery comprising two vessels connected to each other with a member interposed therebetween, and electrically conductive current collectors provided within the two vessels in contact with active material particles or active material forming products contained in electrolytic solutions filled in the two vessels, the member being configured to permit passage of ions and not to permit passage of electrons, and the active material particles or the active material forming products filled in the electrolytic solution in one of the two vessels being adapted to discharge electrons and the active material particles or the active material forming products filled in the electrolytic solution in the other vessel being adapted to absorb the electrons, the method comprising:
adding an electrically conductive filler and a resin to an active material powder, and
forming and curing the active material powder in a shape of particle, plate or bar to obtain particulate, plate-shaped or bar-shaped active material products.

12. The method of producing active material products for a battery according to claim 11, wherein the active material powder is obtained from nickel hydroxide powder.

13. The method of producing active material products for a battery according to claim 12, wherein the nickel hydroxide powder is obtained from a precipitate of nickel hydroxide and cobalt hydroxide obtained by alkali neutralizing a mixed solution containing a nickel salt and a cobalt salt.

14. The method of producing active material products for a battery according to claim 12, wherein the nickel hydroxide powder is obtained from a mixture comprising a precipitate of nickel hydroxide and carbon particles which is obtained by neutralizing a nickel salt solution with carbon particles suspended therein by an alkali.

15. The method of producing active material products for battery according to claim 12, wherein the nickel hydroxide powder is obtained from a mixture of nickel hydroxide and cobalt hydroxide and carbon particles which are precipitated by neutralizing a mixed solution containing a nickel salt and a cobalt salt with carbon particles suspended therein by an alkali.

16. The method of producing active material products for a battery according to claim 11, wherein the active material powder is a material selected from the group consisting of a hydrogen-occluding alloy, cadmium hydroxide, lead, lead dioxide, lithium, wood, graphite, carbon, iron ore, coal, charcoal, sand, gravel, silica, slag, and chaff.

17. The method of producing active material products for a battery according to claim 11, further comprising:
after adding a water-soluble compound in addition to the electrically conductive filler and the resin to the active material powder,
forming and curing the active material products, dissolving the water-soluble compound in water, and extracting and removing the water-soluble compound, thereby forming pores in the active material forming products.

18. The method of producing active material products for a battery according to claim 11, further comprising:
adding particles of a compound, which is converted into an electrolyte in the battery, in addition to adding the electrically conductive filler and the resin to the active material powder;
forming and curing the active material; and
forming pores in the active material forming products by the dissolution of the electrolyte contained in the electrolytic solution or water when the active material products are used for the battery.

19. The method of producing active material products for a battery according to claim 11, wherein the electrically conductive filler is a material selected from the group consisting of carbon fibers, nickel-plated carbon fibers, carbon particles, nickel-plated carbon particles, nickel-plated organic fibers, fibrous nickel, nickel particles, nickel foil, and any combination thereof.

20. The method of producing active material products for a battery according to claim 11, wherein the resin is a thermoplastic resin having a softening temperature of 120° C. or lower, or a resin having a curing temperature ranging from room temperature to 120° C.

21. The method of producing active material products for a battery according to claim 20, wherein the thermoplastic resin is at least one selected from the group consisting of polyethylene, polypropylene, and an ethylene vinyl acetate copolymer.

22. The method of producing active material products according to claim 20, wherein after mixing the active material powder and the electrically conductive filler with the thermoplastic resin dissolved in a solvent and dispersing a mixture of the active material powder, the electrically conductive filler, and the thermoplastic resin, the solvent is vaporized, and the active material products are formed to obtain particulate, plate-shaped or bar-shaped active material products.

23. The method of producing active material products for battery according to claim 20, wherein, the resin having a curing temperature ranging from the room temperature to 120° C. is at least one selected from the group consisting of an epoxy resin, phenol resin, polyurethane, and an unsaturated polyester.

24. The method of producing active material products for a battery according to claim 11, wherein the resin is selected from a resin dissolved in a solvent having a vaporizing temperature of 120° C. or lower, a resin dissolved in the water-soluble solvent, or a resin dissolved in the alcohol-soluble solvent.

25. The method of producing active material products for a battery according to claim 24, wherein the resin dissolved in the solvent having a vaporizing temperature of 120° C. or lower is at least one selected from polyethylene, polypropylene or an ethylene vinyl acetate copolymer dissolved in heated toluene or heated xylene.

26. The method of producing active material products for a battery according to claim 24, wherein the resin is a resin dissolved in a solvent having a vaporizing temperature of 120° C. or lower, and the solvent is removed from particles of the formed active material products by heating the solvent under a reduced pressure or an ambient pressure.

27. The method of producing active material products for a battery according to claim 24, wherein the resin dissolved in the water-soluble solvent is at least one selected from the group consisting of a polyether sulfone resin dissolved in dimethyl sulfoxide, polystyrene dissolved in acetone, polysulfone dissolved in dimethyl formamide or dimethyl sulfoxide, polyacrylonitrile dissolved in dimethyl formamide, dimethyl sulfoxide or ethylene carbonate, polyvinylidene fluoride dissolved in dimethyl formamide, dimethyl sulfoxide or N-methyl-2-pyrrolidone, polyamide dissolved in dimethyl formamide or N-methyl-2-pyrrolidone, and polyimide dissolved in dimethyl formamide or N-methyl-2-pyrrolidone; and the resin dissolved in the alcohol-soluble solvent is selected from acetylcellulose dissolved in methylene chloride or oxide phenylene ether dissolved in methylene chloride.

28. The method of producing active material products for a battery according to claim 24, wherein the resin is a resin dissolved in the water-soluble solvent or the resin dissolved in the alcohol-soluble solvent, and the solvent is extracted and removed from cured active material products by contact with a water or alcohol extractant.

29. The method of producing active material products for a battery according to claim 22, wherein the resin dissolved in the solvent is added to the active material powder and the electrically conductive filler, and a mixture of the active material powder, the electrically conductive filler, and the resin is granulated under agitation prior to forming into active material particles.

30. The method of producing active material products for a battery according to claim 11, wherein the particulate active material products are formed into tablets and cured.

31. The method of producing active material products for a battery according to claim 11, wherein the particulate, plate-shaped, or bar-shaped active material products are formed and cured by pressurized forming.

32. The method of producing active material products for a battery according to claim 11, wherein the particulate, plate-shaped, or bar-shaped active material products are formed and cured by extrusion molding.

33. The method of producing active material products for a battery according to claim 30, wherein the particulate active material products are formed by crushing the formed active material products.

34. The method of producing active material products for a battery according to claim 30, including the step of rounding active material particles which are angular in shape to provide smooth surfaces.

35. The method of producing active material products for a battery according to claim 11, wherein nickel-plating is applied to surfaces of the cured active material products.

36. The method of producing active material products for a battery according to claim 11 including the step of coating surfaces of the cured active material products with a material selected from the group consisting of carbon fibers, nickel-plated carbon fibers, carbon particles, nickel-plated carbon particles, nickel-plated organic fibers, fibrous nickel, nickel particles, and nickel foil,

37. The method of producing active material products for a battery according to claim 36, wherein surfaces of the cured active material products are coated in such a manner that, after expanding and softening surfaces of the particles by using the solvent, the coating material is added to the particles.

38. The method of producing active material products for a battery according to claim 36, wherein surfaces of the active material particles are coated in such a manner that, after adding the resin dissolved in the solvent to the active material powder and the electrically conductive filler, and granulating under agitation and mixing a mixture of the active material powder, the electrically conductive filler and the resin to form particles, the coating material is added to the particles, and agitated.

39. Active material forming products for a battery for use in a three-dimensional battery comprising two vessels connected to each other with a member interposed therebetween, and electrically conductive current collectors provided within the two vessels in contact with the active material forming products contained in electrolytic solutions filled in the two vessels, the member being configured to permit passage of ions and not to permit passage of electrons, and the active material forming products filled in the electrolytic solution in one of the two vessels being adapted to discharge electrons and the active material forming products filled in the electrolytic solution in the other vessel being adapted to absorb the electrons,
the active material forming products being secondary forming products obtained by secondarily forming primary forming products produced by adding electrically conductive filler to an active material powder and curing a mixture of the active material powder and the electrically conductive filler by using resin.

40. The active material forming products for a battery according to claim 39, wherein the active material powder is material selected from the group consisting of nickel hydroxide, hydrogen-occluding alloy, cadmium hydroxide, lead, lead dioxide, lithium, wood, graphite, carbon, iron ore, coal, charcoal, sand, gravel, silica, slag, and chaff.

41. The active material forming products for a battery according to claim 39, wherein the electrically conductive filler is selected from the group consisting of carbon fibers, nickel-plated carbon fibers, nickel-plated organic fibers, carbon particles, nickel-plated carbon particles, fibrous nickel, nickel particles, nickel foil, and any combination thereof.

42. The active material forming products for a battery according to claim 39, wherein the resin is a thermoplastic resin selected from a resin having a softening temperature of 120° C. or lower, a resin having a curing temperature ranging from room temperature to 120° C., a resin soluble in a solvent having a vaporizing temperature of 120° C. or lower, a resin soluble in a water-soluble solvent, or a resin soluble in an alcohol-soluble solvent.

43. The active material forming products for a battery according to claim 42, wherein the thermoplastic resin used for the primary forming products is at least any one selected from the group consisting of polyethylene, polypropylene, and an ethylene vinyl acetate copolymer, and the thermoplastic resin used for the secondary forming products is at least one selected from the group consisting of polyvinyl alcohol, polyethylene, polypropylene, and an ethylene vinyl acetate copolymer.

44. The active material forming products for a battery according to claim 42, wherein, the resin having a curing temperature ranging from room temperature to 120° C. is at least one selected from the group consisting of an epoxy resin, a phenol resin, a polyurethane resin, and an unsaturated polyester resin.

45. The active material forming products for a battery according to claim 42, wherein the resin soluble in the solvent having a vaporizing temperature of 120° C. or lower is at least one selected from the group consisting of polyethylene, polypropylene, and an ethylene vinyl acetate copolymer.

46. The active material forming products for a battery according to claim 42, wherein the resin dissolved in the water-soluble solvent is a polyether sulfone resin, polystyrene, polysulfone, polyacrylonitrile, polyvinylidene fluoride, polyamide, or polyimide, and the resin soluble in the alcohol-soluble solvent is acetylcellulose or oxide phenylene ether.

47. The active material forming products for a battery according to claim 39, wherein the primary forming products have a shape of at least one selected from the group consisting of particle, plate, scale, cylindrical rod, polygonal cylindrical rod, sphere, dice, cube, and amorphous particle.

48. The active material forming products for a battery according to claim 39, wherein a coating layer comprising at least one selected from the group consisting of a nickel-plated layer, carbon fibers, nickel-plated carbon fibers, nickel-plated organic fibers, carbon powder, nickel-plated carbon powder, fibrous nickel, nickel powder, and nickel foil, is formed on surfaces of the primary forming products.

49. The active material forming products for a battery according to claim 39, wherein the secondary forming products have a shape of any one selected from cube, cylinder, block, or polygonal cylinder.

50. The active material forming products for a battery according to claim 39, wherein the primary forming products forming secondary forming products are spaced apart from one another.

51. The active material forming products for a battery according to claim 39, wherein the primary forming products forming secondary forming products are closely filled so as to be in contact with one another

52. The active material forming products for a battery according to claim 39, wherein the secondary forming products are provided with grooves or concave and convex portions on surfaces thereof.

53. A method of producing active material forming products for a battery for use in a three-dimensional battery comprising two vessels connected to each other with a member interposed therebetween, and electrically conductive current collectors provided within the two vessels in contact with the active material forming products contained in electrolytic solutions filled in the two vessels, the member being configured to permit passage of ions and not to permit passage of electrons, and the active material forming products filled in the electrolytic solution in one of the two vessels being adapted to discharge electrons or the active material forming products filled in the electrolytic solution in the other vessel being adapted to absorb the electrons,
the method comprising:
adding an electrically conductive filler and a resin to an active material powder;
forming and curing a mixture of the electrically conductive filler, the resin and the active material powder to obtain primary forming products; and
secondarily forming the primary forming products by pressurization and/or addition of resin, thereby obtaining electrically conductive active material forming products.

54. The method of producing active material forming products for a battery according to claim 53, wherein the primary forming products have a shape of at least one selected from the group consisting of particle, plate, scale, cylindrical rod, polygonal cylindrical rod, sphere, dice, cube, and amorphous particle.

55. The method of producing active material forming products for a battery according to claim 53, wherein the primary forming products are secondarily formed after coating surfaces of the primary forming products with at least one material selected from the group consisting of carbon fibers, nickel-plated carbon fibers, nickel-plated organic fibers, carbon powder, nickel-plated carbon powder, fibrous nickel, nickel powders and nickel foil.

56. The method of producing active material forming products for a battery according to claim 53, wherein the primary forming products are secondarily formed after applying nickel-plating to surfaces thereof.

57. The method of producing active material forming products for a battery according to claim 53, wherein the secondary forming products have a shape selected from the group consisting of cube, cylinder, block, and polygonal cylinder.

58. The method of producing active material forming products for a battery according to claim 53, wherein the secondary forming products are formed such that the primary forming products are spaced from one another.

59. The method of producing active material forming products for a battery according to claim 53, wherein the primary forming products are filled in a mold provided with grooves or concave and convex portions to allow the secondary forming products to have groove-shaped or concave and convex surfaces.

60. The method of producing active material forming products for a battery according to claim 53, wherein the secondary forming products are formed after adding a water-soluble compound to the primary forming products, and then, after dissolving the water-soluble compound in water, the water-soluble compound is extracted and removed, thereby forming pores in the active material forming products.

61. The method of producing active material forming products for a battery according to claim 53, further comprising:
secondarily forming the primary forming products by adding particles of a compound to be converted into an electrolyte in the battery to the primary forming products; and
forming pores in the active material forming products by the dissolution of the electrolyte dissolved in an electrolytic solution or water when the active material products are used for the battery.

62. The method of producing active material forming products for a battery according to claim 53, wherein the electrically conductive filler used in secondary formation is selected from the group consisting of carbon fibers, nickel-plated carbon fibers, carbon particles, nickel-plated carbon particles, nickel-plated organic fibers, fibrous nickel, nickel particles, nickel foil, and a combination thereof.

63. The method of producing active material forming products for a battery according to claim 53, wherein the resin added in secondary formation is a thermoplastic resin having a softening temperature of 120° C. or lower, or a resin having a curing temperature ranging from room temperature to 120° C.

64. The method of producing active material forming products for a battery according to claim 63, wherein the thermoplastic resin used in secondary formation is at least one selected from the group consisting of polyvinyl alcohol, polyethylene, polypropylene, and an ethylene vinyl acetate copolymer.

65. The method of producing active material forming products for a battery according to claim 63, wherein the resin having a curing temperature ranging room temperature to 120° C. is at least one selected from the group consisting of epoxy resin, phenol resin, polyurethane, and an unsaturated polyester.

66. The method of producing active material forming products for a battery according to claim 53, wherein the resin added in secondary formation is selected from the group consisting of a resin dissolved in a solvent having a vaporizing temperature of 120° C. or lower, a resin dissolved in a water-soluble solvent, or a resin dissolved in an alcohol-soluble solvent.

67. The method of producing active material forming products for a battery according to claim 66, wherein the resin dissolved in the solvent having a vaporizing temperature of 120° C. or lower is at least one selected-from the group consisting of polyethylene, polypropylene and an ethylene vinyl acetate copolymer dissolved in heated toluene or heated xylene.

68. The method of producing active material forming products for a battery according to claim 66, wherein the resin dissolved in the water-soluble solvent is at least one selected from the group consisting of polyether sulfone resin dissolved in dimethyl sulfoxide, polystyrene dissolved in acetone, polysulfone dissolved in dimethyl formamide or dimethyl sulfoxide, polyacrylonitrile dissolved in dimethyl formamide, dimethyl sulfoxide or ethylene carbonate, polyvinylidene fluoride dissolved in dimethyl formamide, dimethyl sulfoxide or N-methyl-2-pyrrolidone, polyamide dissolved in dimethyl formamide or N-methyl-2-pyrrolidone, and polyimide dissolved in dimethyl formamide or N-methyl-2-pyrrolidone; and the resin dissolved in the alcohol-soluble solvent is selected from acetylcellulose dissolved in methylene chloride or oxide phenylene ether dissolved in methylene chloride.

69. The method of producing active material forming products for a battery according to claim 53, wherein the secondary forming products are formed while maintaining a shape of the primary forming products.

70. The method of producing active material forming products for a battery according to claim 53, wherein the secondary forming products are formed by filling the primary forming products in a mold and applying a pressure to the primary forming products to allow a bulk density of the secondary forming products to increase higher that a bulk density of the primary forming products.

71. The method of producing active material forming products for a battery according to claim 66, wherein after mixing and dispersing the resin dissolved in the solvent and the electrically conductive filler, a mixture of the resin and the electrically conductive filler is converted into powder by vaporizing the solvent, and the primary forming products are added to the powder to obtain the secondary forming products.

72. Active material products for a battery with improved hydrophilicity, for use in a three-dimensional battery comprising two vessels connected to each other with a member interposed therebetween, and electrically conductive current collectors provided within the vessels in contact with the active material products contained in electrolytic solutions filled in the two vessels, the member being configured to permit passage of ions and not to permit passage of electrons, and the active material particles or the active material forming products filled in the electrolytic solution in one of the two vessels being adapted to discharge electrons and the active material particles or the active material forming products filled in the electrolytic solution in the other vessel being adapted to absorb the electrons,
the active material products being produced by adding or applying a material selected from the group consisting of an inorganic oxides, an inorganic hydroxide, and a combination thereof to the active material forming products that are cured by a resin after adding an electrically conductive filler to an active material powder.

73. The active material products for a battery with improved hydrophilicity according to claim 72, wherein the active material powder is selected from the group consisting of nickel hydroxide, hydrogen-occluding alloy, cadmium hydroxide, lead, lead dioxide, lithium, wood, graphite, carbon, iron ore, coal, charcoal, gravel, sand, silica, slag, and chaff.

74. The active material products for a battery with improved hydrophilicity according to claim 72, wherein the electrically conductive filler is selected from the group consisting of carbon fibers, nickel-plated carbon fibers, nickel-plated organic fibers, carbon particles, nickel-plated carbon particles, fibrous nickel, nickel particles, nickel foil, and a combination thereof.

75. The active material products for a battery with improved hydrophilicity according to claim 72, wherein the resin is a thermoplastic resin having a softening temperature of 120° C. or lower, a resin having a curing temperature ranging from room temperature to 120° C., a resin soluble in a solvent having a vaporizing temperature of 120° C. or lower, a resin soluble in a water-soluble solvent, or a resin soluble in an alcohol-soluble solvent.

76. The active material products for a battery with improved hydrophilicity according to claim 75, wherein the thermoplastic resin is at least one selected from the group consisting of polyethylene, polypropylene, and an ethylene vinyl acetate copolymer.

77. The active material products for a battery with improved hydrophilicity according to claim 75, wherein the resin having a curing temperature ranging from room temperature to 120° C. is at least one selected from the group consisting of an epoxy resin, phenol resin, polyurethane resin, and an unsaturated polyester resin.

78. The active material products for a battery with improved hydrophilicity according to claim 75, wherein the resin soluble in the solvent having a vaporizing temperature of 120° C. or lower is at least one selected from the group consisting of polyethylene, polypropylene, and an ethylene vinyl acetate copolymer.

79. The active material products for a battery with improved hydrophilicity according to claim 75, wherein the resin soluble in the water-soluble solvent is a polyether sulfone resin, polystyrene, polysulfone, polyacrylonitrile, polyvinylidene fluoride, polyamide, or a polyimide, and the resin soluble in the alcohol-soluble solvent is acetylcellulose or oxide phenylene ether.

80. The active material products for a battery with improved hydrophilicity according to claim 72, wherein the active material forming products are pressurized-forming products or resin forming products having at least one shape selected from the group consisting of particle, plate, scale, cylindrical rod, polygonal cylindrical rod, sphere, dice, cube, amorphous particle, secondary pressurized-forming products, and secondary resin forming products.

81. The active material products for a battery with improved hydrophilicity according to claim 72, wherein a coating layer comprising at least one material selected from the group consisting of a nickel-plated layer, carbon fibers, nickel-plated carbon fibers, nickel-plated organic fibers, carbon particles, nickel-plated carbon particles, fibrous nickel, nickel particles and nickel foil is formed on surfaces of active material forming products.

82. The active material products for a battery with improved hydrophilicity according to claim 72, wherein the inorganic oxide is a metal oxide selected from the group consisting of titanium dioxide, silicon dioxide, calcium oxide, calcium carbonate, and a material containing a metal oxide as a major component.

83. The active material products for a battery with improved hydrophilicity according to claim 72, wherein the inorganic hydroxide is calcium hydroxide or a material containing calcium hydroxide as a major component.

84. The active material products for a battery with improved hydrophilicity according to claim 72, wherein at least one of the inorganic oxide and the inorganic hydroxide is added or applied to surfaces of the active material forming products.

85. The active material products for a battery with improved hydrophilicity according to claim 72, wherein at least one of the inorganic oxide and the inorganic hydroxide is added to an interior of the active material forming products.

86. A method of producing hydrophilic active material products for a battery, for use in a three-dimensional battery comprising two vessels connected to each other with a member interposed therebetween, and electrically conductive current collectors provided within the two vessels in contact with the active material products contained in electrolytic solutions filled in the two vessels, the member being configured to permit passage of ions and not to permit passage of electrons, and the active material particles or the active material forming products filled in the electrolytic solution in one of the two vessels being adapted to discharge electrons and the active material particles or the active material forming products filled in the electrolytic solution in the other vessel being adapted to absorb the electrons, the method comprising:
adding an electrically conductive filler and a resin to an active material powder;
forming and curing the active material powder to obtain active material forming products; and
applying or adding at least one of an inorganic oxide and an inorganic hydroxide to surfaces of the active material forming products.

87. The method of producing hydrophilic active material products for a battery according to claim 86, wherein after suspending at least one of the inorganic oxide and the inorganic hydroxide in a solvent, and immersing the active material forming products in the solvent with at least one of the inorganic oxide and the inorganic hydroxide dispersed therein to allow at least one of the inorganic oxide and the inorganic hydroxide to be applied to the surfaces of the active material forming products, the active material forming products are dried.

88. The method of producing hydrophilic active material products according to claim 87, wherein the active material forming products are dried by heating, vacuum drying, or pressure-reduced drying.

89. The method of producing hydrophilic active material products according to claim 86, wherein the active material forming products are kept in contact with at least one of the inorganic oxide and the inorganic hydroxide to allow at least one of the inorganic oxide and the inorganic hydroxide to be applied or added to surfaces of the active material forming products.

90. A method of producing hydrophilic active material products for a battery, for use in a three-dimensional battery comprising two vessels connected to each other with a member interposed therebetween, and electrically conductive current collectors provided within the two vessels in contact with the active material products contained in electrolytic solutions filled in the two vessels, the member being configured to permit passage of ions but and not to permit passage of electrons, and the active material particles or the active material forming products filled in the electrolytic solution in one of the two vessels being adapted to discharge electrons and the active material particles or the active material forming products filled in the electrolytic solution in the other vessel being adapted to absorb the electrons, the method comprising:
adding at least one of an electrically conductive filler, a resin, and at least one of an inorganic oxide and an inorganic hydroxide to an active material powder;
forming and curing the active material powder to obtain active material forming products; and
adding at least one of the inorganic oxide and the inorganic hydroxide to an interior of the active material forming products.

91. The method of producing hydrophilic active material products according to claim 86, wherein the active material forming products are pressurized-forming products or resin forming products having at least one shape selected from the group consisting of particle, plate, scale, cylindrical rod, polygonal cylindrical rod, sphere, dice, cube, amorphous particle, secondary pressurized-forming products, and secondary resin forming products.

92. The method of producing hydrophilic active material products according to claim 86, wherein a material is applied to or coated onto surfaces of the active material forming products, said material selected from the group consisting of nickel plating, carbon fibers, nickel-plated carbon fibers, nickel-plated organic fibers, carbon particles, nickel-plated carbon particles, fibrous nickel, nickel particles, and nickel foil.

93. The method of producing hydrophilic active material products according to claim 86, wherein the inorganic oxide is metal oxide selected from the group consisting of titanium dioxide, silicon dioxide, calcium oxide, calcium carbonate, and a material containing a metal oxide as a major component.

94. The method of producing hydrophilic active material products according to claim 86, wherein the inorganic hydroxide is calcium hydroxide or a material containing calcium hydroxide as a major component.

95. The method of producing hydrophilic active material products according to claim 87, wherein the solvent in which at least one of the inorganic oxide and the inorganic hydroxide is dispersed is water or an organic solvent selected from toluene, xylene, or isopropyl alcohol.

96. Activated active material products for a battery, for use in a three-dimensional battery comprising two vessels connected to each other with a member interposed therebetween, and electrically conductive current collectors provided within the two vessels in contact with the active material products contained in electrolytic solutions filled in the two vessels, the member being configured to permit passage of ions and not to permit passage of electrons, and the active material particles or the active material forming products filled in the electrolytic solution in one of the two vessels being adapted to discharge electrons and the active material particles or the active material forming products filled in the electrolytic solution in the other vessel being adapted to absorb the electrons,
wherein the activated active material products are produced by adding an electrically conductive filler to an active material powder and curing a mixture of the active material powder and the electrically conductive filler by using a resin to obtain active material forming products, and
the active material forming products are pressure-reduced and then hydrogen is applied for pressurization to the active material forming products to form pores therein, thereby increasing an activity of the active material.

97. The activated active material products for a battery according to claim 96, wherein the active material powder is selected from the group consisting of nickel hydroxide, hydrogen-occluding alloy, cadmium hydroxide, lead, lead dioxide, lithium, wood, graphite, carbon, iron ore, iron carbide, iron sulfide, iron hydroxide, iron oxide, coal, charcoal, sand, gravel, silica, slag, and chaff.

98. The activated active material products for a battery according to claim 96, wherein the electrically conductive filler is selected from the group consisting of carbon fibers, nickel-plated carbon fibers, nickel-plated organic fibers, nickel-plated inorganic fibers of silica or alumina, nickel-plated inorganic foil of mica, carbon particles, nickel-plated carbon particles, fibrous nickel, nickel particles, nickel foil, and a combination thereof.

99. The activated active material products for a battery according to claim 96, wherein the resin is a thermoplastic resin having a softening temperature of 120° C. or lower, a resin having a curing temperature ranging from room temperature to 120° C., a resin soluble in a solvent having a vaporizing temperature of 120° C. or lower, a resin soluble in a water-soluble solvent, or a resin soluble in an alcohol-soluble solvent.

100. The activated active material products for a battery according to claim 99, wherein the thermoplastic resin is at least one selected from the group consisting of polyethylene, polypropylene, and an ethylene vinyl acetate copolymer.

101. The activated active material products for a battery according to claim 99, wherein the resin having a curing temperature ranging room temperature to 120° C. is at least one selected from the group consisting of epoxy resin, phenol resin, urethane resin, and an unsaturated polyester.

102. The activated active material products for a battery according to claim 99, wherein the resin soluble in the solvent having a vaporizing temperature of 120° C. or lower is at least one selected from the group consisting of polyethylene, polypropylene, and an ethylene vinyl acetate copolymer.

103. The activated active material products for a battery according to claim 99, wherein the resin soluble in the water-soluble solvent is a polyether sulfone resin, polystyrene, polysulfone, polyacrylonitrile, polyvinylidene fluoride, polyamide, or polyimide, and the resin soluble in the alcohol-soluble solvent is acetylcellulose or oxide phenylene ether.

104. The activated active material products for a battery according to claim 96, wherein the active material forming products are pressurized-forming products or resin forming products having at least one shape selected from the group consisting of particle, plate, scale, cylindrical rod, polygonal cylindrical rod, sphere, dice, cube, amorphous particle, secondary pressurized-forming products, and secondary resin forming products.

105. The activated active material products for a battery according to claim 96, wherein a coating layer is formed on surfaces of the active material forming products, said coating layer selected from the group consisting of a nickel-plated layer, carbon fibers, nickel-plated carbon fibers, nickel-plated organic fibers, nickel-plated inorganic fibers of silica, or nickel-plated inorganic fibers of alumina, nickel-plated inorganic foil of mica, carbon particles, nickel-plated carbon particles, fibrous nickel, nickel particles, and nickel foil.

106. The activated active material products for a battery according to claim 96, wherein at least one gas is applied to the active material forming products for pressurization, said gas selected from the group consisting of air, nitrogen, oxygen, ozone, carbon monoxide, carbon dioxide, helium, neon, argon, nitrogen monoxide, nitrogen dioxide, and hydrogen sulfide, instead of hydrogen.

107. A method of activating active material products for a battery, for use in a three-dimensional battery comprising two vessels connected to each other with a member interposed therebetween, and electrically conductive current collectors provided within the two vessels in contact with the active material products contained in electrolytic solutions filled in the two vessels, the member being configured to permit passage of ions and not to permit passage of electrons, and the active material particles or the active material forming products filled in the electrolytic solution in one of the two vessels being adapted to discharge electrons and the active material particles or the active material forming products filled in the electrolytic solution in the other vessel being adapted to absorb the electrons,
adding an electrically conductive filler and a resin to an active material powder and forming and curing a mixture of the active material powder, the electrically conductive filler, and resin to obtain active material forming products;
placing the active material forming products under a pressure-reduced condition; and
placing the active material forming products under a pressurized condition by injecting a gas to form pores in the active material forming products by the injected gas, thereby increasing the activity of the active material products.

108. The method of activating active material products for a battery according to claim 107, wherein a closed vessel containing the active material forming products is pressure-reduced to less than atmospheric pressure by using a vacuum pump.

109. The method of activating active material products for a battery according to claim 108, wherein the closed vessel containing the active material forming products is pressurized to more than atmospheric pressure by using a pressure pump.

110. The method of activating active material products for a battery according to claim 107, wherein the gas applied to the active material forming products for pressurization is at least one gas selected from consisting of hydrogen, air, nitrogen, oxygen, ozone, carbon monoxide, carbon dioxide, helium, neon, argon, nitrogen monoxide, nitrogen dioxide and hydrogen sulfide.

111. The method of activating active material products for a battery according to claim 107, wherein the active material forming products are pressurized-forming products or resin forming products having at least one shape selected from the group consisting of particle, plate, scale, cylindrical rod, polygonal cylindrical rod, sphere, dice, cube, amorphous particle, secondary pressurized-forming products, and secondary resin forming products.

112. The method of activating active material products for a battery according to claim 107, wherein a material is applied to or coated onto surfaces of the active material forming products, selected from the group consisting of nickel-plating, carbon fibers, nickel-plated carbon fibers, nickel-plated organic fibers, nickel-plated inorganic fibers of silica nickel-plated inorganic fibers of alumina, nickel-plated inorganic foil of mica, carbon particles, nickel-plated carbon particles, fibrous nickel, nickel particles, and nickel foil.
